(19) United States
(12) Patent Application Publication
(10) Pub. No.: US 2021/0376691 A1
(43) Pub. Date: Dec. 2, 2021

(54) Remote Structural Reinforcement of the Flywheel Energy Storage System

(71) Applicant: Christopher Hugh Powell, Cambridge, MA (US)

(72) Inventor: Christopher Hugh Powell, Cambridge, MA (US)

(73) Assignee: Christopher Hugh Powell, Cambridge, MA (US)

(21) Appl. No.: 16/891,043

(22) Filed: Jun. 2, 2020

(51) Int. Cl. H02K 7/02; H02N 15/04; F03G 3/08

(52) U.S. Cl. CPC H02K 7/025; F03G 3/08; H02N 15/04

(57) ABSTRACT

Here, we have devised a system that utilizes Flux-Pinning (or quantum locking) to provide Remote Structural Reinforcement to the rotor of a Flywheel Energy Storage System (FESS). This system utilizes superconducting materials to produce: (i) levitation of the rotor, (ii) a frictionless hinge to hold the rotor in place during operation, and (iii) a series of contactless quantum bonds that provide a reenforcing mechanism. This contactless reinforcement strengthens the rotor against centrifugal forces during operation. And ultimately, this system increases the tensile strength of the rotor; thereby increasing its maximum angular velocity (as well as the energy density of the FESS) without increasing the mass of the Rotor with additional reinforcement materials.

### CROSS REFERENCE TO RELATED APPLICATION(S)

This application claims the benefit of U.S. Provisional Patent Application No. 62/856,466, which is incorporate by reference in its entirety.

### FIELD OF THE INVENTION

The present application relates generally to energy storage systems. More specifically, the present application is by directed to providing Remote Structural Reinforcement to the rotor of a Flywheel Energy Storage Systems (FESS).

### BACKGROUND OF THE INVENTION

A FESS works by accelerating a rotor (i.e. flywheel) to a very high speed and maintaining its rotational energy within the system until extraction. Typically, a FESS uses some sort of electrical motor to accelerate the rotor. Conversely, when energy is extracted from the system, the rotor's rotational energy is used to drive the motor (as a generator) in its production of electricity; thereby, reducing the rotational energy as a consequence of the principle of conservation of energy.

One of the primary limits of FESS design is the tensile strength of the rotor, which—as the spinning component—is under tremendous centrifugal stress during operation. Generally speaking, the stronger the rotor, the faster it may be spun; and ultimately, the more energy the FESS can store. However, when the centrifugal stress exceeds the tensile strength of the rotor, the rotor will shatter releasing all of its stored rotational energy at once—resulting in a violent explosion.

Advanced forms of FESS often utilized vacuum enclosures as a means of eliminating friction, which preserves the rotational energy stored in the FESS.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

Various embodiments of the present disclosure may be directed to an Flywheel Energy Storage System (FESS) providing Remote Structural Reinforcement to the rotor of said FESS through the use of the flux pinning (sometimes referred to as quantum locking) of one or more reinforced high temperature superconductors (HTSC) to a reinforced permanent cylindrical magnet.

Here, we have devised a system that uses Flux-Pinning to provide Remote Structural Reinforcement to a FESS. In this paired arrangement between the rotor (i.e. the spinning flywheel) and the stator (i.e. the stationary base), one of the partners is composed largely of the reinforced permanent cylindrical magnet while the other is composed largely of reinforced HTSC. Upon reaching its critical temperature, the HTSC is able to form flux-pinned bonds, called Vortices, with the cylindrical permanent magnet. —The pair becomes three dimensionally suspended with one levitating a distance from the other. Furthermore, when properly oriented within the permanent cylindrical magnet's axially symmetric field, the pair form a frictionless hinge; whereas, one of the pair can be made to spin around the other using an electromagnetic motor/generator. As such, they form the basis for a frictionless, non-contacting FESS.

Furthermore, this FESS utilizes the Vortices to produce Remote Structural Reinforcement of the Rotor. In this paradigm, layers of reinforcement strengthen the stator; and by strengthening the stator, this FESS increases the load that the rotor can transfer to the stator via the Vortices. Hence, this reinforcement—with sufficiently strong Vortices—allows the stator keeps the rotor in place despite any torque, drag or friction exerted on it by the centripetal forces that inevitably result from a FESS's operation. This systems allows for the continual strengthening of rotor without the need to add any additional mass to the actual rotor's construction. Instead, any additional mass can be exclusively added to the stator.

In sum, Remote Structural Reinforcement offers a solution that allows for the FESS to support increased rotational speeds, without the need to increase the actual mass of the Rotor with reinforcement.

### BRIEF DESCRIPTION OF DRAWINGS

Embodiments are illustrated by way of example and not by limitation in the figures of the accompanying drawings, in which like references indicate similar elements.

FIG. 1A illustrates the structure of the cylindrical permanent magnet where the magnetic field lines are not presently visible (from a front-view/cutaway perspective). The magnet has a hollow center, making its essentially a thick tube.

FIG. 1B illustrates the cylindrical permanent magnet with its magnetic field lines (from a front-view/cutaway perspective).

FIG. 1C illustrates the cylindrical permanent magnet with its magnetic field lines (from a front-view/cutaway perspective) where the innermost magnetic field lines are highlighted as they emerge from magnet's surface.

FIG. 1D illustrates the cylindrical permanent magnet with its magnetic field lines (from a front-view/cutaway perspective) where the second most inner magnetic field lines are highlighted as they emerge from magnet's surface.

FIG. 1E illustrates the cylindrical permanent magnet with its magnetic field lines (from a front-view/cutaway perspective) where the third most inner magnetic field lines are highlighted as they emerges from magnet's surface.

FIG. 1F illustrates the cylindrical permanent magnet with its magnetic field lines (from a front-view/cutaway perspective) where the fourth most inner magnetic field lines are highlighted as they emerges from magnet's surface.

FIG. 1G illustrates the cylindrical permanent magnet with its magnetic field lines (from a front-view/cutaway perspective) where the outermost magnetic field lines are highlighted as they emerges from magnet's surface.

FIG. 1H illustrates the cylindrical permanent magnet with its magnetic field lines (from a front-view/cutaway perspective). It also highlights the surface of the magnetic pole from which the all of the various magnetic field lines emerge.

FIG. 1I illustrates the cylindrical permanent magnet with its magnetic field lines (from a front-view/cutaway perspective). It also illustrates the collection of the magnetic field lines at the midpoint of the magnet.

FIG. 2A illustrates the cylindrical permanent magnet (from the perspective of a ¾ view of the front/top of the magnet). The magnet has a hollow center, making its essentially a thick tube.

FIG. 2B illustrates the cylindrical permanent magnet with its magnetic field lines (from the perspective of a ¾ view of the front/top of the magnet). It also illustrates the pattern formed on the surface of the magnet's poles by the emerging magnetic field lines.

FIG. 2C illustrates the cylindrical permanent magnet with its magnetic field lines where the innermost magnetic field lines are highlighted (from the perspective of a ¾ view of the front/top of the magnet).

FIG. 2D illustrates the cylindrical permanent magnet with its magnetic field lines (from the perspective of a ¾ view of the front/top of the magnet) where the second most inner magnetic field lines are highlighted.

FIG. 2E illustrates the cylindrical permanent magnet with its magnetic field lines (from the perspective of a ¾ view of the front/top of the magnet) where the third most inner magnetic field lines are highlighted.

FIG. 2F illustrates the cylindrical permanent magnet with its magnetic field lines (from the perspective of a ¾ view of the front/top of the magnet) where the fourth most inner magnetic field lines are highlighted.

FIG. 2G illustrates the cylindrical permanent magnet with its magnetic field lines (from the perspective of a ¾ view of the front/top of the magnet) where the outermost magnetic field lines are highlighted.

FIG. 2H illustrates a cylindrical permanent magnet with select portions of its magnetic field lines (from the perspective of a ¾ view of the front/top of the magnet).

FIG. 3A illustrates a top view of a cylindrical permanent magnet (from the perspective of the top view of the magnet). The magnet has a hollow center; making its essentially a thick tube.

FIG. 3B illustrates a cylindrical permanent magnet with its magnetic field lines (from the perspective of the top view of the magnet).

FIG. 3C illustrates a cylindrical permanent magnet with its magnetic field lines (from the perspective of the top view of the magnet) where the innermost magnetic field lines are highlighted.

FIG. 3D illustrates a cylindrical permanent magnet with its magnetic field lines (from the perspective of the top view of the magnet) where the second most inner magnetic field lines are highlighted.

FIG. 3E illustrates a cylindrical permanent magnet with its magnetic field lines (from the perspective of the top view of the magnet) where the third most inner magnetic field lines are highlighted.

FIG. 3F illustrates a cylindrical permanent magnet with its magnetic field lines (from the perspective of the top view of the magnet) where the fourth most inner magnetic field lines are highlighted.

FIG. 3G illustrates a cylindrical permanent magnet with its magnetic field lines (from the perspective of the top view of the magnet) where the outermost magnetic field lines are highlighted.

FIG. 3H illustrates a cylindrical permanent magnet with its magnetic field lines (from the perspective of the top view of the magnet).

FIG. 4A illustrates a cylindrical permanent magnet with (a selection of) its magnetic field lines (from the perspective of a ¾ view of the front/top of the magnet).

FIG. 4B illustrates a cylindrical permanent magnet with (a selection of) its magnetic field lines (from the perspective of a ¾ view of the front/top of the magnet). Furthermore, FIG. 4B also highlights the collection of the magnetic field lines at the midpoint of the magnet.

FIG. 4C illustrates a cylindrical permanent magnet with (a selection of) its magnetic field lines (from the perspective of a ¾ view of the front/top of the magnet). It also illustrates the surface from which these innermost magnetic field lines emerge.

FIG. 4D illustrates a cylindrical permanent magnet with (a selection of) its magnetic field lines (from the perspective of a ¾ view of the front/top of the magnet). It also illustrates the surface from which these second most inner magnetic field lines emerge.

FIG. 4E illustrates a cylindrical permanent magnet with (a selection of) its magnetic field lines (from the perspective of a ¾ view of the front/top of the magnet). It also illustrates the surface from which these third most inner magnetic field lines emerge.

FIG. 4F illustrates a cylindrical permanent magnet with (a selection of) its magnetic field lines (from the perspective of a ¾ view of the front/top of the magnet). It also illustrates the surface from which these fourth most inner magnetic field lines emerge.

FIG. 4G illustrates a cylindrical permanent magnet with (a selection of) its magnetic field lines (from the perspective of a ¾ view of the front/top of the magnet).

FIG. 4H illustrates a cylindrical permanent magnet with (a selection of) its magnetic field lines (from the perspective of a ¾ view of the front/top of the magnet).

FIG. 5A illustrates a very wide cylindrical permanent magnet (from the perspective of a ¾ view of the front/top of the magnet). The magnetic field lines are not presently visible in this illustration. The magnet has a very large hollow center making its essentially a thin tube. Furthermore, the thin wall of the magnet is also highlighted here.

FIG. 5B illustrates a very wide cylindrical permanent magnet with (a selection of) its magnetic field lines at its midpoint (from the perspective of a ¾ view of the front/top of the magnet).

FIG. 6A illustrates a very wide cylindrical permanent magnet (from a front-view/cutaway perspective). The magnetic field lines are not presently visible in this illustration. The magnet has a very large hollow center, making its essentially a thin tube. Furthermore, the thin wall of the magnet is also highlighted here.

FIG. 6B illustrates a very wide cylindrical permanent magnet with its magnetic field lines (from a front-view/cutaway perspective) where the outermost field line is highlighted. Furthermore, we illustrate the path of the outermost field line as it travels above/below the magnet. Finally, FIG. 6B illustrates the field line within the hollow of the magnet's center.

FIG. 7A illustrates a very wide cylindrical permanent magnet (from the perspective of the top view of the magnet). The magnetic field lines are not presently visible in this illustration. The magnet has a very large hollow center; making its essentially a thin tube. Furthermore, the thin wall of the magnet is also highlighted here.

FIG. 7B illustrates a very wide cylindrical permanent magnet with (a selection of) its magnetic field lines where the outermost magnetic field lines are highlighted (from the perspective of the top view of the magnet).

FIG. 8A illustrates—from a ¾ view of the front/top of a cylindrical permanent magnet—a cylindrical permanent magnet with select portions of its magnetic field lines. Furthermore, FIG. 8A also illustrates a Levitator within a certain proximity of the magnet. In the present illustration, the Levitator is out of range of the magnetic field and cannot flux pin with the magnet. Levitator is composed of reinforced (HTSC).

FIG. 8B illustrates—from a ¾ view of the front/top of a cylindrical permanent magnet—a Levitator flux-pinned to the pole of a cylindrical permanent magnet. The Levitator has come within range of the magnetic field flux pinned bonds (called Vortices) with the magnet.

FIG. 8C illustrates—from a ¾ view of the front/top of a cylindrical permanent magnet—how a Levitator, which is flux-pinned to the pole of a cylindrical permanent magnet, can move about the axially symmetric field. FIG. 8C demonstrates how the Levitator can travel in a circular path along the pattern of homogenous flux (called an Activated Orbital) at said magnetic pole. According to an embodiment of the invention, the Levitator is far smaller than the magnetic surface where the revolute joint is formed. And the Levitator acts as the rotor; with its movement being powered by a electromagnetic motor/generator (not illustrated herein).

FIG. 8D demonstrates—from a ¾ view of the front/top of a cylindrical permanent magnet—a type of motion which is prohibited by the Vortices in this present configuration.

FIG. 8E demonstrates—from a ¾ view of the front/top of a cylindrical permanent magnet—a type of motion which is prohibited by the Vortices in this present configuration.

FIG. 9A illustrates—from a ¾ view of the front/top of a cylindrical permanent magnet—a cylindrical permanent magnet with (a selection of) its magnetic field lines. Furthermore, FIG. 9A also illustrates a Levitator 800 within a certain proximity of the magnet. In the present illustration, the Levitator 800 is out of range of the magnetic field and cannot flux pin with the magnet.

FIG. 9B illustrates—from a ¾ view of the front/top of a cylindrical permanent magnet—a Levitator flux-pinned to the midpoint of a cylindrical permanent magnet. FIG. 9B also illustrates how the Vortices link each Activated Orbital to its corresponding Activated Image.

FIG. 9C illustrates—from a ¾ view of the front/top of a cylindrical permanent magnet—how a Levitator, which is flux-pinned to the midpoint of a cylindrical permanent magnet; furthermore, it demonstrates how the Levitator can travel in a circular pattern along the homogenous flux of an Activated Orbital at the magnet's midpoint. According to an embodiment of the invention, Levitator is far smaller than the magnetic surface where the revolute joint is formed. And the Levitator acts as the rotor; and its movement is powered by a electromagnetic motor/generator (not illustrated herein).

FIG. 9D demonstrates—from a ¾ view of the front/top of a cylindrical permanent magnet—a type of motion which is prohibited by the Vortices in this present configuration. In particular, the Levitator moves from its original position to its present position, its motions produce torque and resistance from the Vortices, resulting in the breaking of the Vortices.

FIG. 9E demonstrates—from a ¾ view of the front/top of a cylindrical permanent magnet—a type of motion which is prohibited by the Vortices in this present configuration. In particular, the Levitator moves from its original position to its present position, its motions produce torque and resistance from the Vortices, resulting in the breaking of the Vortices.

FIG. 10A illustrates—from a front-view/cutaway perspective of a cylindrical permanent magnet with select portions of its magnetic field lines—the cylindrical permanent magnet with its magnetic field lines. Furthermore, FIG. 10A also illustrates a Levitator within a certain proximity of the magnet. In the present illustration, the Levitator 800 is out-of-range of the magnetic field and cannot flux pin with the magnet.

FIG. 10B illustrates—from a front-view/cutaway perspective of a cylindrical permanent magnet with select portions of its magnetic field lines—how a cylindrical permanent magnet has a uniform magnetic field close to midpoint of its side; hence, a Levitator can be flux-pinned to the side of such a magnet forming a cylindrical joint in which the Levitator perform linear motions along the side of the magnet for a limited range. FIG. 10B illustrates a Levitator flux-pinned to the side of a cylindrical permanent magnet. The Levitator has come within range of the magnetic field forming Vortices 805 with the magnet.

FIG. 10C illustrates—from a front-view/cutaway perspective of a cylindrical permanent magnet with select portions of its magnetic field lines—that when the Levitator bonds to the side of the cylindrical permanent magnet certain linear motions are allowed without any torque, resistance or breaking of Vortices.

FIG. 10D demonstrates—from a front-view/cutaway perspective of a cylindrical permanent magnet with select portions of its magnetic field lines—a types of movements that are prohibited to Vortices within this present configuration; such movements produce torque, resistance and ultimately the breaking of Vortices. In particular, the Levitator breaks away from the homogenous flux moving from its original position to its present position.

FIG. 10E demonstrates—from a front-view/cutaway perspective of a cylindrical permanent magnet with select portions of its magnetic field lines—a type of motion which is prohibited by the Vortices in this present configuration. In particular, the Levitator breaks away from its field line moving towards the center of the magnet's axis.

FIG. 10F demonstrates—from a front-view/cutaway perspective of a cylindrical permanent magnet with select portions of its magnetic field lines—a type of motion which is prohibited by the Vortices in this present configuration. In particular, the Levitator breaks away from its field line moving away from the center of the magnet's axis.

FIG. 11A illustrates—from a front-view/cutaway perspective of a cylindrical permanent magnet with select portions of its magnetic field lines—a cylindrical permanent magnet with select portions of its magnetic field lines. Furthermore, FIG. 11A also illustrates a Levitator within a certain proximity of the magnet. In the present illustration, the Levitator is out-of-range of the magnetic field and cannot flux pin with the magnet.

FIG. 11B illustrates—from a front-view/cutaway perspective of a cylindrical permanent magnet with select portions of its magnetic field lines—how the Levitator, composed of High Temperature Superconductor (HTSC), has come within range of the magnetic field forming magnetic bonds (called Vortices) with the magnet at its poles.

FIG. 11C demonstrates—from a front-view/cutaway perspective of a cylindrical permanent magnet with select portions of its magnetic field lines—a type of motion which is prohibited by the Vortices in this present configuration; such movements produce torque, resistance and ultimately the breaking of Vortices. In particular, the Levitator breaks away from its homogenous flux pattern moving away from the surface of the magnetic pole.

FIG. 11D demonstrates—from a front-view/cutaway perspective of a cylindrical permanent magnet with select portions of its magnetic field lines—a type of motion which is prohibited by the Vortices in this present configuration; such movements produce torque, resistance and ultimately the breaking of Vortices. In particular, the Levitator breaks away from its homogenous flux pattern moving toward the surface of the magnetic pole.

FIG. 12A illustrates a ¾ view of the front/top view of a cylindrical permanent magnet with select portions of its magnetic field lines. Furthermore, FIG. 12A also illustrates a Levitator within a certain proximity of the magnet. In the present illustration, the Levitator is out of range of the magnetic field and cannot flux pin with the magnet.

FIG. 12B illustrates—from a ¾ view of the front/top of a cylindrical permanent magnet with select portions of its magnetic field lines—how the Levitator, composed of High Temperature Superconductor (HTSC), has come within range of the magnetic field forming magnetic bonds (called Vortices) with the magnet at its poles; furthermore, it demonstrates how the Levitator can travel in a circular path along the pattern of homogenous flux at the magnet's pole. According to an embodiment of the invention, Levitator is large enough to nearly cover the entirety of the magnetic surface where the revolute joint is formed. The rotor, may be either the Levitator or the permanent cylindrical magnet, and its movement is powered by a electromagnetic motor/generator (not illustrated herein).

FIG. 12C illustrates—from a ¾ view of the front/top of a cylindrical permanent magnet with select portions of its magnetic field lines—how a Levitator, which is flux-pinned to the pole of a cylindrical permanent magnet, can move about the axially symmetric magnetic field. According to an embodiment of the invention, Levitator is large enough to nearly cover the entirety of the magnetic surface where the revolute joint is formed. The rotor, may be either the Levitator or the permanent cylindrical magnet, and its movement is powered by a electromagnetic motor/generator (not illustrated herein).

FIG. 12D demonstrates—from a ¾ view of the front/top of a cylindrical permanent magnet with select portions of its magnetic field lines—a type of motion which is prohibited by the Vortices in this present configuration. In particular, the Levitator breaks away from its homogenous flux pattern moving away from the center of the magnet's axis.

FIG. 13A illustrates—from a front-view/cutaway perspective of a cylindrical permanent magnet with select portions of its magnetic field lines—a cylindrical permanent magnet with select portions of its magnetic field lines. Furthermore, FIG. 13A also illustrates a Levitator within a certain proximity of the magnet. In the present illustration, the Levitator is out-of-range of the magnetic field and cannot flux pin with the magnet.

FIG. 13B illustrates—from a front-view/cutaway perspective of a cylindrical permanent magnet with select portions of its magnetic field lines—how the Levitator has come within range of the magnetic field forming Vortices with the magnet's pole.

FIG. 13C demonstrates—from a front-view/cutaway perspective of a cylindrical permanent magnet with select portions of its magnetic field lines—a type of motion which is prohibited by the Vortices in this present configuration; such movements produce torque, resistance and ultimately the breaking of Vortices. In particular, the Levitator breaks away from its homogenous pattern of flux moving away from the axis of the magnetic pole.

FIG. 13D demonstrates—from a front-view/cutaway perspective of a cylindrical permanent magnet with select portions of its magnetic field lines—a type of motion which is prohibited by the Vortices in this present configuration; such movements produce torque, resistance and ultimately the breaking of Vortices. In particular, the Levitator breaks away from its homogenous pattern of flux moving away from the surface of the magnetic pole.

FIG. 14A illustrates—from a front-view/cutaway perspective of a cylindrical permanent magnet with select portions of its magnetic field lines illustrated—the cylindrical permanent magnet with its magnetic field lines. Furthermore, FIG. 14A also illustrates a Levitator within a certain proximity of the magnet. In the present illustration, the Levitator is out-of-range of the magnetic field and cannot flux pin with the magnet.

FIG. 14B illustrates—from a front-view/cutaway perspective of a cylindrical permanent magnet with select portions of its magnetic field lines—a Levitator flux-pinned to the side of a cylindrical permanent magnet. The Levitator has come within range of the magnetic field forming Vortices with the magnet.

FIG. 14C illustrates—from a front-view/cutaway perspective of a cylindrical permanent magnet with select portions of its magnetic field lines illustrated—how the cylindrical permanent magnet has a uniform magnetic field close to midpoint of its side; hence, a Levitator can be flux-pinned to the side of such a magnet forming a cylindrical joint in which the Levitator perform linear motions along the side of the magnet for a limited range.

FIG. 14D demonstrates—from a front-view/cutaway perspective of a cylindrical permanent magnet with select portions of its magnetic field lines illustrated—a type of motion which is prohibited by the Vortices in this present configuration; such movements produce torque, resistance and ultimately the breaking of Vortices. In particular, the Levitator breaks away from its homogenous flux moving away from the center of the magnet's axis.

FIG. 14E demonstrates—from a front-view/cutaway perspective of a cylindrical permanent magnet with select portions of its magnetic field lines illustrated—a type of motion which is prohibited by the Vortices in this present configuration; such movements produce torque, resistance and ultimately the breaking of Vortices. In particular, the Levitator breaks away from the homogenous flux.

FIG. 15A illustrates—from a ¾ view of the front/top of two cylindrical permanent magnets with select portions of their magnetic field lines—a Levitator between two cylindrical permanent magnets. The Levitator is out-of-range of the magnetic fields and cannot flux pin with the magnets.

FIG. 15B illustrates—from a ¾ view of the front/top of two cylindrical permanent magnets with select portions of their magnetic field lines—a Levitator flux-pinned to the poles of two cylindrical permanent magnets simultaneously. The Levitator has come within range of the magnetic field forming Vortices with the magnets. FIG. 15B illustrates how the Levitator, composed of High Temperature Superconductor (HTSC), forms magnetic bonds (called Vortices) with each magnet at its respective pole; furthermore, it demonstrates how the Levitator can travel in a circular path along the pattern of homogenous flux of conjoined Orbital Pattern at each magnet's pole. Notice that the Levitator in this example is large enough to enclose almost the entirety of the magnet's surface at its pole. According to an embodiment of the invention, Levitator is large enough to nearly cover the entirety of the magnetic surface where the revolute joint is formed. And the rotor's, in this case the Levitator, movement is powered by a electromagnetic motor/generator (not illustrated herein).

FIG. 16A illustrates—from a front-view/cutaway perspective of a Levitator between two cylindrical permanent magnet with select portions of its magnetic field lines—a Levitator between two cylindrical permanent magnets. The Levitator is out-of-range of the magnetic fields and cannot flux pin with the magnets.

FIG. 16B illustrates a Levitator flux-pinned to the poles of two cylindrical permanent magnets simultaneously. The Levitator has come within range of the magnetic field forming Vortices with the magnets. FIG. 16B illustrates how the Levitator, composed of High Temperature Superconductor (HTSC), forms magnetic bonds (called Vortices) with each magnet at its respective pole; furthermore, it demonstrates how the Levitator can travel in a circular path along the pattern of homogenous flux of conjoined Orbital Pattern at each magnet's pole. Notice that the Levitator in this example is large enough to enclose almost the entirety of both magnets' surfaces at their respective poles.

FIG. 17A illustrates—from a ¾ view of the front/top of two Levitators sandwiching a cylindrical permanent magnet—two Levitators sandwiching a cylindrical permanent magnets. The Levitators is out-of-range of the magnetic fields and cannot flux pin with the magnet.

FIG. 17B illustrates—from a ¾ view of the front/top of two Levitators sandwiching a cylindrical permanent magnet—two Levitators flux-pinned to the poles of a cylindrical permanent magnet simultaneously. The Levitators 1200 have come within range of the magnetic field forming Vortices with the magnet. FIG. 17B illustrates how the Levitators, composed of High Temperature Superconductor (HTSC), form magnetic bonds (called Vortices) with the magnet at both of its respective poles; furthermore, it demonstrates how the magnet can travel on a circular path along the pattern of homogenous flux of conjoined magnetic fields of each magnet's pole. According to an embodiment of the invention, Levitator is large enough to nearly cover the entirety of the magnetic surface where the revolute joint is formed. And the rotor's, in this case the permanent cylindrical magnet, movement is powered by a electromagnetic motor/generator (not illustrated herein).

FIG. 18A illustrates—from a front-view/cutaway perspective of two Levitators sandwiching a cylindrical permanent magnet—two Levitators sandwiching a cylindrical permanent magnet. The Levitators is out-of-range of the magnetic fields and cannot flux pin with the magnet.

FIG. 18B illustrates two Levitators flux-pinned to the poles of a cylindrical permanent magnet simultaneously. The Levitators have come within range of the magnetic field forming Vortices with the magnet. FIG. 18B illustrates how the Levitators, composed of High Temperature Superconductor (HTSC), form magnetic bonds (called Vortices) with the magnet at both of its respective poles; furthermore, it demonstrates how the magnet can travel on a circular path along the pattern of homogenous flux of conjoined magnetic fields of each magnet's pole.

FIG. 19A illustrates—from a front-view/cutaway perspective of a hollow very wide cylindrical permanent magnet with select portions of its magnetic field lines—the cylindrical permanent magnet with its magnetic field lines. Furthermore, FIG. 19A also illustrates a Levitator within a certain proximity of the magnet. The Levitator is out-of-range of the magnetic field and cannot flux pin with the magnet.

FIG. 19B illustrates—from a front-view/cutaway perspective of a hollow very wide cylindrical permanent magnet with select portions of its magnetic field lines—a Levitator flux-pinned to the inner side of the cavity of a cylindrical permanent magnet. The Levitator has come within range of the magnetic field forming Vortices with the magnet. FIG. 19B illustrates how the Levitator, composed of High Temperature Superconductor (HTSC), forms magnetic bonds (called Vortices) with the magnet.

FIG. 19C illustrates—from a front-view/cutaway perspective of a hollow very wide cylindrical permanent magnet with select portions of its magnetic field lines—how a Levitator, which is flux-pinned to the inner side of the cavity of a cylindrical permanent magnet, can move in linear manner. FIG. 19C demonstrates how the Levitator can travel in a linear motion along the homogenous flux of the magnet's side within its hollow cavity.

FIG. 19D demonstrates—from a front-view/cutaway perspective of a hollow very wide cylindrical permanent magnet with select portions of its magnetic field lines—a type of motion which is prohibited by the Vortices in this present configuration. In particular, the Levitator breaks away from the homogenous flux.

FIG. 19E demonstrates—from a front-view/cutaway perspective of a hollow very wide cylindrical permanent magnet with select portions of its magnetic field lines—a type of motion which is prohibited by the Vortices in this present configuration. In particular, the Levitator breaks away from its homogenous flux moving towards the center of the magnet's axis.

FIG. 20A illustrates—from a ¾ view of front/top of a hollow very wide cylindrical permanent magnet with select portions of its magnetic field lines—a cylindrical permanent magnet with (a selection of) its magnetic field lines. Furthermore, FIG. 20A also illustrates a Levitator within a certain proximity of the magnet. In the present illustration, the Levitator is out-of-range of the magnetic field and cannot flux pin with the magnet.

FIG. 20B illustrates—from a ¾ view of front/top of a hollow very wide cylindrical permanent magnet with select portions of its magnetic field lines—a Levitator flux-pinned to the midpoint of a cylindrical permanent magnet. The Levitator has come within range of the magnetic field forming Vortices with the magnet. FIG. 20B also highlights a circular pattern of homogenous flux; as such, this paradigm allows the Levitator to travel in a circular motion about this homogenous flux. FIG. 20B also highlights how the Levitator, composed of High Temperature Superconductor (HTSC), forms magnetic bonds (called Vortices) with the magnet; furthermore, it demonstrates how the Levitator can travel in a circular pattern along the homogenous flux of an Activated Orbital at the magnet's midpoint within the magnet's hollow cavity. According to an embodiment of the invention, Levitator is far smaller than the magnetic surface where the revolute joint is formed. And the Levitator acts as the rotor; and its movement is powered by a electromagnetic motor/generator (not illustrated herein).

FIG. 20C illustrates—from a ¾ view of front/top of a hollow very wide cylindrical permanent magnet with select portions of its magnetic field lines—how a Levitator, which is flux-pinned to the midpoint within the hollow cavity of a cylindrical permanent magnet, can move in circular manner about the homogenous flux. FIG. 20C also highlights how the Levitator, composed of High Temperature Superconductor (HTSC), forms magnetic bonds (called Vortices) with the magnet; furthermore, it demonstrates how the Levitator can travel in a circular pattern along the homogenous flux of an Activated Orbital at the magnet's midpoint within the magnet's hollow cavity. According to an embodiment of the invention, Levitator is far smaller than the magnetic surface where the revolute joint is formed. And the Levitator acts as the rotor; and its movement is powered by a electromagnetic motor/generator (not illustrated herein)

FIG. 20D demonstrates—from a ¾ view of front/top of a hollow very wide cylindrical permanent magnet with select portions of its magnetic field lines—a type of motion which is prohibited by the Vortices in this present configuration. In particular, the Levitator breaks away from its homogenous flux.

FIG. 20E demonstrates—from a ¾ view of front/top of a hollow very wide cylindrical permanent magnet with select portions of its magnetic field lines—a type of motion which is prohibited by the Vortices in this present configuration. In particular, the Levitator breaks away from its homogenous flux.

FIG. 21A illustrates the wide cylindrical Levitator with a hollow center.

FIG. 21B illustrates the wide cylindrical permanent magnet with a hollow center. Throughout this FIG. 21 this magnet will act as the spinning component.

FIG. 21C illustrates the narrow cylindrical Levitator.

FIG. 21D illustrates a flat disk shaped Levitator.

FIG. 21E illustrates a flywheel system where the Levitator acts as the stator while the magnet acts as the rotor.

FIG. 21F illustrates a flywheel system where the Levitator acts as the stator while the magnet acts as the rotor.

FIG. 21G illustrates a flywheel system where the Levitator acts as the stator while the magnet acts as the rotor.

FIG. 21H illustrates a flywheel system where two separate Levitators act as the stators while the magnet acts as the rotor.

FIG. 21I illustrates a flywheel system where three separate Levitators act as the stators while the magnet acts as the rotor.

FIG. 21J illustrates a flywheel system where four separate Levitators acts as the stators while the magnet acts as the rotor.

FIG. 21K mechanisms described in FIG. 21A through FIG. 21J and how various components relate to one another forming various FESS configurations.

FIG. 22A illustrates the wide cylindrical Levitator with a hollow center.

FIG. 22B illustrates the wide cylindrical permanent magnet with a hollow center. Throughout this FIG. 22 this magnet will act as the spinning component.

FIG. 22C illustrates the narrow cylindrical Levitator.

FIG. 22D illustrates a flat disk shaped Levitator.

FIG. 22E illustrates a flywheel system where the Levitator acts as the stator while the magnet acts as the rotor.

FIG. 22F illustrates a flywheel system where the Levitator acts as the stator while the magnet acts as the rotor.

FIG. 22G illustrates a flywheel system where the Levitator acts as the stator while the magnet acts as the rotor.

FIG. 22H illustrates a flywheel system where two separate Levitators act as the stators while the magnet acts as the rotor.

FIG. 22I illustrates a flywheel system where three separate Levitators act as the stators while the magnet acts as the rotor.

FIG. 22J illustrates a flywheel system where four separate Levitators act as the stators while the magnet acts as the rotor.

FIG. 22K illustrates mechanisms described in FIG. 22A through FIG. 22J and how various components relate to one another forming various FESS configurations.

FIG. 23A illustrates the very wide cylindrical permanent magnet with a hollow center.

FIG. 23B illustrates the wide cylindrical Levitator with a hollow center. Throughout this FIG. 23 this Levitator will act as the spinning component.

FIG. 23C illustrates the wide cylindrical permanent magnet with a hollow center.

FIG. 23D illustrates a flat disk shaped magnet.

FIG. 23E illustrates a flywheel system where the magnet acts as the stator while the Levitator acts as the rotor.

FIG. 23F illustrates a flywheel system where the magnet acts as the stator while the Levitator acts as the rotor.

FIG. 23G illustrates a flywheel system where two separate magnets acts as the stator while the Levitator acts as the rotor.

FIG. 23H illustrates a flywheel system where two separate magnets acts as the stators while the Levitator acts as the rotor.

FIG. 23I illustrates a flywheel system where three separate magnets acts as the stators while the Levitator acts as the rotor.

FIG. 23J illustrates a flywheel system where four separate magnets acts as the stators while the Levitator acts as the rotor.

FIG. 23K illustrates mechanisms described in FIG. 23A through FIG. 23J and how various components relate to one another forming various FESS configurations.

FIG. 24A illustrates the very wide cylindrical permanent magnet with a hollow center.

FIG. 24B illustrates the wide cylindrical Levitator with a hollow center. Throughout this FIG. 24 this Levitator will act as the spinning component.

FIG. 24C illustrates the wide cylindrical permanent magnet with a hollow center.

FIG. 24D illustrates a flat disk shaped magnet.

FIG. 24E illustrates a flywheel system where the magnet acts as the stator while the Levitator acts as the rotor.

FIG. 24F illustrates a flywheel system where the magnet acts as the stator while the Levitator acts as the rotor.

FIG. 24G illustrates a flywheel system where two separate magnets acts as the stator while the Levitator acts as the rotor.

FIG. 24H illustrates a flywheel system where two separate magnets acts as the stators while the Levitator acts as the rotor.

FIG. 24I illustrates a flywheel system where three separate magnets acts as the stators while the Levitator acts as the rotor.

FIG. 24J illustrates a flywheel system where four separate magnets acts as the stators while the Levitator acts as the rotor.

FIG. 24K illustrates mechanisms described in FIG. 24A through FIG. 24J and how various components relate to one another forming various FESS configurations.

FIG. 25 illustrates—from a ¾ view of front/top perspective—a FESS “battery cell” with several (two) rotors, each rotor is surrounded by a four (4) sided “tunnel” composed of stator(s). In this example, several Levitators are acting as the stator(s); the four surfaces of stators comprise the tunnel to which each of the cylindrical permanent magnet(s) is flux pinned to form the necessary revolute joint(s). Additionally, these Levitators can also be flux pinned to cylindrical permanent magnet(s) on either side of their tunnel. The two cylindrical permanent magnet(s), in turn, act as the rotor(s) for the FESS battery cells.

FIG. 26 illustrates—from a ¾ view of front/top—a FESS “battery cell” with several (two) rotors, each rotor is surrounded by a four (4) sided “tunnel” composed of stator(s). In this example, several cylindrical permanent magnets are acting as the stator(s); the four surfaces of stators comprise the tunnel to which each of the Levitators is flux pinned to form the necessary revolute joint(s). And the Levitators, acting as rotors within each tunnel, are suspended by their flux pinned interactions with the magnetic fields to create the necessary revolute joints. And additionally, some of these magnetic stators can also form bonds with additional Levitators on either side of the stator tunnel. (These cylindrical permanent magnets are separated from one another by reinforcement so as not to interrupt each other's magnetic fields).

From a front-view/cutaway perspective, FIG. 27A illustrates the cylindrical permanent magnet with its magnetic field lines. Furthermore, FIG. 27A also illustrates a Levitator within a certain proximity of the magnet. Levitator is out-of-range of the magnetic field and cannot flux pin with the magnet.

From a front-view/cutaway perspective, FIG. 27B illustrates a Levitator flux-pinned to the side of a cylindrical permanent magnet. The Levitator has come within range of the magnetic field forming Vortices with the magnet.

From a front-view/cutaway perspective, FIG. 27C illustrates a Levitator flux-pinned to the side of a cylindrical permanent magnet. Yet in this depiction, the magnet has also been strengthened by layers of reinforcement material. In this paired arrangement between the Levitator and the permanent cylindrical magnet, wherein one (or both) of the partners is composed largely of reinforcement materials. The Levitator is composed of interlocking layers of High Temperature Superconductor (HTSC) and reinforcement materials. The cylindrical permanent magnet may also be encased in layers of reinforcement material. And the rotor may be constructed in a manner, in which the particular materials (within the rotor)—that will be under the influence of flux pinning—are positioned within the rotor's mass to reinforce any other masses (within the rotor) from centrifugal stress. As such, the outermost rim of the rotor should be composed of the materials undergoing flux pinning interactions.

FIG. 28A Illustrates a top/cutaway view of a view of a battery-cell-tray. In particular, this example battery-cell-tray is the largest of those depicted in this FIG. 28.

FIG. 28B Illustrates a top/cutaway view of a view of a battery-cell-tray. In particular, this example battery-cell-tray is the second largest of those depicted in this FIG. 28.

FIG. 28C Illustrates a top/cutaway view of a view of a battery-cell-tray. In particular, this example battery-cell-tray is the smallest of those depicted in this FIG. 28.

FIG. 28D illustrates a side view of a Spherical Holder 2845 of five battery-cell-trays where each battery-cell-tray is layered upon one another in the following order (top to bottom). FIG. 28D illustrate a systems for storing FESS battery cells in a spherical container with a high level of efficiency. The several FESS “battery cells” are stored—layered within the spherical container; whereas the outer shell of the spherical container is composed of reinforcement material.

FIG. 29A Illustrates a top/cutaway view of a battery-cell-tray. In particular, this example battery-cell-tray is the largest of those depicted in this FIG. 29.

FIG. 29B Illustrates a top/cutaway view of a battery-cell-tray. In particular, this example battery-cell-tray is the second largest of those depicted in this FIG. 29.

FIG. 29C Illustrates a top/cutaway view of a battery-cell-tray. In particular, this example battery-cell-tray is the smallest of those depicted in this FIG. 29.

FIG. 29D illustrates a side view of a Spherical Holder of five battery-cell-trays where each battery-cell-tray is layered upon one another in the following order (top to bottom).

FIG. 29E illustrates—from a top/cutaway view of a battery-cell-tray—the benefits of this embodiment. This system allow the centrifugal stress of one cell to provide additional reinforcement for its neighboring cells.

FIG. 30A illustrates—from a top/cutaway view—the Outermost-Spherical-Insulation-chamber 3000 that acts as a vacuum chamber.

FIG. 30B illustrates—from a top/cutaway view—the Innermost-Spherical-Insulation-chamber, which acts as an encasement for the Spherical Holder of the FESS battery cells as discuss in FIG. 30E.

FIG. 30C illustrates—from a top/cutaway view—a combines assembly where the Innermost-Spherical-Insulation-chamber is placed within the Outermost-Spherical-Insulation-chamber to form the Insulation Chamber for the battery.

FIG. 30D illustrates—from a top/cutaway view—the battery which will be place within the insulation chamber. A generic battery example is illustrated.

FIG. 30E illustrates—from a top/cutaway view—the complete insulation chamber with a battery assembly within it.

FIG. 30F illustrates—from a top/cutaway view—an insulation chamber for the FESS battery cells as described in components discussed in FIG. 30A though FIG. 30E. The insulation system is composed of a dual chambered enclave designed to insulate and extract heat from the FESS in form of infrared light. Whereas the inner chamber—in which the FESS is stored—has an outer surface that is coated with a material that is highly reflective of infrared radiation; this inner chamber is levitated (via flux pinning) within an outer chamber. Furthermore, the inner surface of the outer chamber is coated with a material that is highly absorptive of infrared radiation. And in the zone separating these two chambers, a vacuum is maintained.

FIG. 31A illustrates—from a top/cutaway view—the outermost sphere of the gimbal. The illustration demonstrates the degrees of movement this sphere will enable.

FIG. 31B illustrates—from a top/cutaway view—the innermost sphere of the gimbal. The illustration demonstrates the degrees of movement this sphere will enable.

FIG. 31C illustrates—from a top/cutaway view—a generic example of a FESS battery cell.

FIG. 31D illustrates—from a top/cutaway view—the fully assembled gimbal with the battery cell within it.

FIG. 31E illustrates—from a top/cutaway view—a spherical gimbal that utilizes flux pinning that to produce the requisite revolute joints. Furthermore, this gimbal is comprised of dual spherical chambers, one enclosing the other. And the FESS is stored within the innermost chamber.

FIG. 32 illustrates—from a top/cutaway view—a donut shaped magnetic rotor, enclosed within a hollow donut shaped stator, which increases the surface area available for the formation of Vortices.

FIG. 33 illustrates—from a ¾ cutaway view of front/top—a donut shaped magnetic rotor, enclosed within a hollow donut shaped stator, which increases the surface area available for the formation of Vortices.

FIG. 34A illustrates—from a ¾ cutaway view of front/top—a multilayered-rotor composed of very thin overlapping layers of magnetic materials and HTSC and reinforcement. Each layer of the rotor essentially forms a hollow cylindrical shell of one of the following: (i) a Levitator (HTSC), (ii) a permanent cylindrical magnet, or (iii) composite reinforcement. Furthermore, each cylindrical layer encases the next. FIG. 34A illustrates—from a ¾ cutaway view of front/top—a solid-multilayer-FESS-rotor composed of several overlapping layers of magnetic thin films and Levitator thin films. This particular illustration has a portion of the rotor unraveled and a portion bonded for illustration purpose.

FIG. 34B illustrates—from a ¾ cutaway view of front/top—a multilayered-rotor composed of very thin overlapping layers of magnetic materials and HTSC and reinforcement. Each layer of the rotor essentially forms a hollow cylindrical shell of one of the following: (i) a Levitator (HTSC), (ii) a permanent cylindrical magnet, or (iii) composite reinforcement. Furthermore, each cylindrical layer encases the next. FIG. 34B illustrates—from a ¾ cutaway view of front/top—a solid-multilayer-FESS-rotor (fully bonded) implemented with its three surface stator (Levitator based stator in this example).

FIG. 35 illustrates—from a top/cutaway view—a multilayered-rotor composed of very thin overlapping layers of magnetic materials and HTSC and reinforcement. Each layer of the rotor essentially forms a hollow cylindrical shell of one of the following: (i) a Levitator (HTSC), (ii) a permanent cylindrical magnet, or (iii) composite reinforcement. Furthermore, each cylindrical layer encases the next.

FIG. 36 here we illustrate—from a front/cutaway view—a donut shaped rotor, enclosed within a hollow donut shaped stator, which increases the surface area available for the formation of Vortices. Furthermore, the reinforcement has been built into the inner portion of the donut shaped rotor; while the outer portion of the rotor 3605 composed of flux pinning materials.

As a result of these features, the rotor has be constructed in a manner, in which the particular materials (within the rotor)—that will be under the influence of flux pinning—are positioned within the rotor's mass to reinforce any other masses (within the rotor) from centrifugal stress. As such, the outermost rim of the rotor is actually composed of the materials undergoing flux pinning interactions.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and other changes can be made without departure from the scope of what is claimed. The following detailed description is therefore not to be taken in a limiting sense, and the scope is defined by the appended claims and their equivalents.

Flux-Pinning: High Temperature Superconductors (HTSC) have defects in their crystal lattices called Pinning Sites. If these Pinning Sites are exposed to a magnetic field of sufficient strength, the defects will allow the magnetic field to partially penetrate the HTSC; thereby, pinning the magnetic flux in place. This penetration appears in the form of cylindrical columns of swirling flux, called Vortices, which strongly bond the HTSC to the magnet. This process of bonding the HTSC to the magnet is called Flux Pinning (and is sometimes referred to as Quantum Locking).

And these Vortices form a contactless bond that requires no physical contact between the HTSC and magnet, demonstrated in the levitation of a HTSC above a magnet (or vice versa) upon the pair becoming flux-pinned to one another. As a superconductor, the HTSC resists any changes to the magnetic flux captured within its Pinning Sites; this resistance manifests itself as a force of friction, torque or drag opposed to the direction of motion that would disrupt the flux distribution. This resistance is not incidental; and it can support a weight that is a several thousand times the weight of the engaged HTSC.

Although Flux-Pinning can exert restraining forces in all six degrees of freedom, an interface can be designed to constrain only certain degree) of freedom so that it functions as a non-contacting kinematic joint. To construct such a joint, one must design a path-of-motion—along the desired degree(s) of freedom—that precipitates no change in the magnetic flux within the superconductor's volume. Such a joint allows the two non-contacting modules to move in relation to each other, while remaining effectively constrained in the remaining degrees of freedom. And apart from the cooling demands, flux-pinned joints require no power, lubricant or physical contact; while providing potentially limitless stiffness while remaining essentially impervious to mechanical wear.

The devised system utilizes flux-pinning to provide Remote Structural Reinforcement to the rotor of a Flywheel Energy Storage System (FESS). This system utilizes superconducting materials to produce a series of contactless quantum bonds that provide a reenforcing mechanism, which strengthens the rotor against centrifugal forces experience during operation. Ultimately, this system increases the tensile strength of the rotor; thereby increasing its maximum angular velocity as well as the energy density of the FESS without increasing the mass of the Rotor with additional reinforcement materials.

In this paired arrangement between the rotor (i.e. the spinning flywheel) and the stator (i.e. the stationary base), one of the partners is composed largely of the reinforced permanent cylindrical magnet while the other is composed largely of reinforced HTSC. Upon reaching its critical temperature, the HTSC is able to form flux-pinned bonds, called Vortices, with the cylindrical permanent magnet. —The pair becomes three dimensionally suspended with one levitating a distance from the other. Furthermore, when properly oriented within the permanent cylindrical magnet's axially symmetric field, the pair form a frictionless hinge; whereas, one of the pair can be made to spin around the other using an electromagnetic motor/generator. As such, they form the basis for a frictionless, non-contacting FESS.

Our design utilizes the Vortices in producing Remote Structural Reinforcement of the Rotor. In this paradigm, layers of reinforcement strengthen the stator; and by strengthening the stator, this FESS increases the load that the rotor can transfer to the stator via the Vortices. Hence, this reinforcement—with sufficiently strong Vortices—allows the stator keeps the rotor in place despite any torque, drag or friction exerted on it by the centripetal forces that inevitably result from a FESS's operation. This systems allows for the continual strengthening of rotor without the need to add any additional mass to the actual rotor's construction. Instead, any additional mass can be exclusively added to the stator.

Ultimately, our design focuses on (i) increasing the number of Vortices/flux-pinned bonds system can support and (ii) increasing the effective reinforcement of the stator. In sum, Remote Structural Reinforcement offers a solution that allows for the FESS to support increased rotational speeds, without the need to increase the actual mass of the Rotor with reinforcement.

Increasing Vortices Strength and Distribution: The magnet and the Levitator (HTSC) must be bonded in extremely close proximity to one another. Proximity greatly amplifies the accessibility to the magnetic flux, the strengthening the Vortices, as well as the homogeneous distribution of the Vortices throughout both HTSC and the magnet.

Vortices should be homogeneously distributed through rotor. A sparseness in the distribution of Vortices would create a sort of “weak-link” as it pertains to the Remote Structural Reinforcement being offered to the rotor by the system. Hence, the magnet may be preferable as a rotor materials as opposed to the levitator; since Vortices are more homogeneously distributed along the magnet's volume than within the Levitator's volume.

Highly Reinforced HTSC: Reinforcement material should be very strong, light weight and thinly layered; most importantly these materials must not block magnetic flux from magnet and must not interfere with the superconductivity of the various components. Thinly layered HTSC materials have several advantages including an increased the ability trap magnetic flux, which ultimately increase the strength and number of Vortices. Bulk HTSC materials can produce magnetic interference upon becoming sufficiently dense; as such, thinly layered HTSC prevent this phenomenon while increase the surface area available for Pinning-Sites (i.e. the location of Vortices formation in the Levitator). It is advantageous to assemble the Levitator by overlapping thin layers of HTSC between thin layers of reinforcement materials. While a Levitator may be composed entirely of a bulk HTSC; it is preferable to construct a Levitator with ultra thin layers of HTSC and reinforcement. Levitator is composed in this fashion to form ultra thin HTSC layers, which are separated from one another. The thinness and separation aids reducing the superconductors' resistance to and interference with magnetic fields. It also strengthens the HTSC materials for handling during construction as well as within FESS operation.

Superconducting-Permanent-Cylindrical-Magnets: Superconducting-Permanent-Magnets are a form of permanent magnet composed of superconducting materials. (Superconducting materials must be maintained with their appropriate temperature parameters so as to maintain their superconducting properties (i.e. critical temperature)). Superconducting-Permanent-Magnets have an increased dipole moment, which amplifies the amount of magnetic flux available to form Vortices. The permanent magnets are sometimes fabricated by taking either a type 1 or type 2 superconducting materials and forming a short circuit (or loop), which is then brought to its critical temperature and imbued with a magnetic field. Once established, this magnetic field is retained so long as the superconductivity is maintained. It is important to note that the magnet's critical strength should not be so great that it would interfere with the its ability to form Vortices or it would interfere with the superconductivity of some other component.

Elimination of Friction: By creating a system composed of largely contactless components, we allow for the elimination of various sources of friction.

Flux-Pinning allows for the creation of a contactless hinge by which the rotor can spin suspended in place without contact to its stator. This is effectively a frictionless-hinge that will never wear down, require maintenance or even lubrication so long as the superconducting convictions are maintained.

Contactless motor/generator elements can be placed within both rotor and/or stator. These elements will allow electricity to power the spinning of the rotor though electromagnetic propulsion; thereby, increasing its rotational energy. Furthermore, these same elements will also harness the rotor's rotational energy to generate electricity for extraction from the system at a later time.

By placing both the rotor and the stator within a vacuum chamber and by removing the air (whether completely or partially), we can further eliminate the possibility of friction caused by air resistance during flywheel's operation.

Insulation: By reducing (or even eliminating) any contact with various forms of matter and light, this system can be insulated so as to maintain the cryogenic temperatures of its superconducting components with minimal refrigeration.

All of the superconducting components of the FESS could be stored within a flux-pinned container that is essentially suspended within a insulated vacuum chamber.

Furthermore, by placing the FESS into a vacuum chamber and removing the air, we can eliminate an transmission of heat through contact with gaseous matter.

Even in the absence of matter, heat can still be transmitted through a vacuum via infrared light. However, this can be abated through the pairing of surfaces that are either reflective or absorptive of infrared light. The outermost shell of the suspended FESS chamber could be made reflective of infrared light while the innermost surface of the vacuum chamber where the FESS is stored and suspended, could be made highly absorptive of infrared light. As such the vacuum chamber would absorb far more infrared heat from the FESS than it would transmit to the FESS.

Reducing Turbulence: The introduction of Adaptive Suspension and Active Gimbal Systems will reduce the effects of any movements/turbulence.

An Adaptive Suspension utilizing an electronically controlled system (with machine learning) could adapt to conditions and protect flywheel from any damaged cause by movements outside of the system.

By placing the system within a gimbal container anchored to an electronically controlled gymbal, the FESS will remain in the optimal position.

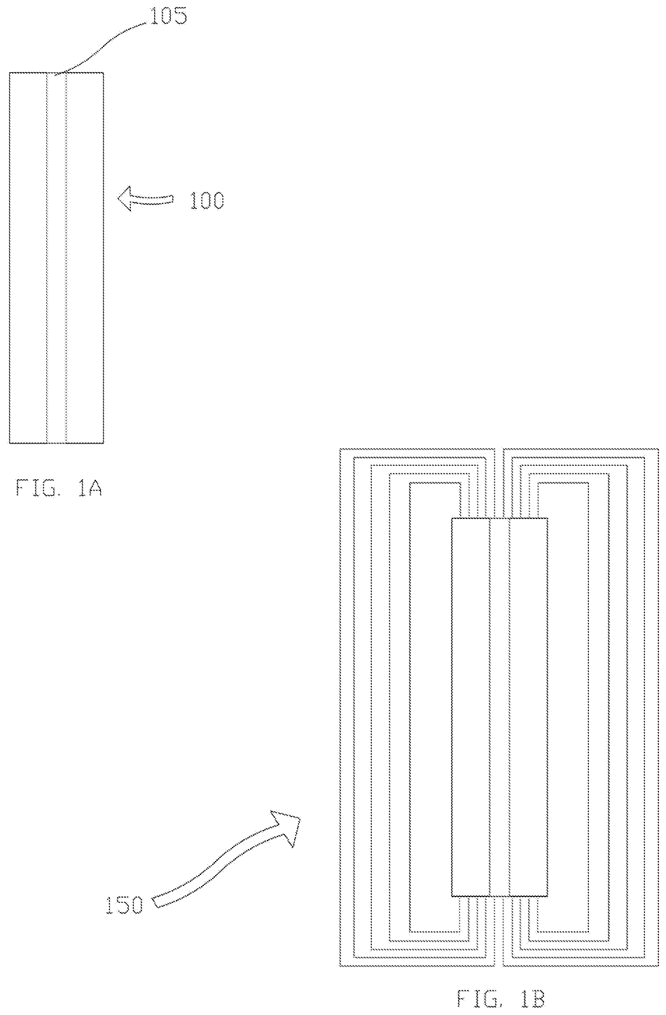

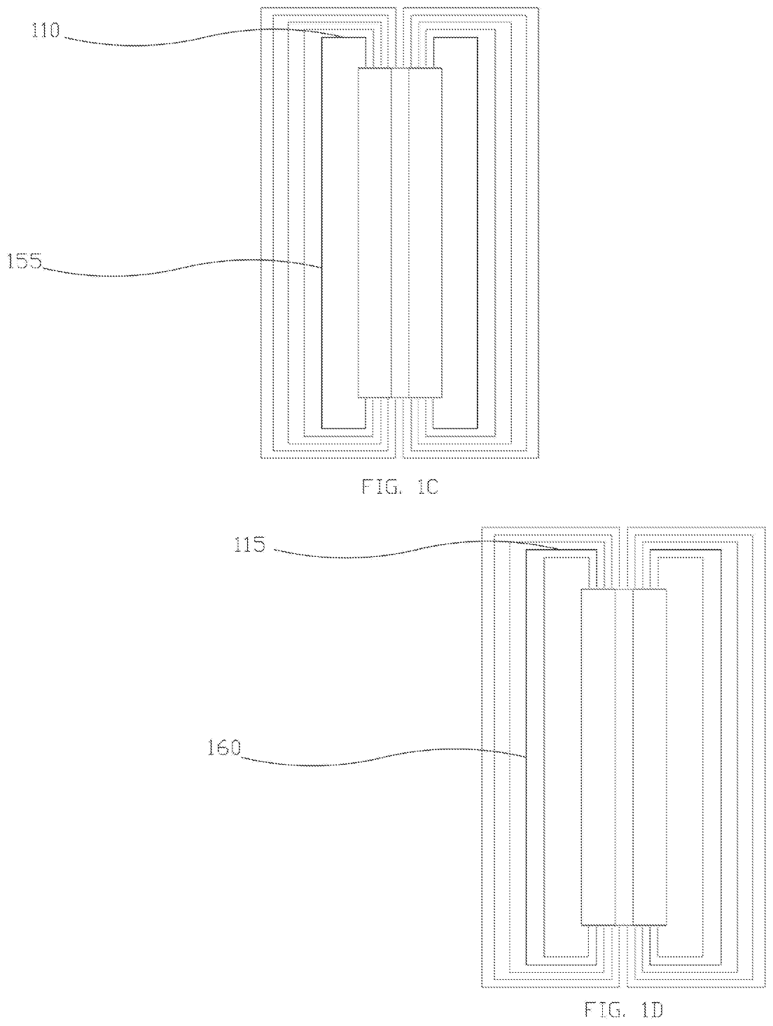

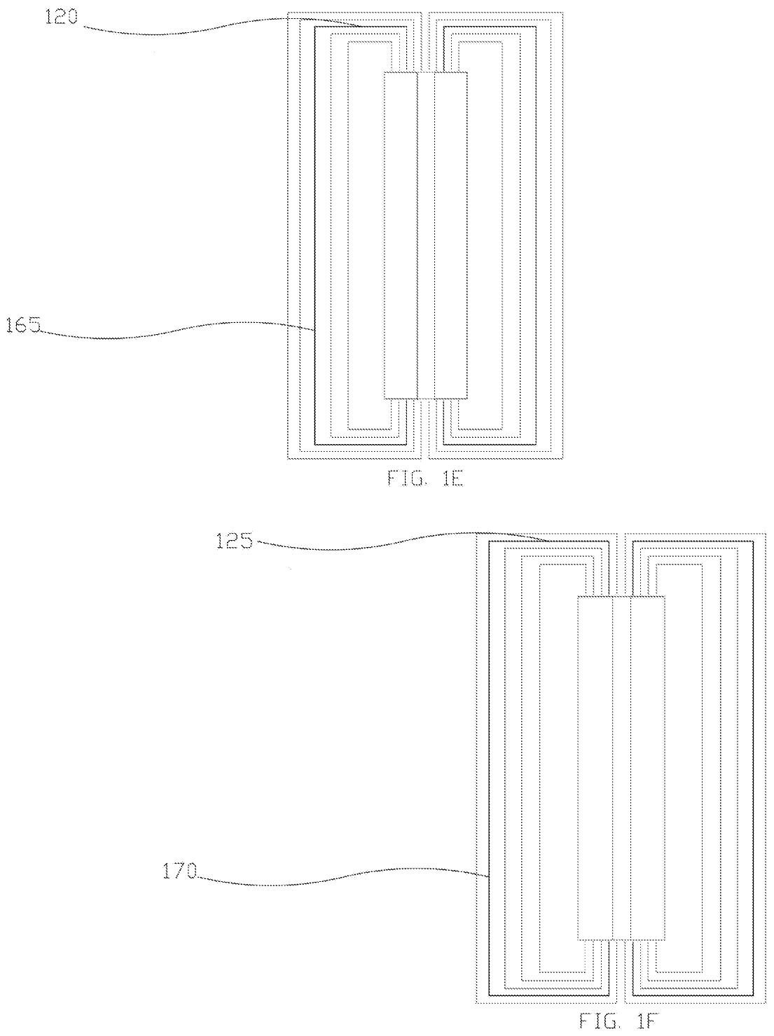

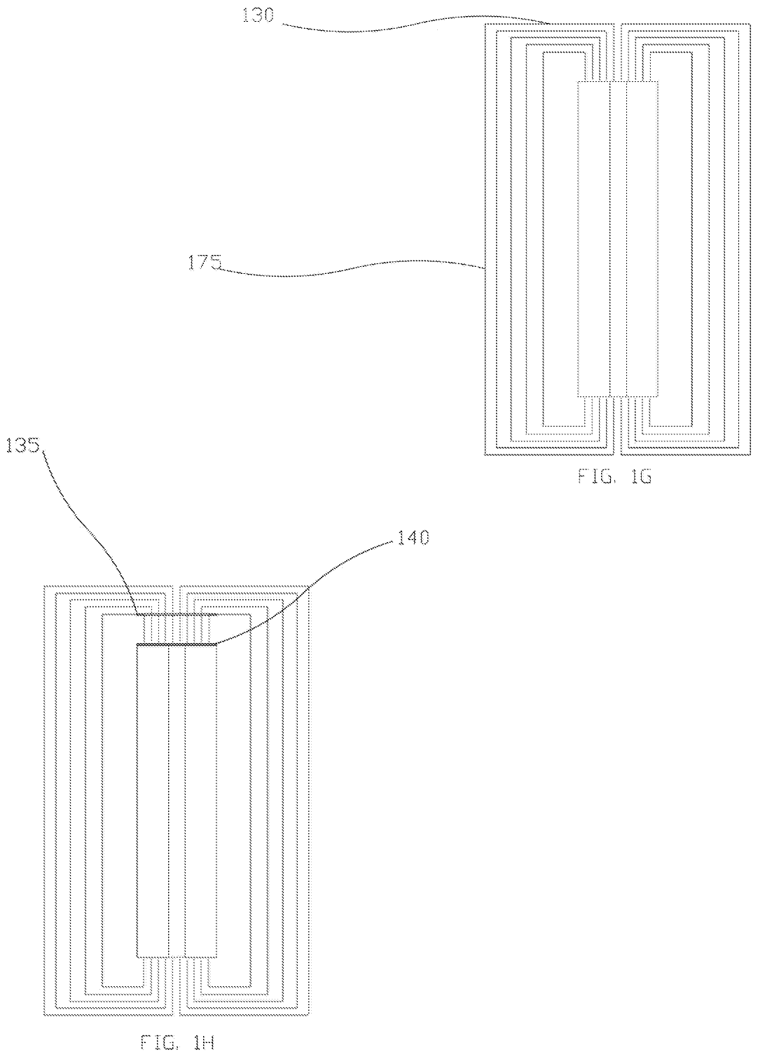

This FIG. 1A series illustrates the basic structure of a cylindrical permanent magnet from a front-view/cutaway perspective. FIG. 1A illustrates the structure of the cylindrical permanent magnet 100 where the magnetic field lines are not presently visible. The magnet has a hollow center 105, making its essentially a thick tube.

FIG. 1B illustrates—from a front-view/cutaway perspective—the cylindrical permanent magnet with its magnetic field lines 150. FIG. 1B demonstrates how the magnetic field lines form along various surfaces of the magnet, whether the sides or the poles. This FIG. 1B series also illustrates how homogeneous patterns of magnetic flux form around various surfaces of the magnet.

FIG. 1C illustrates—from a front-view/cutaway perspective—the cylindrical permanent magnet with its magnetic field lines where the innermost magnetic field 110 lines are highlighted as they emerge from magnet's surface. Furthermore, FIG. 1C illustrates an Activated Field Line 155 parallel to the side of the magnet's surface.

FIG. 1D illustrates—from a front-view/cutaway perspective—the cylindrical permanent magnet with its magnetic field lines where the second most inner magnetic field 115 lines are highlighted as they emerge from magnet's surface. Furthermore, FIG. 1D illustrates an Activated Field Line 160 parallel to the side of the magnet's surface.

FIG. 1E illustrates—from a front-view/cutaway perspective—the cylindrical permanent magnet with its magnetic field lines where the third most inner magnetic field 120 lines are highlighted as they emerges from magnet's surface. Furthermore, FIG. 1E illustrates an Activated Field Line 165 parallel to the side of the magnet's surface.

FIG. 1F illustrates—from a front-view/cutaway perspective—the cylindrical permanent magnet with its magnetic field lines where the fourth most inner magnetic field 125 lines are highlighted as they emerges from magnet's surface. Furthermore, FIG. 1F illustrates an Activated Field Line 170 parallel to the side of the magnet's surface.

FIG. 1G illustrates—from a front-view/cutaway perspective—the cylindrical permanent magnet with its magnetic field lines where the outermost magnetic field 130 lines are highlighted as they emerges from magnet's surface. Furthermore, FIG. 1G illustrates an Activated Field Line 175 parallel to the side of the magnet's surface.

FIG. 1H illustrates—from a front-view/cutaway perspective—the cylindrical permanent magnet with its magnetic field lines. It also highlights the surface of the magnetic pole from which the all of the various magnetic field lines emerge; these field lines form an image on the surface (not presently visible) called the Surface Image 140. Furthermore, FIG. 1H also highlights a plane, some distance from the surface of the magnet, where all of the various magnetic field lines are equidistant from the Surface Image 140. The pattern formed along this plane (not presently visible) is called Orbital Pattern 135.

FIG. 1I illustrates—from a front-view/cutaway perspective—the cylindrical permanent magnet with its magnetic field lines. It also illustrates the collection of the magnetic field lines 145 at the midpoint of the magnet.

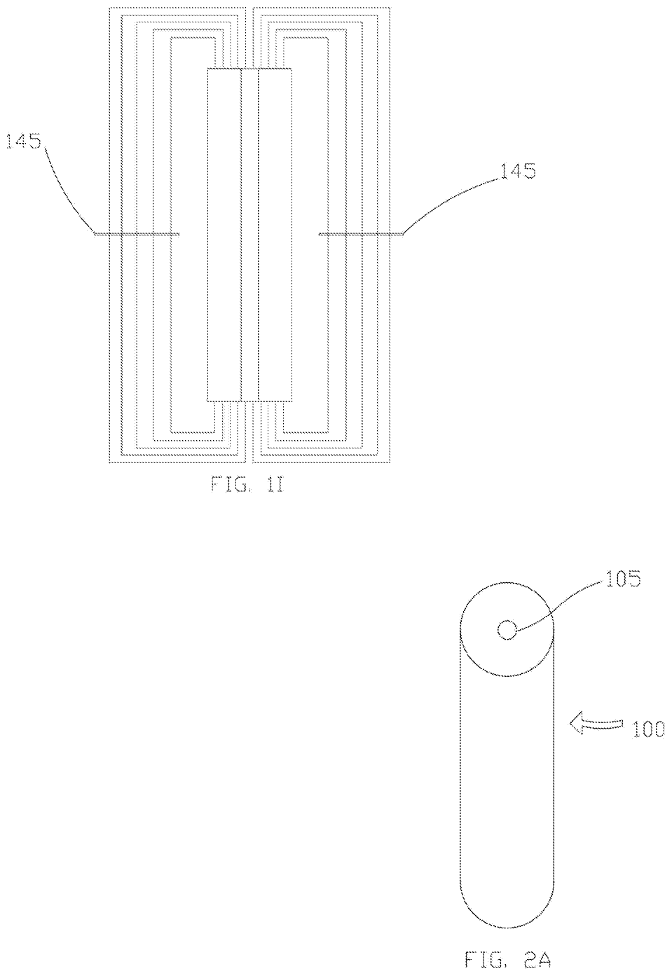

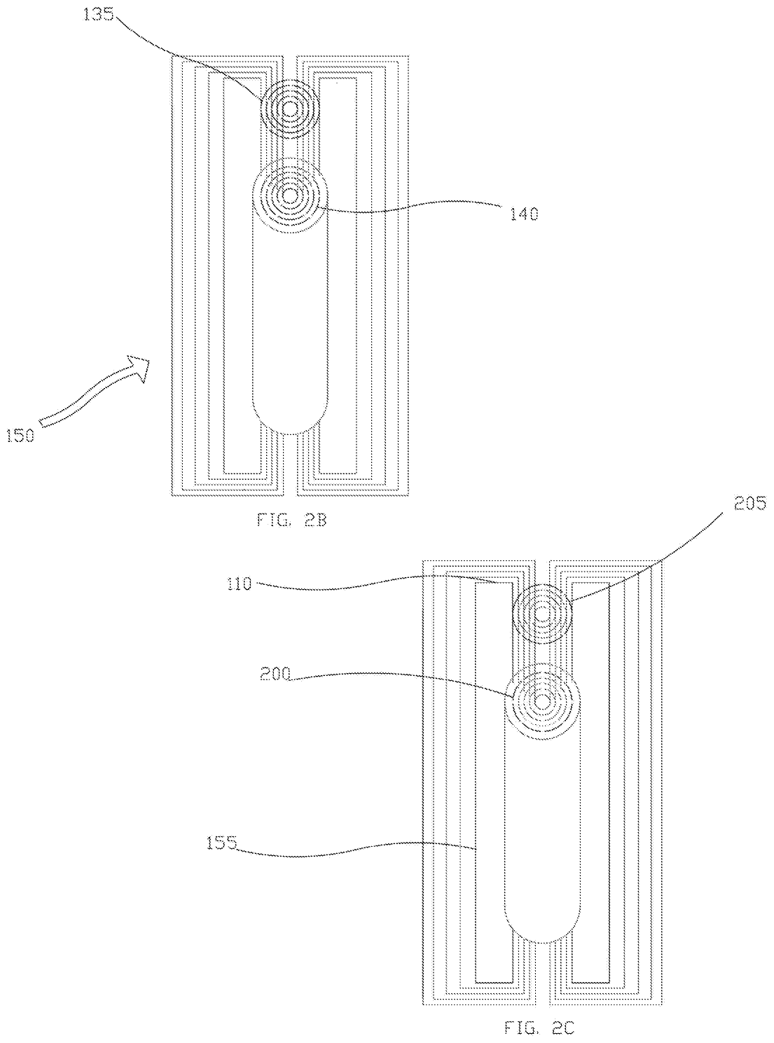

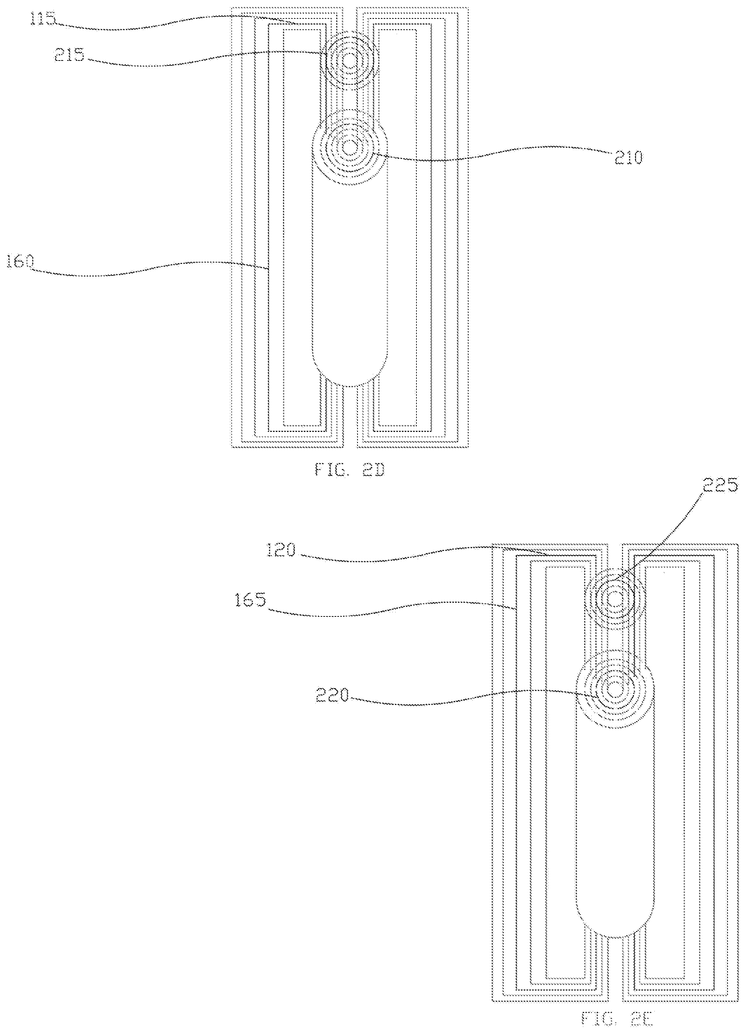

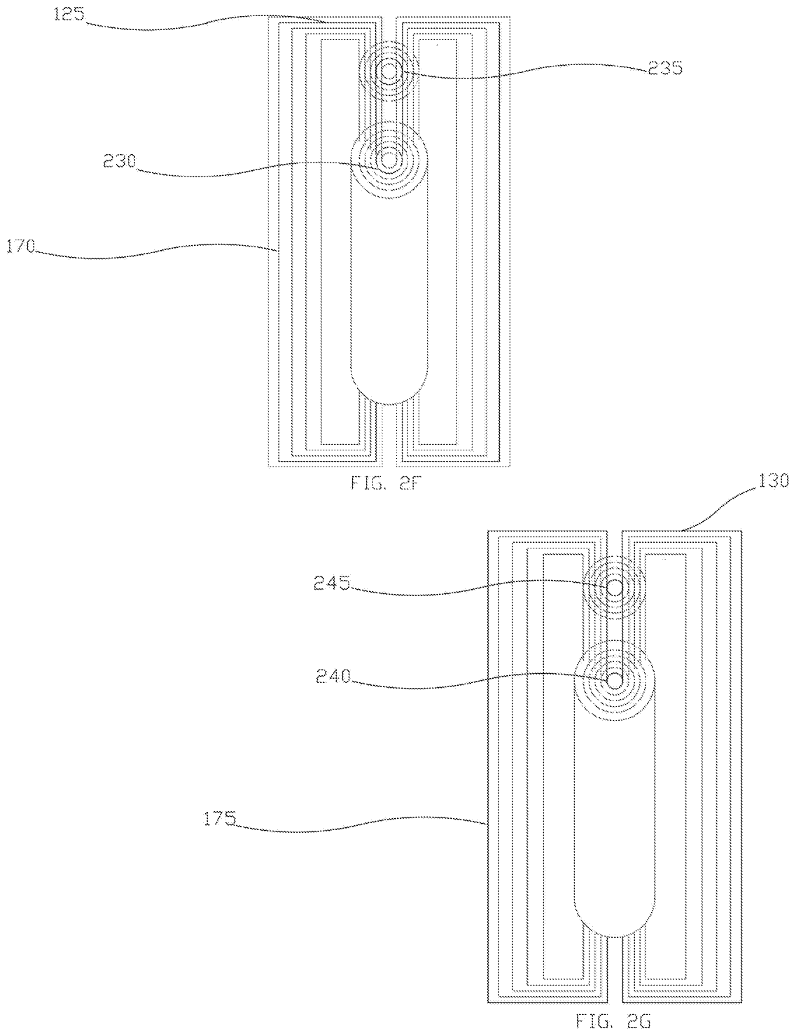

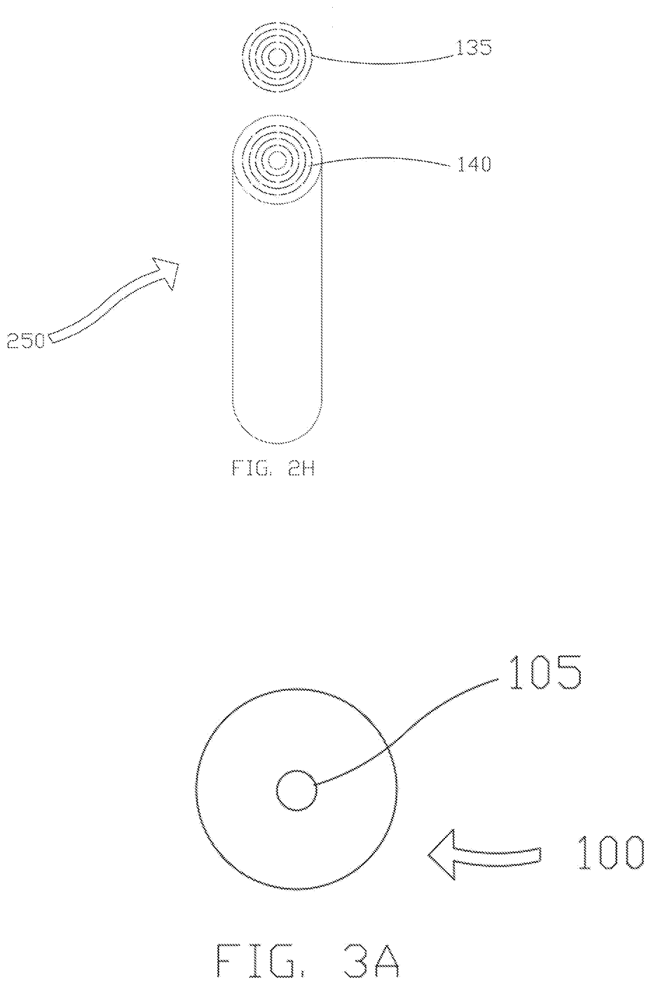

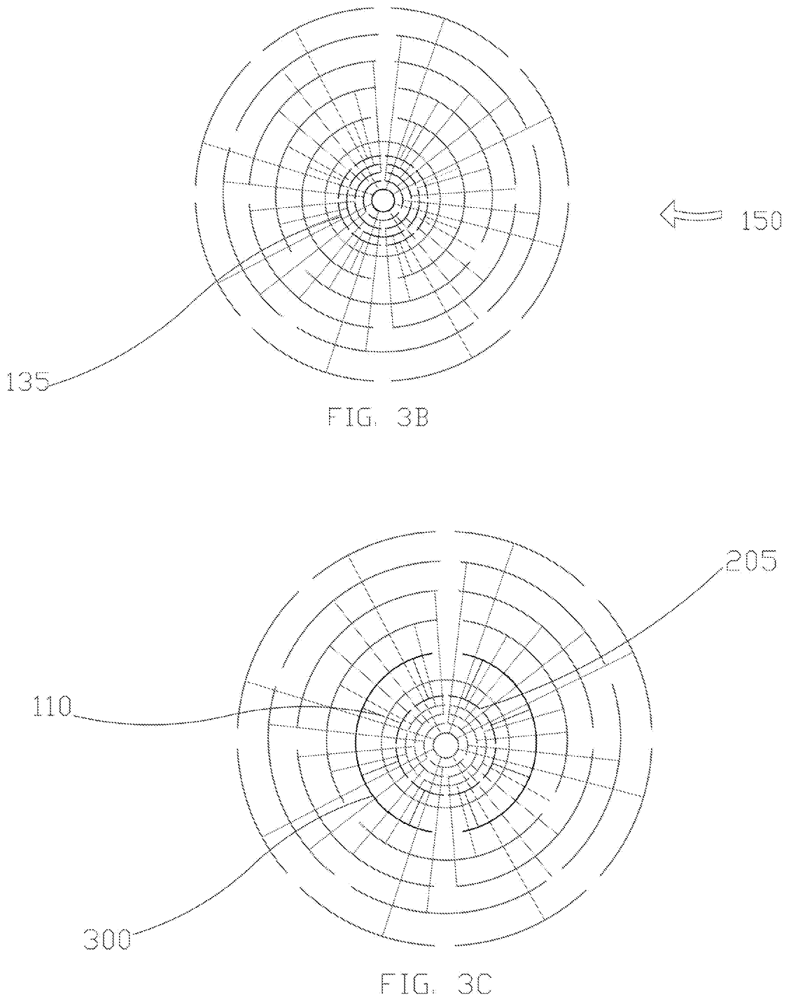

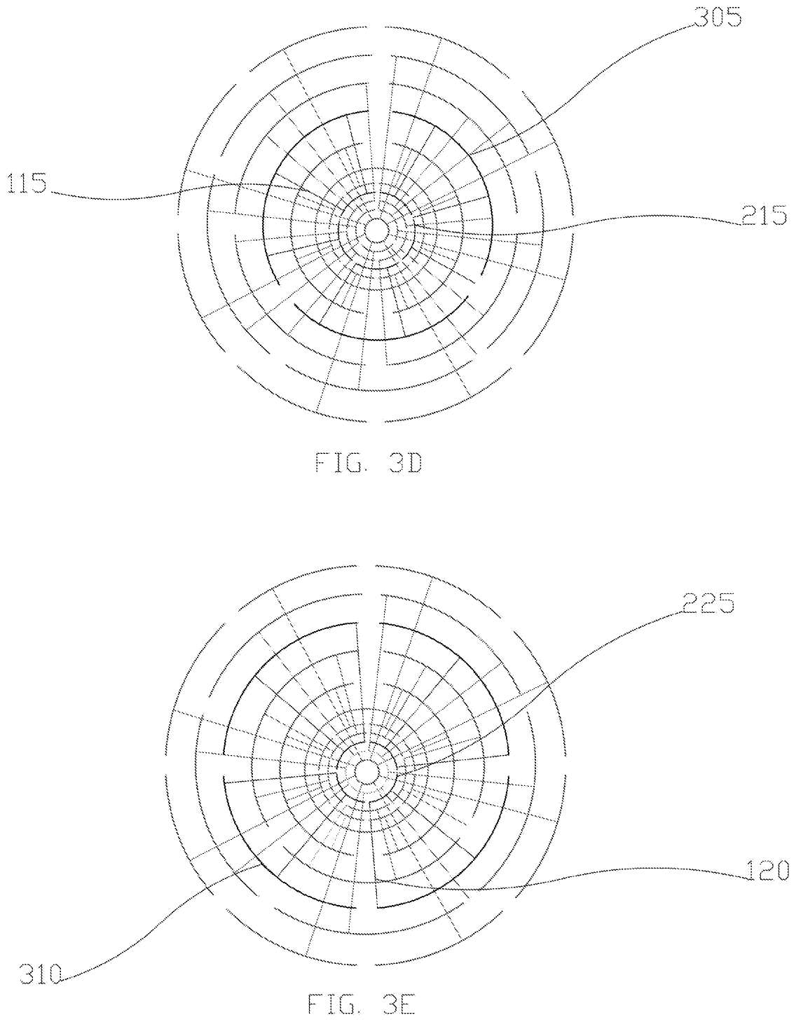

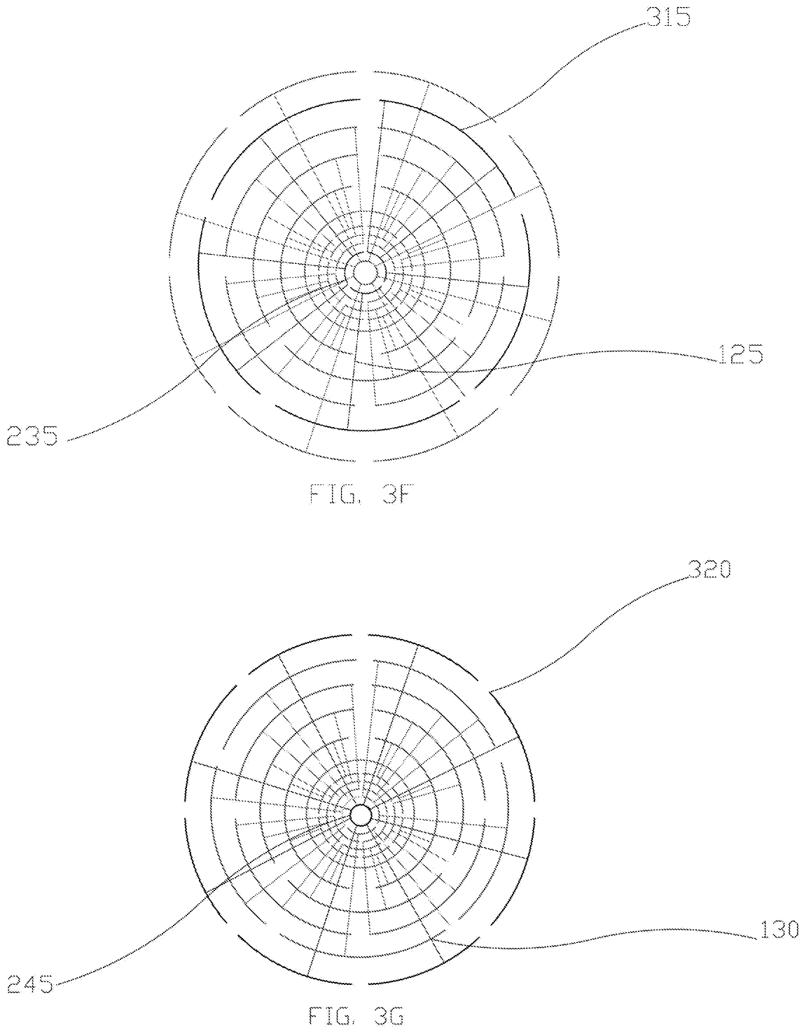

FIG. 2A illustrates—from the perspective of a ¾ view of the front/top of the magnet—the cylindrical permanent magnet 100. The magnetic field lines are not presently visible in this illustration. The magnet has a hollow center 105; making its essentially a thick tube.

FIG. 2B illustrates—from the perspective of a ¾ view of the front/top of the magnet—the cylindrical permanent magnet with its magnetic field lines 150. It also illustrates the pattern formed on the surface of the magnet's poles by the emerging magnetic field lines; this pattern formation is referred to as the Surface Image 140. Furthermore, FIG. 2B also illustrates a plane, some distance from the Surface Image 140, where all of the various magnetic field lines are equidistant from the Surface Image 140. The pattern that forms along this plane is called the Orbital Pattern 135.

FIG. 2C illustrates—from the perspective of a ¾ view of the front/top of the magnet—the cylindrical permanent magnet with its magnetic field lines where the innermost magnetic field lines 110 are highlighted. It also illustrates the circular pattern formed on the surface of the magnet's poles by these innermost magnetic field lines 110; this pattern formation is referred to as its Activated Image 200. Furthermore, FIG. 2C also illustrates a plane, some distance from its Activated Image 200, where all of these innermost magnetic field lines 110 are equidistant from its Activated Image 200. The pattern that forms along this plane is called its Activated Orbital 205. Finally, FIG. 2C illustrates an Activated Field Line 155 parallel to the side of the magnet's surface.

FIG. 2D illustrates—from the perspective of a ¾ view of the front/top of the magnet—the cylindrical permanent magnet with its magnetic field lines where the second most inner magnetic field lines 115 are highlighted. It also illustrates the circular pattern formed on the surface of the magnet's poles by these second most inner magnetic field lines 115; this pattern formation is referred to as its Activated Image 210. Furthermore, FIG. 2D also illustrates a plane, some distance from its Activated Image 210, where all of these second most inner magnetic field lines 115 are equidistant from its Activated Image 210. The pattern that forms along this plane is called its Activated Orbital 215. Finally, FIG. 2D illustrates an Activated Field Line 160 parallel to the side of the magnet's surface.

FIG. 2E illustrates—from the perspective of a ¾ view of the front/top of the magnet—the cylindrical permanent magnet with its magnetic field lines where the third most inner magnetic field lines 120 are highlighted. It also illustrates the circular pattern formed on the surface of the magnet's poles by these third most inner magnetic field lines 120; this pattern formation is referred to as its Activated Image 220. Furthermore, FIG. 2E also illustrates a plane, some distance from its Activated Image 220, where all of these third most inner magnetic field lines 120 are equidistant from its Activated Image 220. The pattern that forms along this plane is called its Activated Orbital 225. Finally, FIG. 2E illustrates an Activated Field Line 165 parallel to the side of the magnet's surface.

FIG. 2F illustrates—from the perspective of a ¾ view of the front/top of the magnet—the cylindrical permanent magnet with its magnetic field lines where the fourth most inner magnetic field lines 125 are highlighted. It also illustrates the circular pattern formed on the surface of the magnet's poles by these fourth most inner magnetic field lines 125; this pattern formation is referred to as its Activated Image 230. Furthermore, FIG. 2F also illustrates a plane, some distance from its Activated Image 230, where all of these fourth most inner magnetic field lines 125 are equidistant from its Activated Image 230. The pattern that forms along this plane is called its Activated Orbital 235. Finally, FIG. 2F illustrates an Activated Field Line 170 parallel to the side of the magnet's surface.

FIG. 2G illustrates—from the perspective of a ¾ view of the front/top of the magnet—the cylindrical permanent magnet with its magnetic field lines where the outermost magnetic field lines 130 are highlighted. It also illustrates the circular pattern formed on the surface of the magnet's poles by these outermost magnetic field lines 130; this pattern formation is referred to as its Activated Image 240. Furthermore, FIG. 2G also illustrates a plane, some distance from its Activated Image 240, where all of these outermost magnetic field lines 130 are equidistant from its Activated Image 240. The pattern that forms along this plane is called its Activated Orbital 245. Finally, FIG. 2G illustrates an Activated Field Line 175 parallel to the side of the magnet's surface.

FIG. 2H illustrates—from the perspective of a ¾ view of the front/top of the magnet—a cylindrical permanent magnet with select portions of its magnetic field lines 250. The illustration also highlights the Surface Image 140 as well as the Orbital Pattern 135.

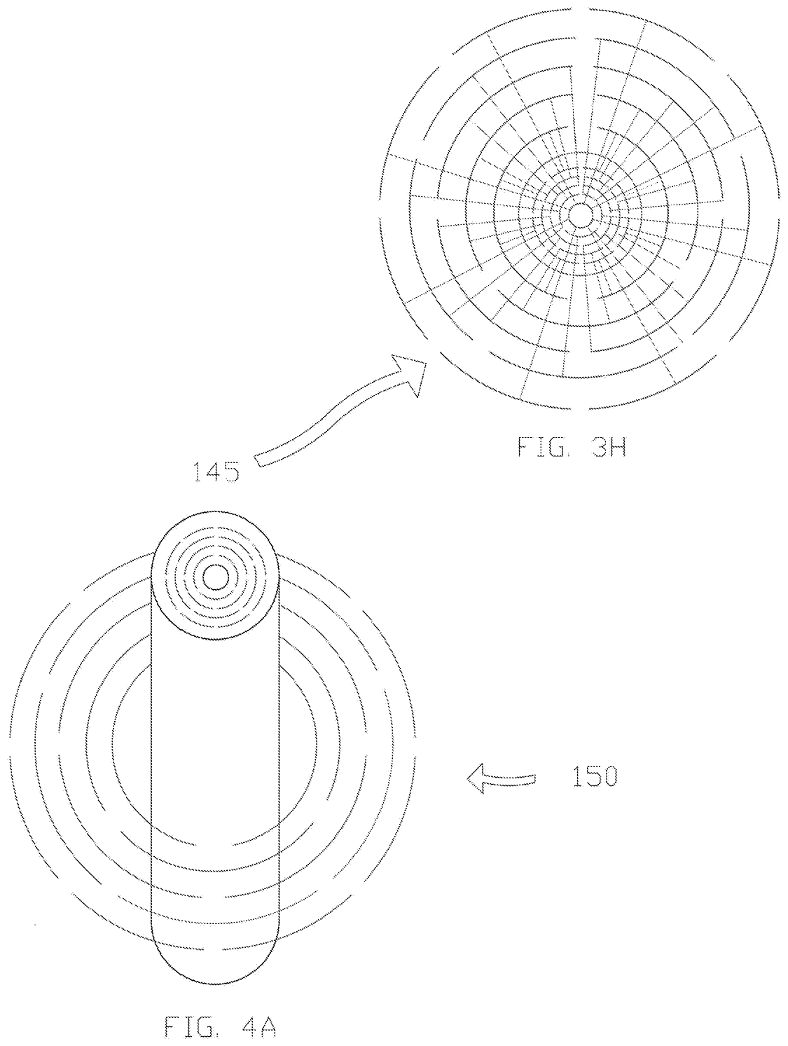

FIG. 3A illustrates—from a top view—the basic structure of a cylindrical permanent magnet 100. The magnetic field lines are not presently visible in this illustration. The magnet has a hollow center 105; making its essentially a thick tube.

FIG. 3B illustrates—from a top view—a cylindrical permanent magnet with its magnetic field lines 150. Furthermore, FIG. 3B also highlights the Orbital Pattern 135. This FIG. 3B series also illustrates how homogeneous patterns of magnetic flux form around these various magnetic surfaces.

FIG. 3C illustrates—from a top view—a cylindrical permanent magnet with its magnetic field lines where the innermost magnetic field lines 110 are highlighted. FIG. 3C also illustrates an Activated Orbital 205 formed by these innermost magnetic field lines 110 at the magnet's pole. Finally, FIG. 3C illustrates the Activated Orbital 300 formed by these innermost magnetic field lines 110 at the magnet's sides.

FIG. 3D illustrates—from a top view—a cylindrical permanent magnet with its magnetic field lines where the second most inner magnetic field lines 115 are highlighted. FIG. 3D also illustrates an Activated Orbital 215 formed by these second most inner magnetic field lines 115 at the magnet's pole. Finally, FIG. 3D illustrates the Activated Orbital 305 formed by these second most inner magnetic field lines 115 at the magnet's sides.

FIG. 3E illustrates—from a top view—a cylindrical permanent magnet with its magnetic field lines where the third most inner magnetic field lines 120 are highlighted. FIG. 3E also illustrates an Activated Orbital 225 formed by these third most inner magnetic field lines 120 at the magnet's pole. Finally, FIG. 3E illustrates the Activated Orbital 310 formed by these third most inner magnetic field lines 120 at the magnet's sides.

FIG. 3F illustrates—from a top view—a cylindrical permanent magnet with its magnetic field lines where the fourth most inner magnetic field lines 125 are highlighted. FIG. 3F also illustrates an Activated Orbital 235 formed by these fourth most inner magnetic field lines 125 at the magnet's pole. Finally, FIG. 3F illustrates the Activated Orbital 315 formed by these fourth most inner magnetic field lines 125 at the magnet's sides.

FIG. 3G illustrates—from a top view—a cylindrical permanent magnet with its magnetic field lines where the outermost magnetic field lines 130 are highlighted. FIG. 3G also illustrates an Activated Orbital 245 formed by these outermost magnetic field lines 130 at the magnet's pole. Finally, FIG. 3G illustrates the Activated Orbital 320 formed by these outermost magnetic field lines 130 at the magnet's sides.

FIG. 3H illustrates—from a top view—a cylindrical permanent magnet with its magnetic field lines. Further it highlights the collection of the magnetic field lines at the midpoint 145 of the magnet.

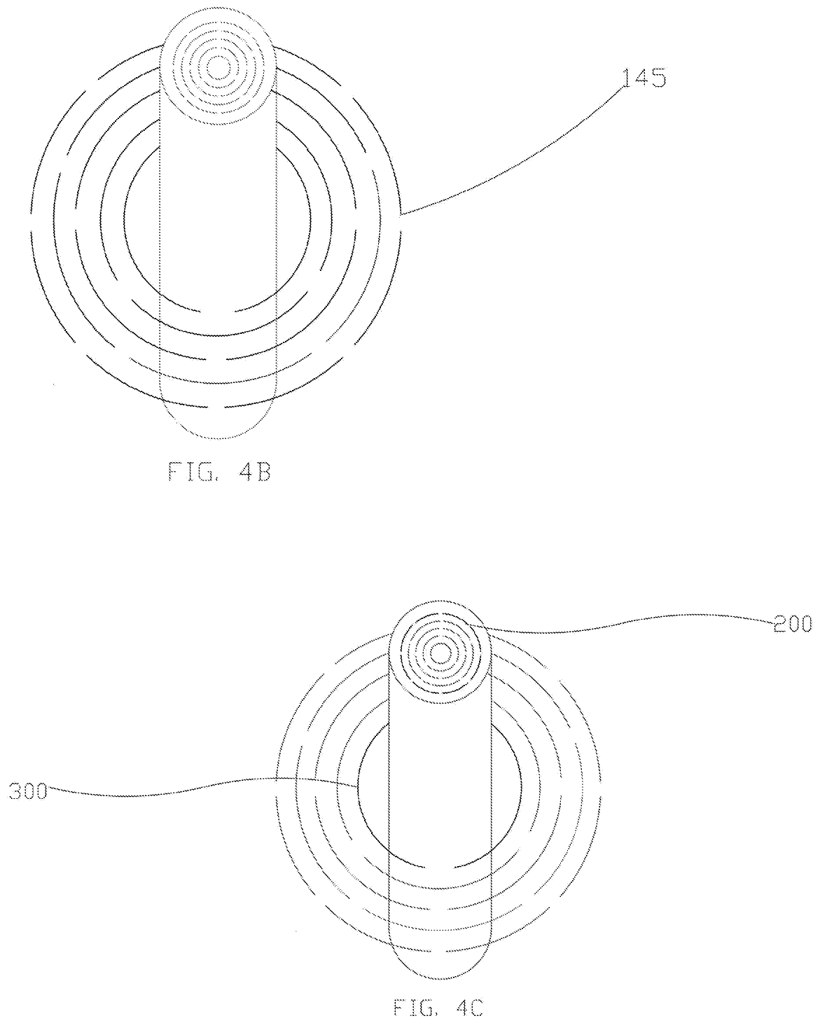

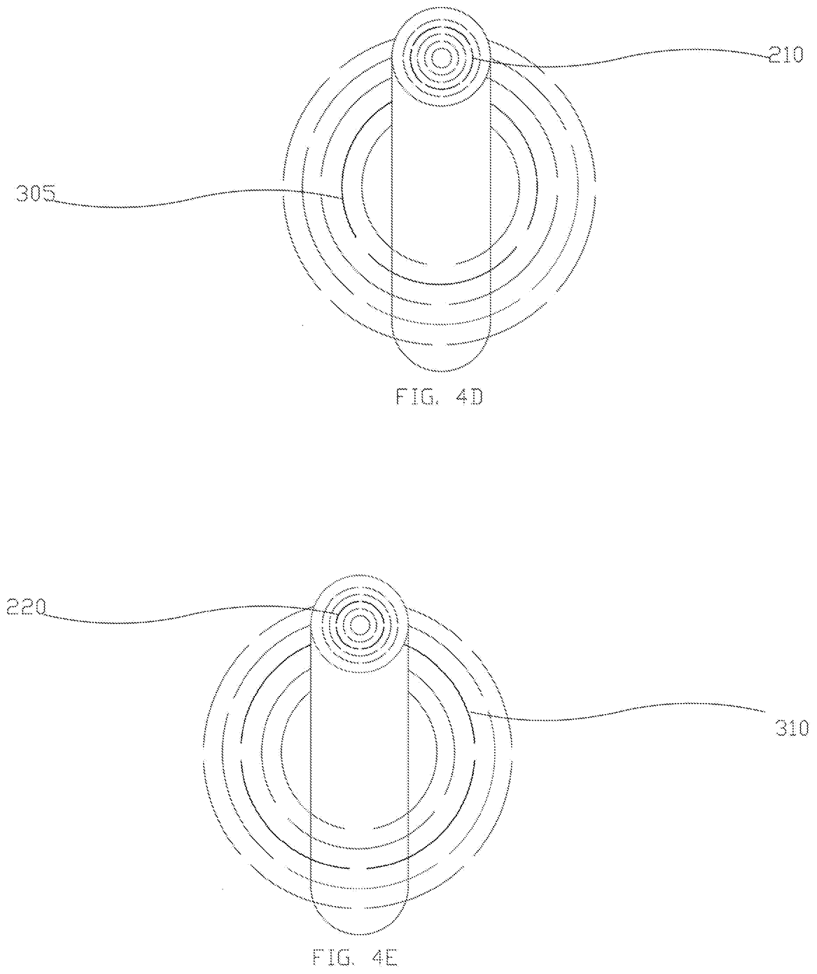

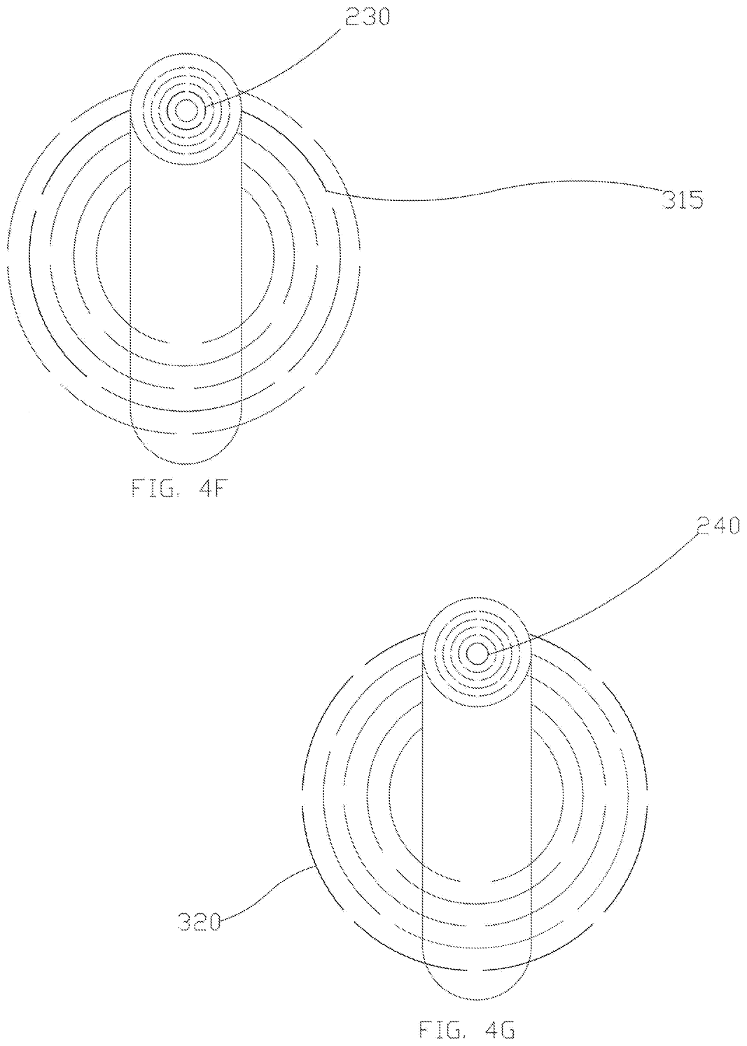

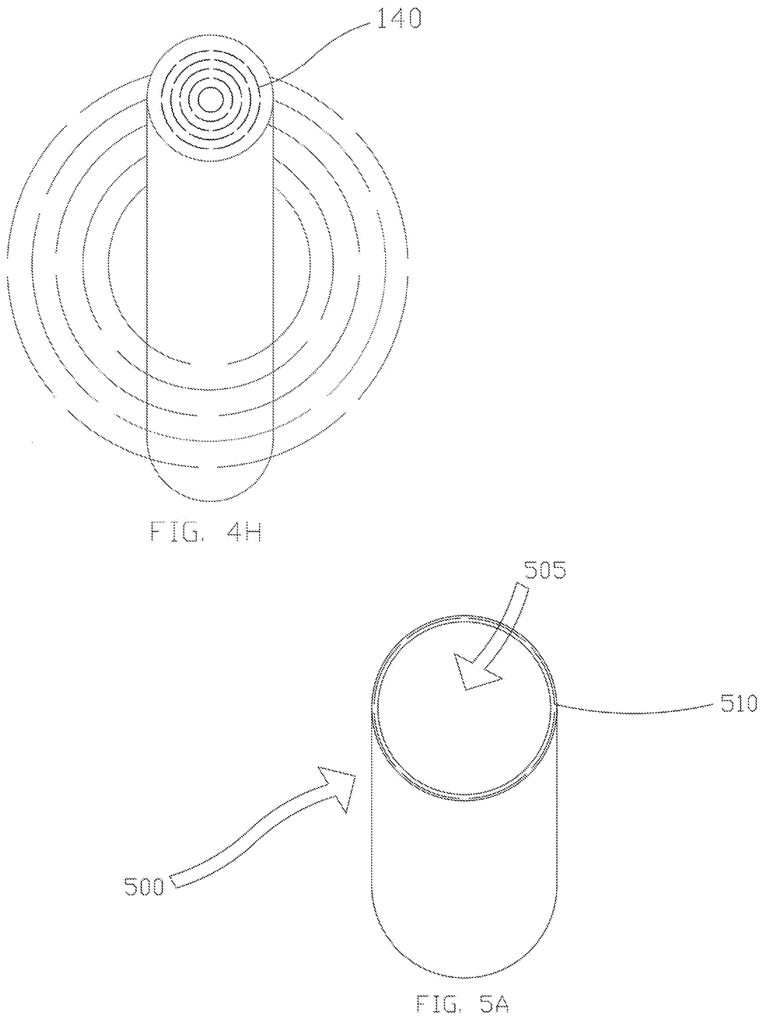

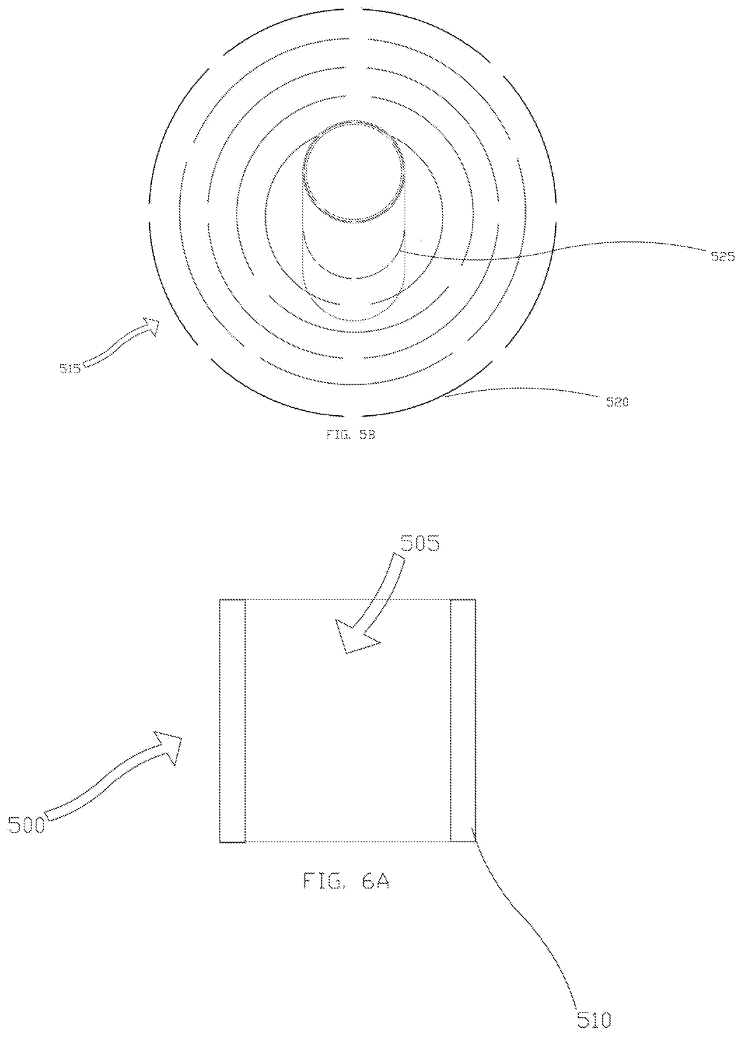

FIG. 4A illustrates—from the perspective of a ¾ view of the front/top of the magnet—a cylindrical permanent magnet with (a selection of) its magnetic field lines 150. It also demonstrates how magnetic field lines form along particular surfaces of the magnet, whether at its midpoint or its poles. This FIG. 4A series also illustrates how homogeneous patterns of magnetic flux form around these various magnetic surfaces.

FIG. 4B illustrates—from the perspective of a ¾ view of the front/top of the magnet—a cylindrical permanent magnet with (a selection of) its magnetic field lines. Furthermore, FIG. 4B also highlights the collection of the magnetic field lines at the midpoint 145 of the magnet.

FIG. 4C illustrates—from the perspective of a ¾ view of the front/top of the magnet—a cylindrical permanent magnet with (a selection of) its magnetic field lines. It also illustrates the Activated Surface 200 from which these innermost magnetic field lines emerge. Finally, FIG. 4C illustrates an Activated Orbital 300 formed by these innermost magnetic field lines at the magnet's sides.

FIG. 4D illustrates—from the perspective of a ¾ view of the front/top of the magnet—a cylindrical permanent magnet with (a selection of) its magnetic field lines. It also illustrates the Activated Surface 210 from which these second most inner magnetic field lines emerge. Finally, FIG. 4D illustrates an Activated Orbital 305 formed by these second most inner magnetic field lines at the magnet's sides.

FIG. 4E illustrates—from the perspective of a ¾ view of the front/top of the magnet—a cylindrical permanent magnet with (a selection of) its magnetic field lines. It also illustrates the Activated Surface 220 from which these third most inner magnetic field lines emerge. Finally, FIG. 4E illustrates an Activated Orbital 310 formed by these third most inner magnetic field lines at the magnet's sides.

FIG. 4F illustrates—from the perspective of a ¾ view of the front/top of the magnet—a cylindrical permanent magnet with (a selection of) its magnetic field lines. It also illustrates the Activated Surface 230 from which these fourth most inner magnetic field lines emerge. Finally, FIG. 4F illustrates an Activated Orbital 315 formed by these fourth most inner magnetic field lines at the magnet's sides.

FIG. 4G illustrates—from the perspective of a ¾ view of the front/top of the magnet—a cylindrical permanent magnet with (a selection of) its magnetic field lines. It also illustrates an Activated Surface 240 from which these outermost magnetic field lines emerge. Finally, FIG. 4G illustrates an Activated Orbital 320 formed by these fourth most inner magnetic field lines at the magnet's sides.

FIG. 4H illustrates—from the perspective of a ¾ view of the front/top of the magnet—a cylindrical permanent magnet with (a selection of) its magnetic field lines. FIG. 4H also highlights the Surface Image 140.

FIG. 5A illustrates—from the perspective of a ¾ view of the front/top of the magnet—a very wide cylindrical permanent magnet 500. The magnetic field lines are not presently visible in this illustration. The magnet has a very large hollow center 505; making it essentially a thin tube. Furthermore, the thin wall 510 of the magnet is also highlighted here.

FIG. 5B illustrates—from the perspective of a ¾ view of the front/top of the magnet—a very wide cylindrical permanent magnet with (a selection of) its magnetic field lines at its midpoint 515 where the outermost Activated Orbital 520 is highlighted. Furthermore, the midpoint of the magnet 525 is also highlighted here. It also demonstrates how magnetic field lines form along particular surfaces of the magnet, whether at its midpoint or its poles. This FIG. 5B series also illustrates how homogeneous patterns of magnetic flux form around these various magnetic surfaces.

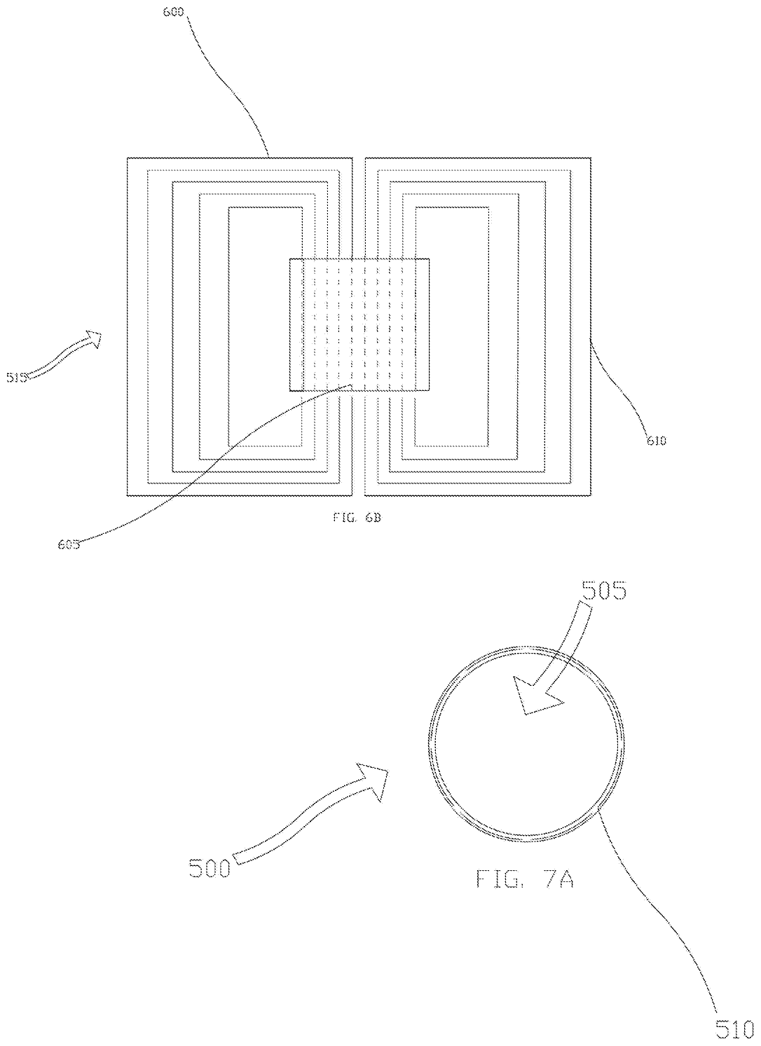

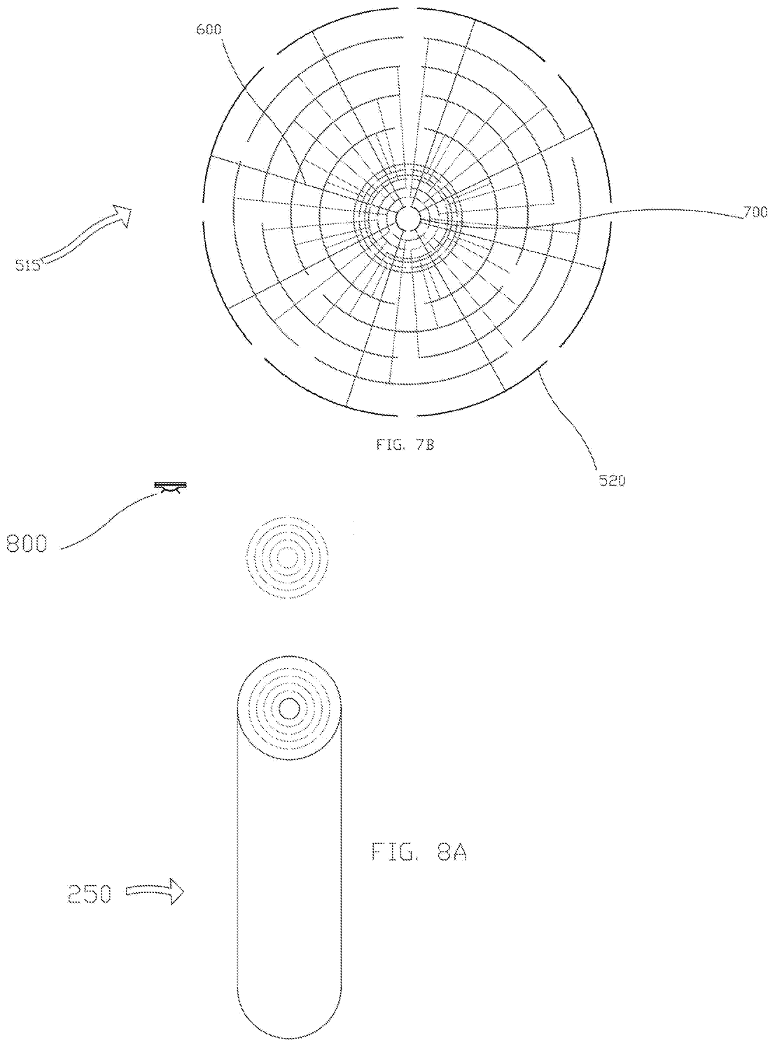

FIG. 6A illustrates—from a front-view/cutaway perspective—a very wide cylindrical permanent magnet 500. The magnetic field lines are not presently visible in this illustration. The magnet has a very large hollow center 505, making its essentially a thin tube. Furthermore, the thin wall of the magnet 510 is also highlighted here.

FIG. 6B illustrates—from a front-view/cutaway perspective—a very wide cylindrical permanent magnet with its magnetic field lines 515 where the outermost Activated Field Line 610 line is highlighted. Furthermore, we illustrate the path of the outermost field line 600 as it travels above/below the magnet. Finally, FIG. 6B illustrates the Activated Field Line 605 within the hollow of the magnet's center. It also demonstrates how the magnetic field lines form along various surfaces of the magnet, whether the sides or the poles. This FIG. 6B series also illustrates how homogeneous patterns of magnetic flux form around various surfaces of the magnet

FIG. 7A illustrates—from the perspective of the top view of the magnet—a very wide cylindrical permanent magnet 500. The magnetic field lines are not presently visible in this illustration. The magnet has a very large hollow center 505; making its essentially a thin tube. Furthermore, the thin wall of the magnet 510 is also highlighted here.

FIG. 7B illustrates—from the perspective of the top view of the magnet—a very wide cylindrical permanent magnet with (a selection of) its magnetic field lines 515 where the outermost magnetic field 600 lines are highlighted. Furthermore, we illustrate the outermost Activated Orbital 520 that forms outside the magnet's surface. Finally, we illustrate the outmost Activated Orbital 700 that forms within the magnet's hollow center. It also demonstrates how magnetic field lines form along various surfaces of the magnet, whether on its sides or its poles. This FIG. 7B series also illustrates how homogeneous patterns of magnetic flux form around these various magnetic surfaces.

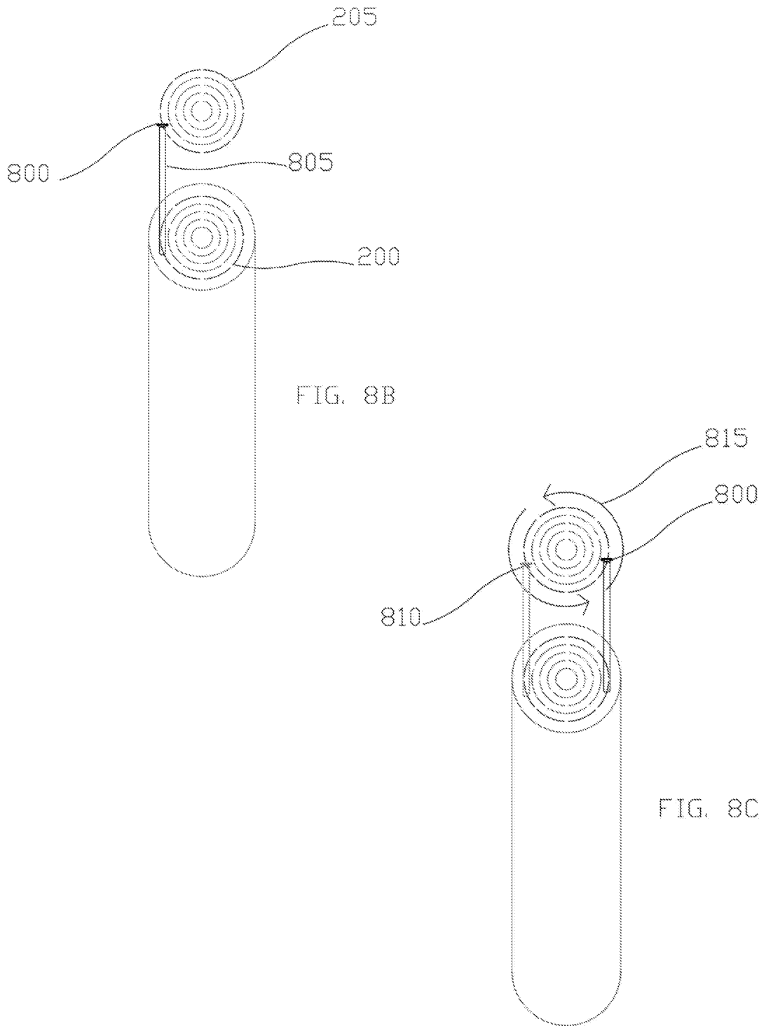

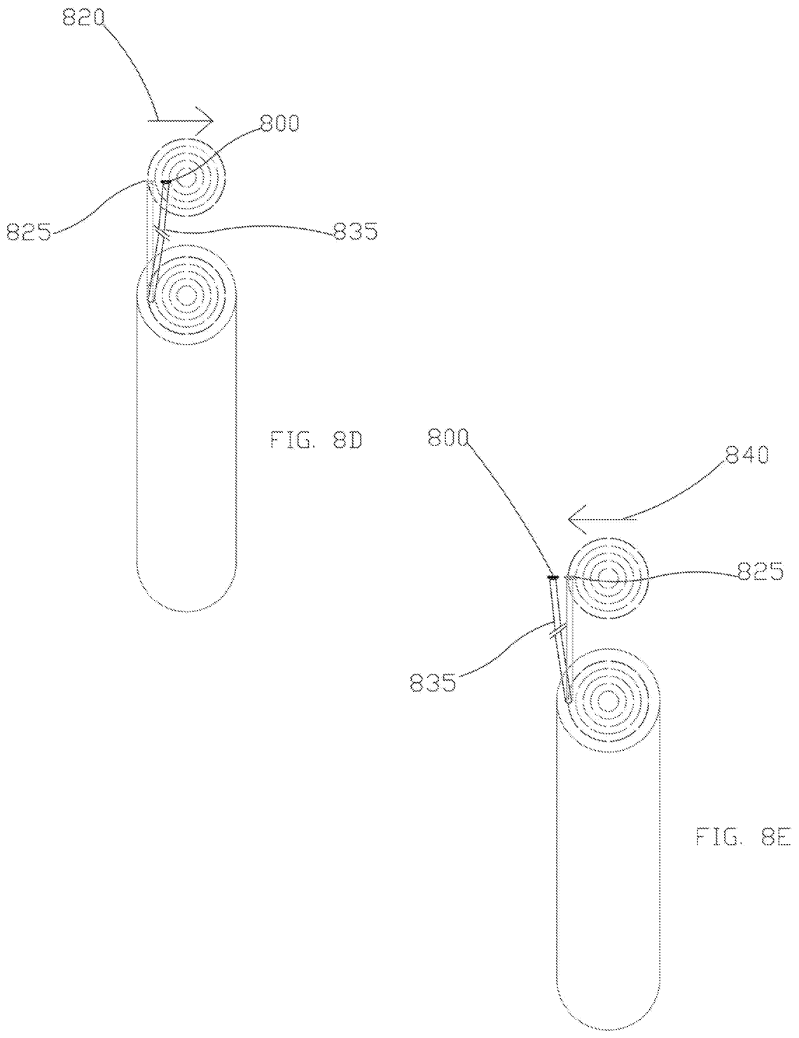

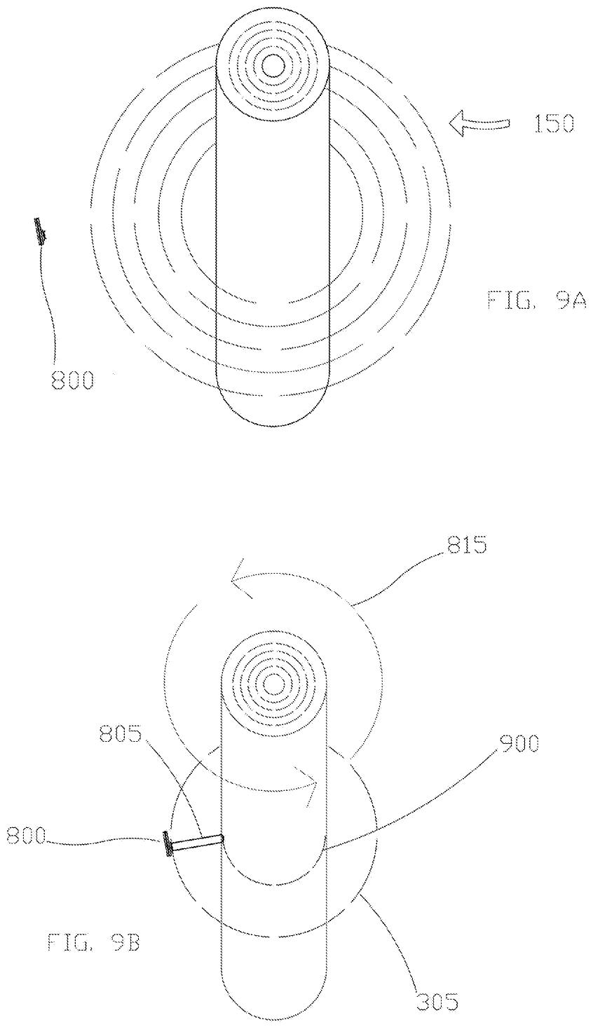

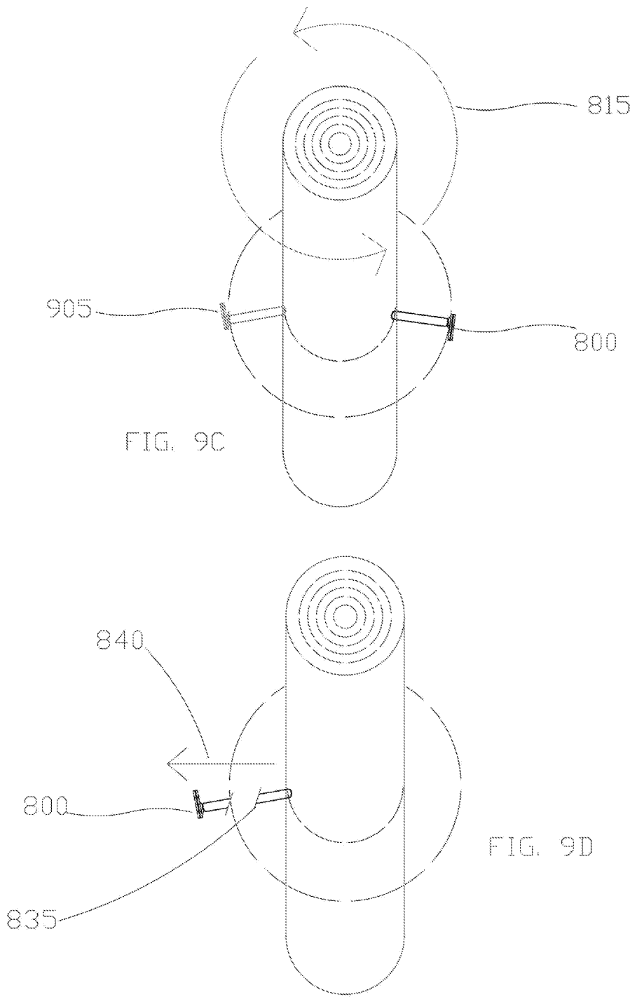

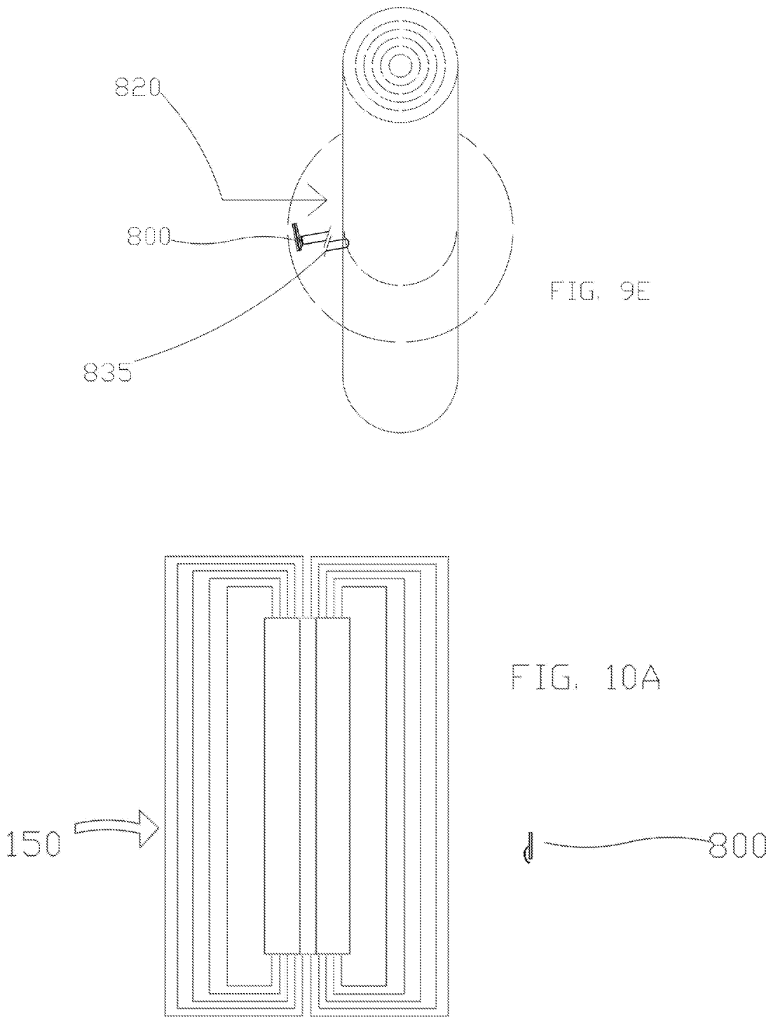

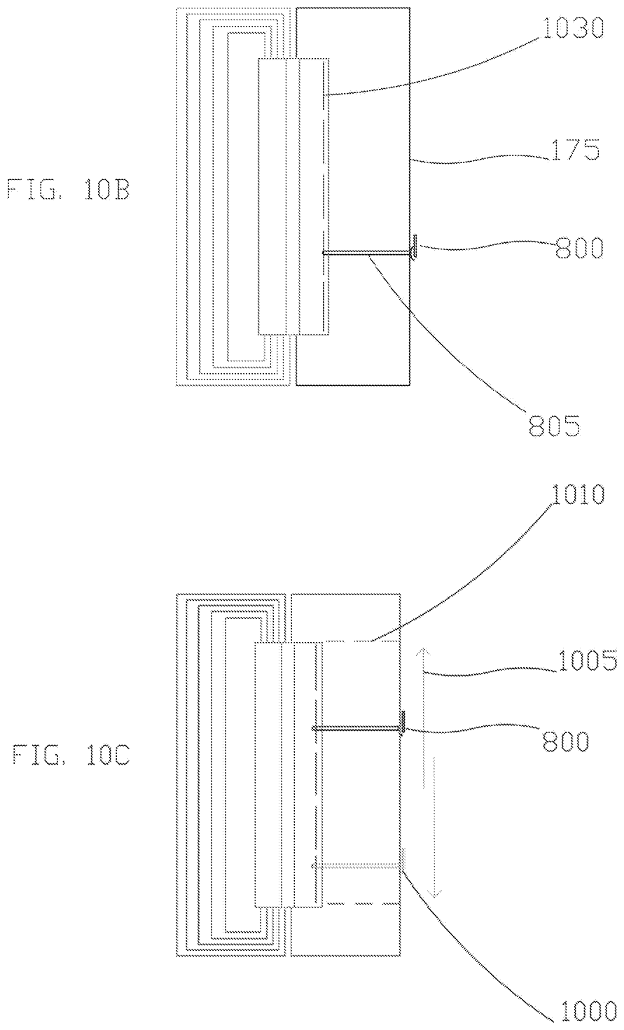

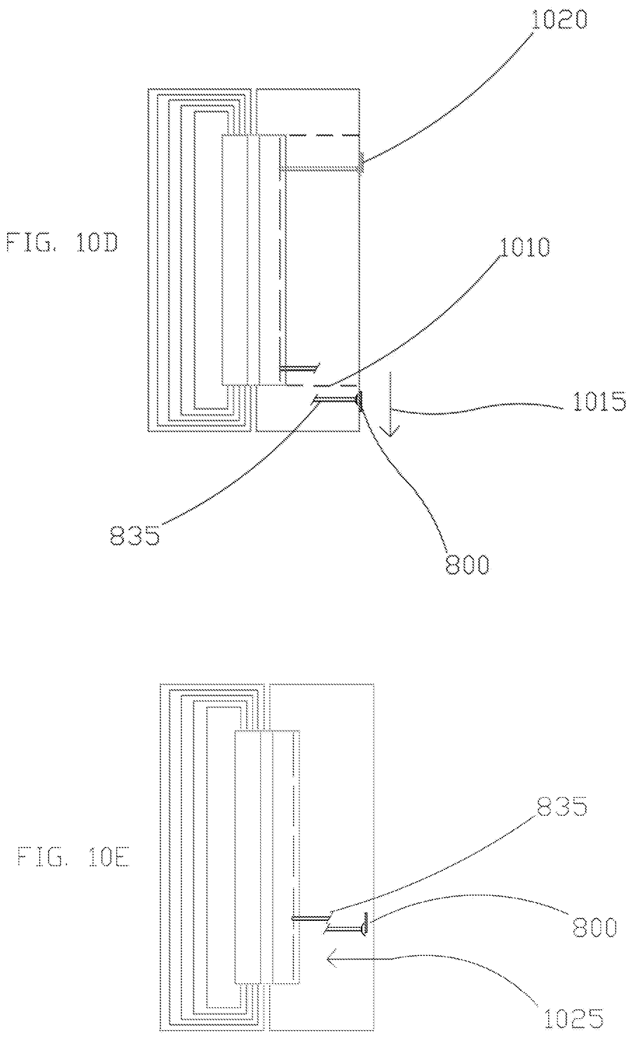

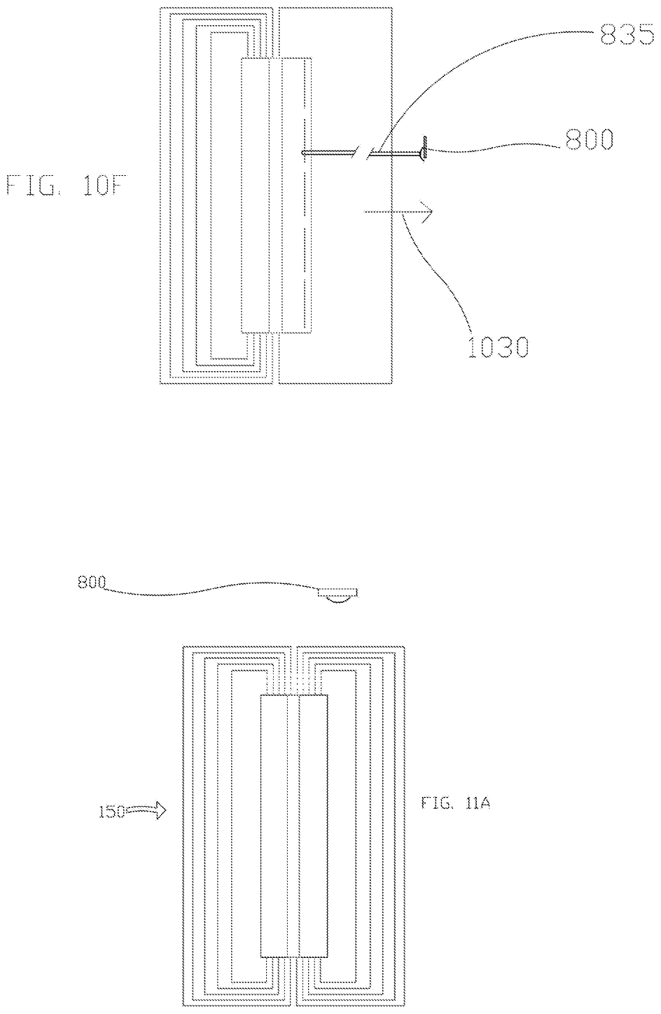

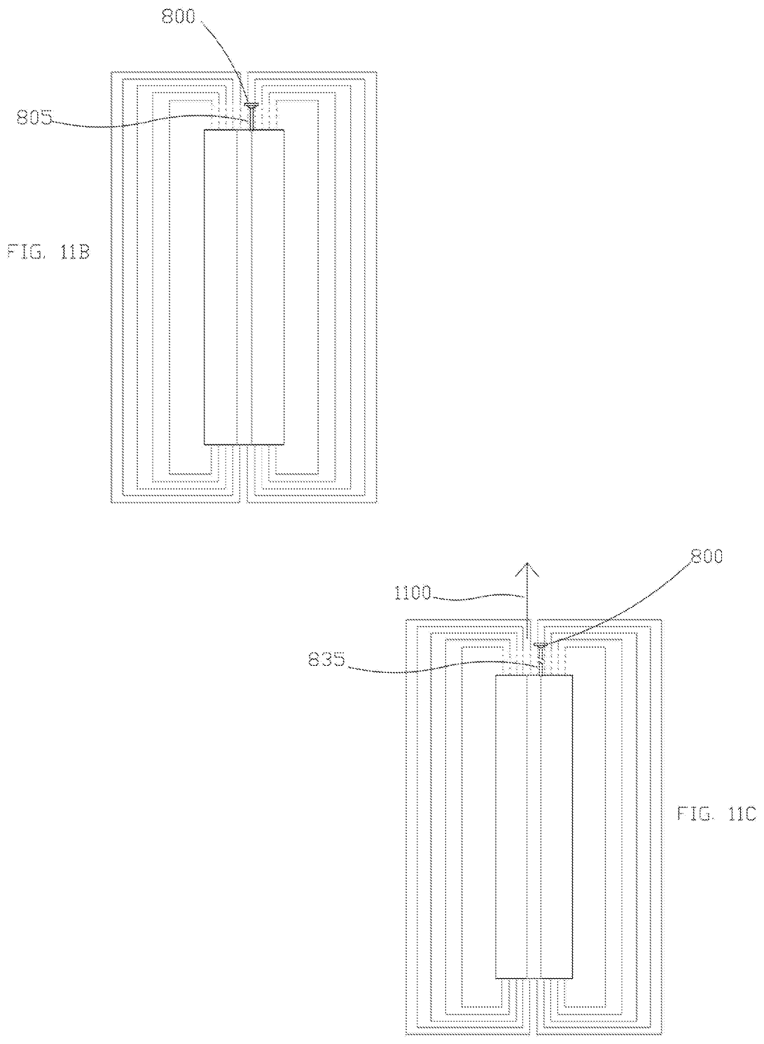

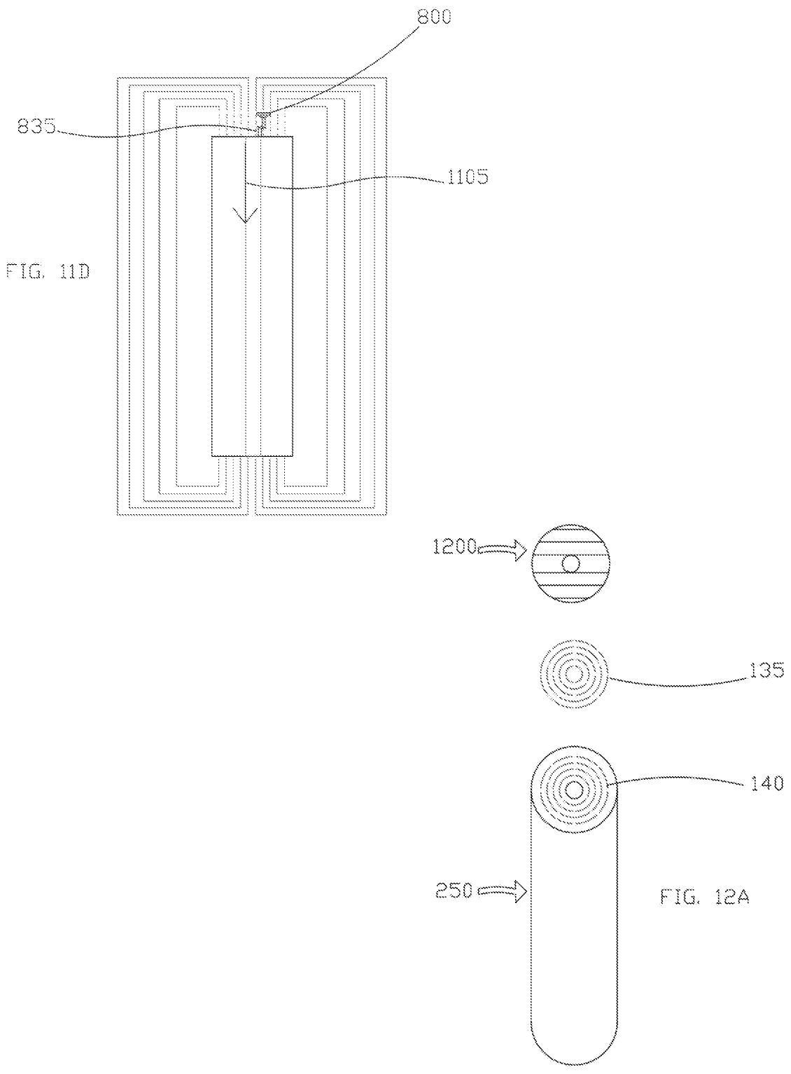

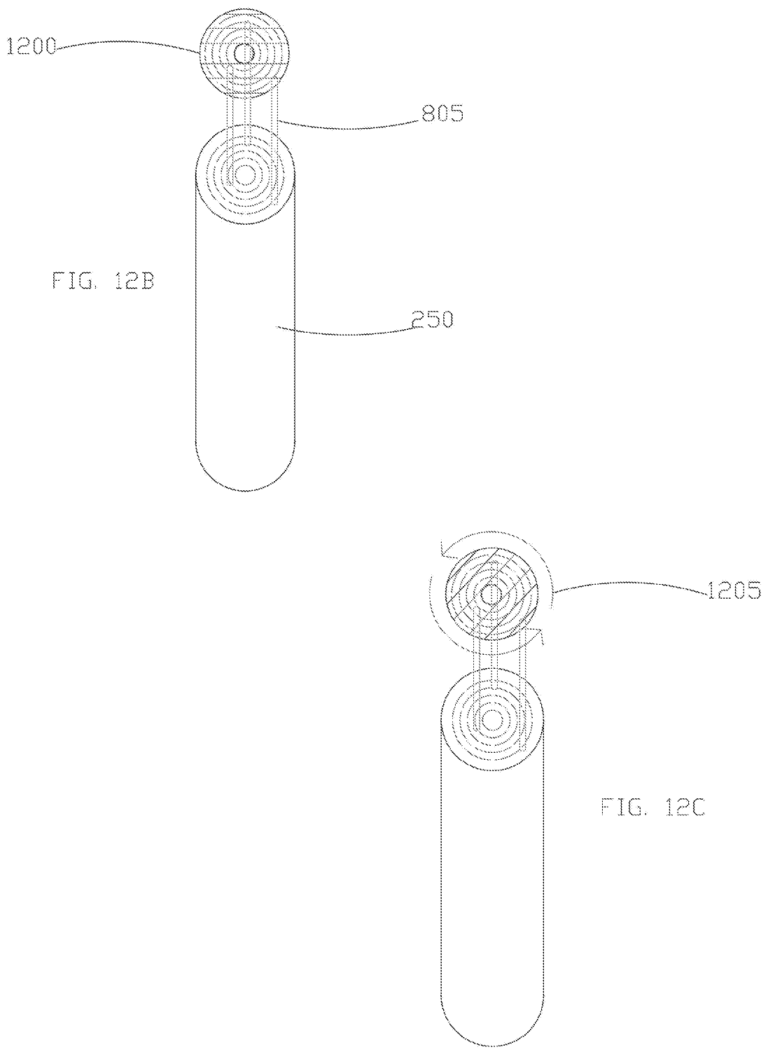

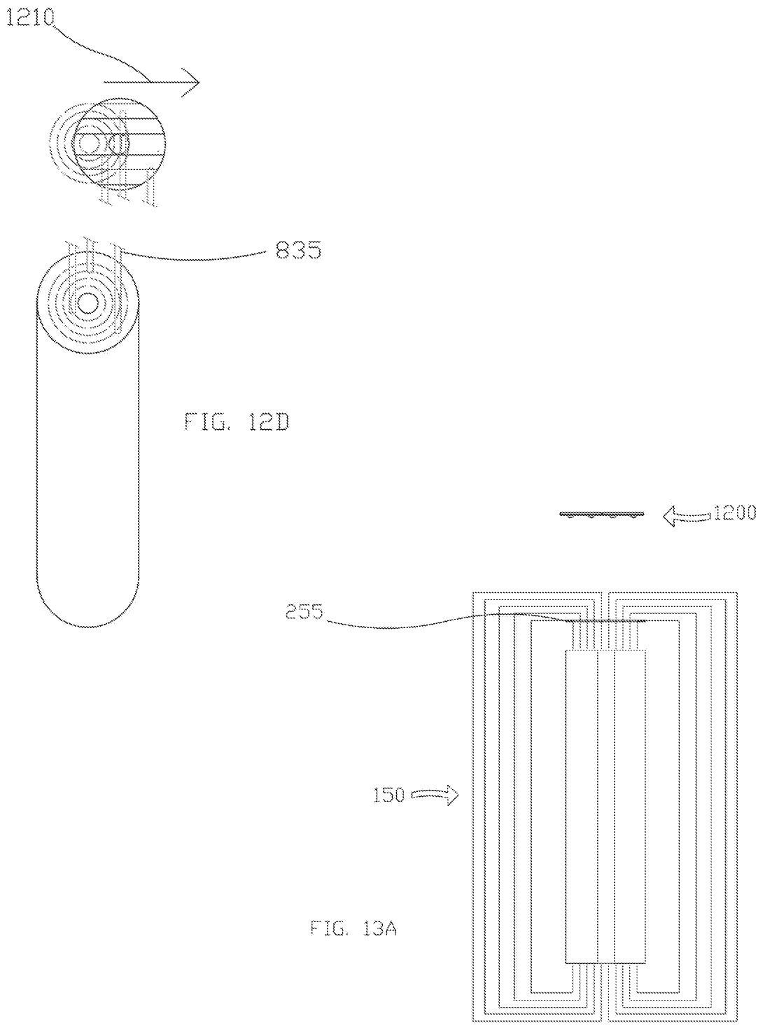

FIG. 8A illustrates—from a ¾ view of the front/top of a cylindrical permanent magnet—a cylindrical permanent magnet with select portions of its magnetic field lines 250, those select portion are—in particular—Orbital Pattern as well as the Surface Image produced at the pole of the magnet. Furthermore, FIG. 8A also illustrates a Levitator 800 within a certain proximity of the magnet. Levitator is composed of very thin layers of a High Temperature Superconductor (HTSC) capable of flux-pinning with the magnetic flux emanating from the magnet. In the present illustration, the Levitator 800 is out of range of the magnetic field and cannot flux pin with the magnet.

FIG. 8B illustrates—from a ¾ view of the front/top of a cylindrical permanent magnet—a Levitator 800 flux-pinned to the pole of a cylindrical permanent magnet. The Levitator 800 has come within range of the magnetic field forming Vortices 805 with the magnet; FIG. 8B also highlights the Activated Orbital's 205 circular pattern of homogenous flux. Furthermore, FIG. 8B illustrates how the Vortices 805 extend from the Activated Orbital 205 to the Activated Image 200.

FIG. 8C illustrates—from a ¾ view of the front/top of a cylindrical permanent magnet—how a Levitator, which is flux-pinned to the pole of a cylindrical permanent magnet, can move about the Activated Orbital. The magnet has an axially symmetric magnetic field; as such, the Levitator is fixed in every degree of freedom except for its rotation about magnet's axis of symmetry (i.e. magnet's dipole axis). This paradigm allows the Levitator to travel in a circular motion 815 about the Activated Orbital. Notice that as the Levitator moves from its original position 810 to its present position 800; its motions produce no torque or resistance from the Vortices and the Vortices are maintained throughout the action. According to an embodiment of the invention, Levitator is far smaller than the magnetic surface where the revolute joint is formed. And the Levitator acts as the rotor; and its movement is powered by a electromagnetic motor/generator (not illustrated herein).

FIG. 8D demonstrates—from a ¾ view of the front/top of a cylindrical permanent magnet—a type of motion which is prohibited by the Vortices in this present configuration. In particular, the Levitator breaks away from its Activated Orbital moving towards the center of the magnet's axis 820. Notice that as the Levitator moves from its original position 825 to its present position 800, its motions produce torque and resistance from the Vortices, resulting in the breaking 835 of the Vortices.

FIG. 8E demonstrates—from a ¾ view of the front/top of a cylindrical permanent magnet—a type of motion which is prohibited by the Vortices in this present configuration. In particular, the Levitator breaks away from its Activated Orbital moving away from the center of the magnet's axis 840. Notice that as the Levitator moves from its original position 825 to its present position 800; its motions produce torque and resistance from the Vortices, resulting in the breaking 835 of the Vortices.

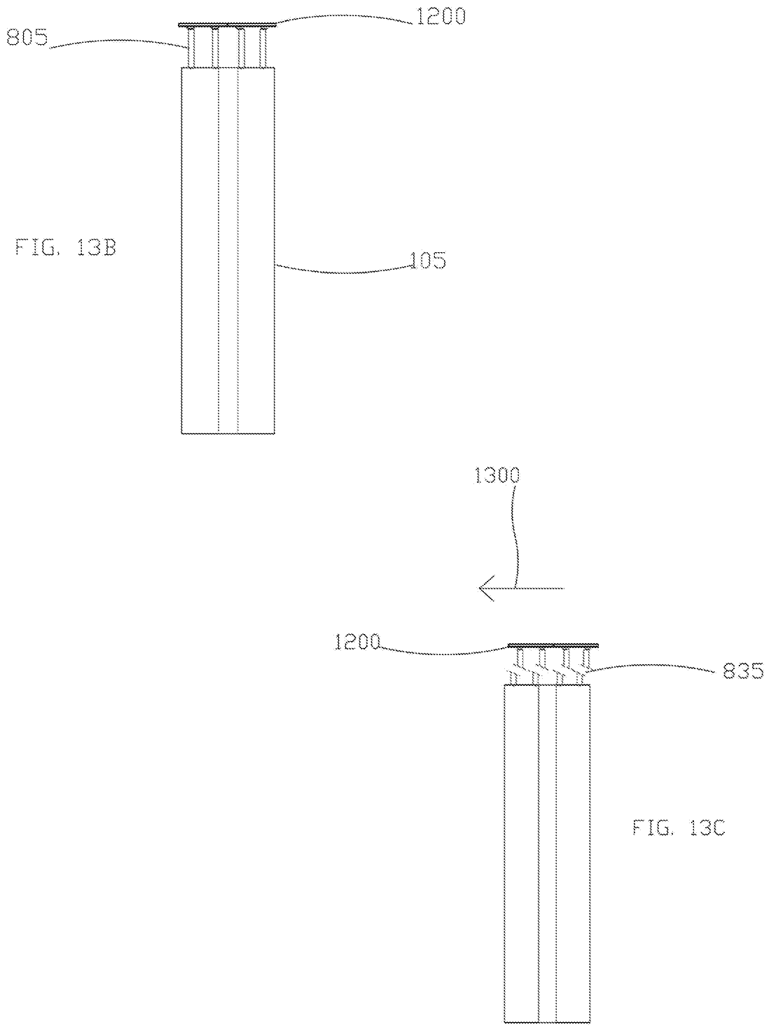

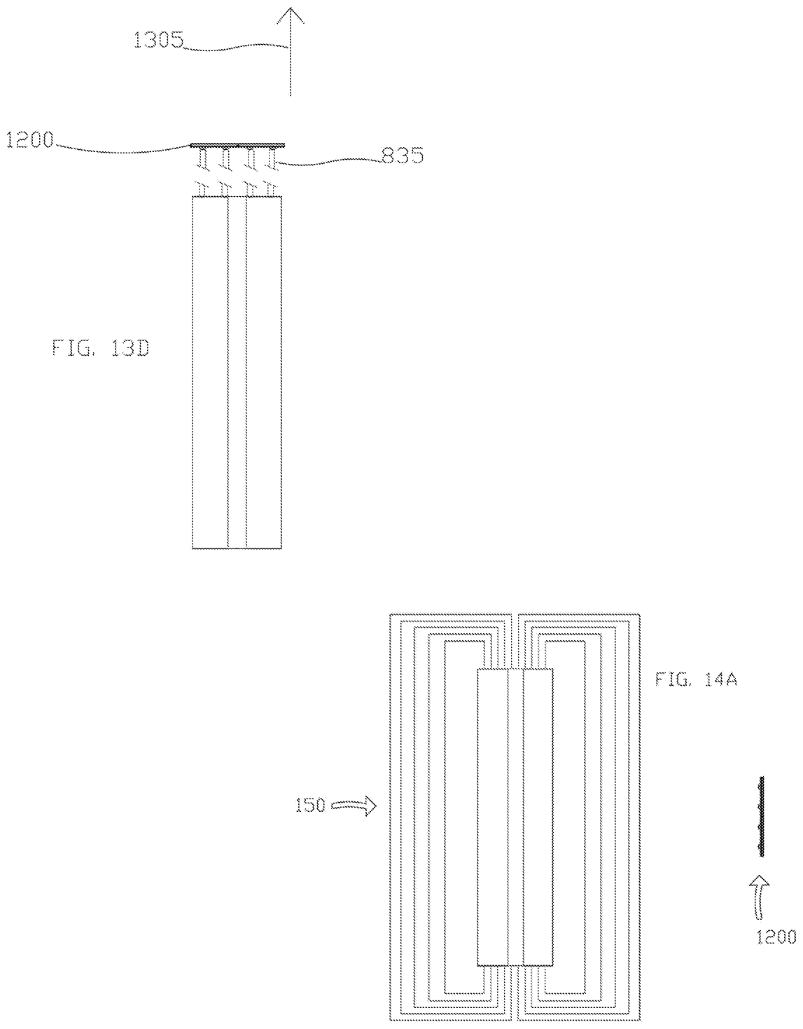

FIG. 9A illustrates—from a ¾ view of front/top of a cylindrical permanent magnet—a cylindrical permanent magnet with (a selection of) its magnetic field lines 150. Those select portion are—in particular—Orbital Pattern at the magnet's midpoint as well as the Surface Image produced at the pole of the magnet. Furthermore, FIG. 9A also illustrates a Levitator 800 within a certain proximity of the magnet. Levitator is composed of very thin layers of a High Temperature Superconductor (HTSC) capable of flux-pinning with the magnetic flux emanating from the magnet. In the present illustration, the Levitator 800 is out of range of the magnetic field and cannot flux pin with the magnet.

FIG. 9B illustrates—from a ¾ view of front/top of a cylindrical permanent magnet—a Levitator 800 flux-pinned to the midpoint of a cylindrical permanent magnet. The Levitator 800 has come within range of the magnetic field forming Vortices 805 with the magnet. FIG. 9B also highlights the Activated Orbital's 305 circular pattern of homogenous flux. Furthermore, FIG. 9B illustrates how the Vortices 805 extend from the Activated Orbital 305 to the Activated Image 900. The magnet has an axially symmetric magnetic field; this paradigm allows the Levitator to travel in a circular motion 815 about the Activated Orbital.

FIG. 9C illustrates—from a ¾ view of front/top of a cylindrical permanent magnet—how a Levitator 800, which is flux-pinned to the midpoint of a cylindrical permanent magnet, can move in circular manner 815 about an Activated Orbital. The magnet has an axially symmetric magnetic field; as such, the Levitator is fixed in every degree of freedom except for its rotation about magnet's axis of symmetry. This paradigm allows the Levitator to travel in a circular motion 815 about the Activated Orbital. Notice that as the Levitator moves from its original position 905 to its present position 800; its motions produce no torque or resistance from the Vortices and the Vortices are maintained throughout the action. According to an embodiment of the invention, Levitator is far smaller than the magnetic surface where the revolute joint is formed. The Levitator acts as the rotor; with its movement powered by a electromagnetic motor/generator (not illustrated herein).

FIG. 9D demonstrates—from a ¾ view of front/top of a cylindrical permanent magnet—a type of motion which is prohibited by the Vortices in this present configuration. In particular, the Levitator 800 breaks away from its Activated Orbital moving away from the center of the magnet's axis 840. Notice that as the Levitator 800 moves from its original position to its present position 800; its motions produce torque and resistance from the Vortices, resulting in the breaking 835 of the Vortices.

FIG. 9E demonstrates—from a ¾ view of front/top of a cylindrical permanent magnet—a type of motion which is prohibited by the Vortices in this present configuration. In particular, the Levitator 800 breaks away from its Activated Orbital moving towards the center of the magnet's axis 820. Notice that as the Levitator 800 moves from its original position to its present position 800, its motions produce torque and resistance from the Vortices, resulting in the breaking 835 of the Vortices.

From a front-view/cutaway perspective, this FIG. 10A illustrates the cylindrical permanent magnet with its magnetic field lines 150. Furthermore, FIG. 10A also illustrates a Levitator 800 within a certain proximity of the magnet. Levitator is composed of very thin layers of a High Temperature Superconductor (HTSC) capable of flux-pinning with the magnetic flux emanating from the magnet. In the present illustration, the Levitator 800 is out-of-range of the magnetic field and cannot flux pin with the magnet.

From a front-view/cutaway perspective, this FIG. 10B illustrates a Levitator 800 flux-pinned to the side of a cylindrical permanent magnet. The Levitator 800 has come within range of the magnetic field forming Vortices 805 with the magnet. FIG. 10B also highlights the Activated Field Line's 175 linear pattern of homogenous flux. Furthermore, FIG. 10B illustrates how the Vortices 805 extend from the Activated Field Line 175 to the Activated Image 1030. An cylindrical permanent magnet has a uniform magnetic field close to midpoint of its side. Hence, a Levitator can be flux-pinned to the side of such a magnet forming a cylindrical joint in which the Levitator perform linear motions along the side of the magnet for a limited range. This FIG. 10 illustrates that when the Levitator bonds to the side of the cylindrical permanent magnet certain linear motions are allowed without any torque, resistance or breaking of Vortices.

From a front-view/cutaway perspective, this FIG. 10C illustrates how a Levitator 800, which is flux-pinned to the side of a cylindrical permanent magnet, can move in linear manner 1005 along the Activated Field Line. Notice that as the Levitator moves from its original position 1000 to its present position 800; its motions produce no torque or resistance from the Vortices and the Vortices are maintained throughout the action. Finally, FIG. 10C illustrates the boundary 1010 at which the magnetic flux is no longer homogenous for the Activate Field Line.

From a front-view/cutaway perspective, this FIG. 10D demonstrates a type of motion which is prohibited by the Vortices in this present configuration. In particular, the Levitator 800 breaks away from the homogenous flux provided by the Activated Field Line as it moves 1015 beyond the boundary 1010 at which the magnetic flux is no longer homogenous for the Activate Field Line. Notice that as the Levitator 800 moves from its original position to its present position, its motions produce torque and resistance resulting in the breaking 835 of the Vortices.

From a front-view/cutaway perspective, this FIG. 10E demonstrates a type of motion which is prohibited by the Vortices in this present configuration. In particular, the Levitator 800 breaks away from its Activated Field Line moving towards the center of the magnet's axis 1025. Notice that as the Levitator 800 moves from its original position to its present position, its motions produce torque and resistance resulting in the breaking 835 of the Vortices.

From a front-view/cutaway perspective, this FIG. 10F demonstrates a type of motion which is prohibited by the Vortices in this present configuration. In particular, the Levitator 800 breaks away from its Activated Field Line moving away from the center of the magnet's axis 1030. Notice that as the Levitator 800 moves from its original position to its present position, its motions produce torque and resistance resulting in the breaking 835 of the Vortices.

From a front-view/cutaway perspective, FIG. 11A illustrates a cylindrical permanent magnet with select portions of its magnetic field lines 150. Furthermore, FIG. 11A also illustrates a Levitator 800 within a certain proximity of the magnet. Levitator is composed of very thin layers of a High Temperature Superconductor (HTSC) capable of flux-pinning with the magnetic flux emanating from the magnet. In the present illustration, the Levitator 800 is out-of-range of the magnetic field and cannot flux pin with the magnet.

From a front-view/cutaway perspective, FIG. 11B illustrates a Levitator 800 flux-pinned to the pole of a cylindrical permanent magnet. The Levitator 800 has come within range of the magnetic field forming Vortices 805 with the magnet.

From a front-view/cutaway perspective, FIG. 11C demonstrates a type of motion which is prohibited by the Vortices in this present configuration. In particular, the Levitator breaks away from its Activated Orbital moving away from 1100 the surface of the magnetic pole. Notice that as the Levitator moves from its original position to its present position 800, its motions produce torque and resistance from the Vortices, resulting in the breaking 835 of the Vortices.

From a front-view/cutaway perspective, FIG. 11D demonstrates a type of motion which is prohibited by the Vortices in this present configuration. In particular, the Levitator breaks away from its Activated Orbital moving toward 1105 the surface of the magnetic pole. Notice that as the Levitator moves from its original position to its present position 800, its motions produce torque and resistance from the Vortices, resulting in the breaking 835 of the Vortices.

From a ¾ view of the front/top of a cylindrical permanent magnet, FIG. 12A illustrates a cylindrical permanent magnet with select portions of its magnetic field lines 250, those select portion are—in particular—Orbital Pattern 135 as well as the Surface Image 140 produced at the pole of the magnet. Furthermore, FIG. 12A also illustrates a Levitator 1200 within a certain proximity of the magnet. Levitator is composed of very thin layers of a High Temperature Superconductor (HTSC) capable of flux-pinning with the magnetic flux emanating from the magnet. In the present illustration, the Levitator 1200 is out of range of the magnetic field and cannot flux pin with the magnet.

From a ¾ view of the front/top of a cylindrical permanent magnet, FIG. 12B illustrates a Levitator 1200 flux-pinned to the pole of a cylindrical permanent magnet 250. The Levitator 1200 has come within range of the magnetic field forming Vortices 805 with the magnet.

From a ¾ view of the front/top of a cylindrical permanent magnet, FIG. 12C illustrates how a Levitator, which is flux-pinned to the pole of a cylindrical permanent magnet, can move about the Activated Orbital. The magnet has an axially symmetric magnetic field; as such, the Levitator is fixed in every degree of freedom except for its rotation about magnet's axis of symmetry (i.e. magnet's dipole axis). This paradigm allows the Levitator to travel in a circular motion 1205 about the Activated Orbital. Notice that as the Levitator moves from its original position to its present position; its motions produce no torque or resistance from the Vortices and the Vortices are maintained throughout the action. According to an embodiment of the invention, the rotor may be either the Levitator or the permanent cylindrical magnet, and its movement is powered by a electromagnetic motor/generator (not illustrated herein). And the Levitator is large enough to nearly cover the magnetic surface where the revolute joint is formed.

From a ¾ view of the front/top of a cylindrical permanent magnet, FIG. 12D demonstrates a type of motion which is prohibited by the Vortices in this present configuration. In particular, the Levitator breaks away from its Activated Orbital moving away from the center of the magnet's axis 1210. Notice that as the Levitator moves from its original position to its present position, its motions produce torque and resistance from the Vortices, resulting in the breaking 835 of the Vortices. Notice that all of the Vortices are broken simultaneously by this prohibited motion.

From a front-view/cutaway perspective, FIG. 13A illustrates a cylindrical permanent magnet with select portions of its magnetic field lines 150. Furthermore, FIG. 13A also illustrates a Levitator 1200 within a certain proximity of the magnet. Levitator is composed of very thin layers of a High Temperature Superconductor (HTSC) capable of flux-pinning with the magnetic flux emanating from the magnet. In the present illustration, the Levitator 1200 is out-of-range of the magnetic field and cannot flux pin with the magnet's orbital pattern 255.

From a front-view/cutaway perspective, FIG. 13B illustrates a Levitator 1200 flux-pinned to the pole of a cylindrical permanent magnet 100. The Levitator 1200 has come within range of the magnetic field forming Vortices 805 with the magnet.

From a front-view/cutaway perspective, FIG. 13C demonstrates a type of motion which is prohibited by the Vortices in this present configuration. In particular, the Levitator 1200 breaks away from its Activated Orbital moving away from the axis 1300 of the magnetic pole. Notice that as the Levitator moves from its original position to its present position, its motions produce torque and resistance from the Vortices, resulting in the breaking 835 of the Vortices. Notice that all of the Vortices are broken simultaneously by this prohibited motion.

From a front-view/cutaway perspective, FIG. 13D demonstrates a type of motion which is prohibited by the Vortices in this present configuration. In particular, the Levitator 1200 breaks away from its Activated Orbital moving away from the surface 1305 of the magnetic pole. Notice that as the Levitator moves from its original position to its present position, its motions produce torque and resistance from the Vortices, resulting in the breaking 835 of the Vortices. Notice that all of the Vortices are broken simultaneously by this prohibited motion.

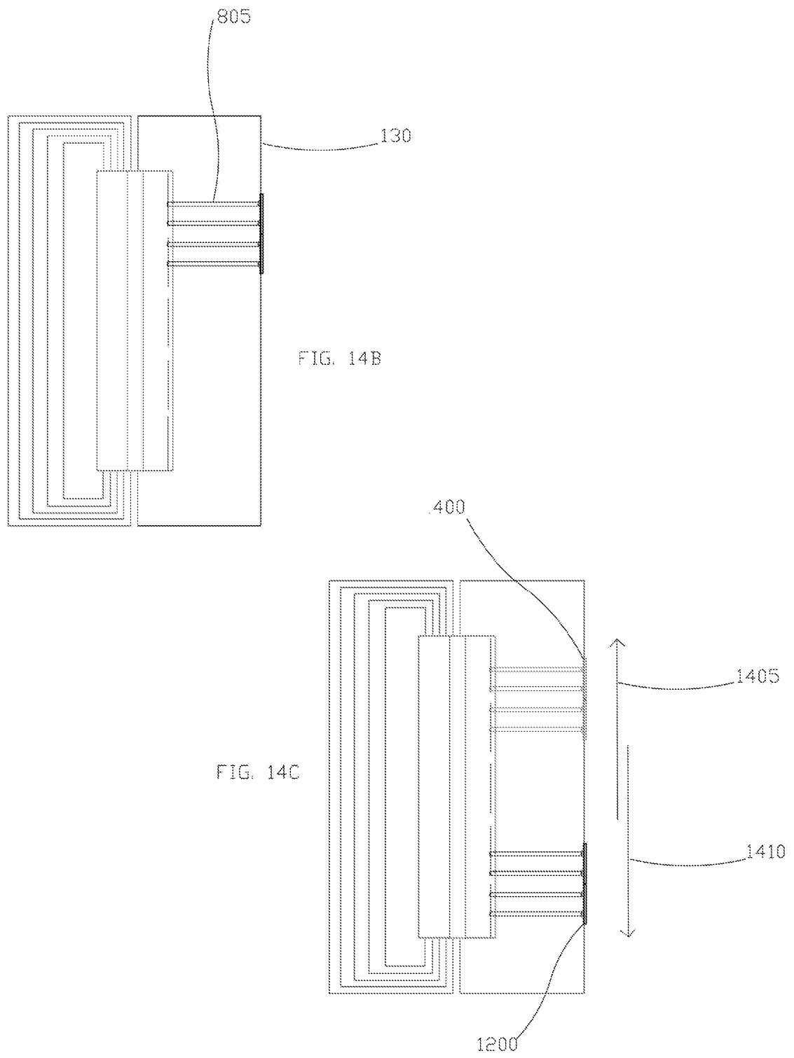

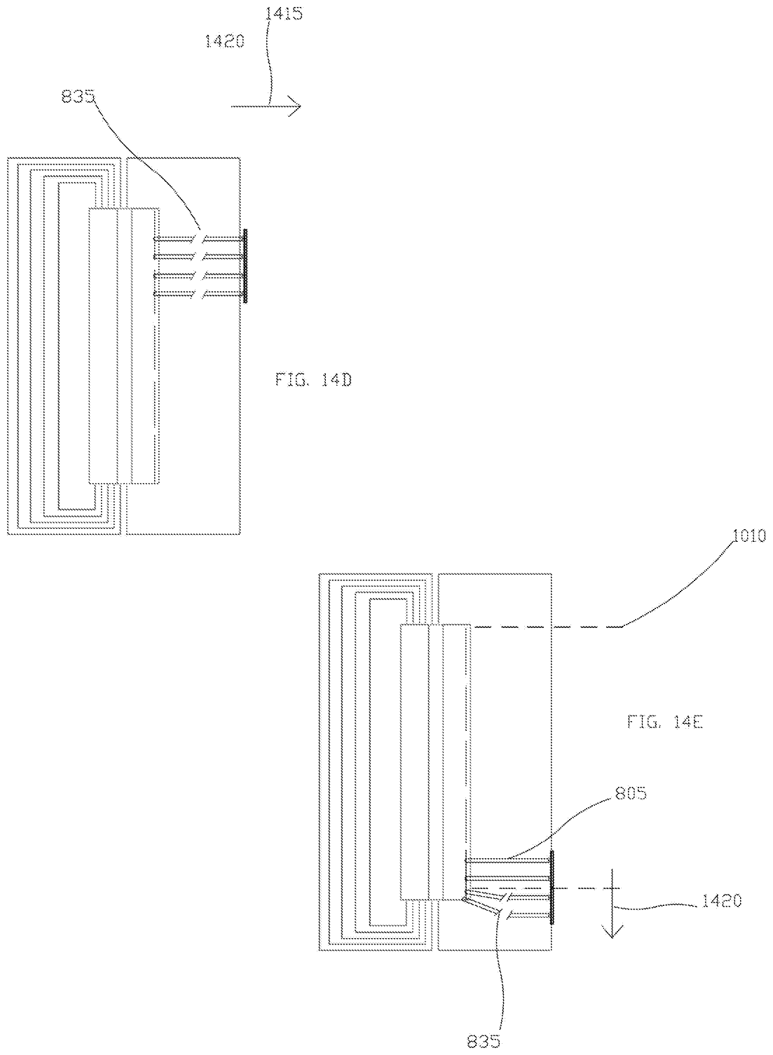

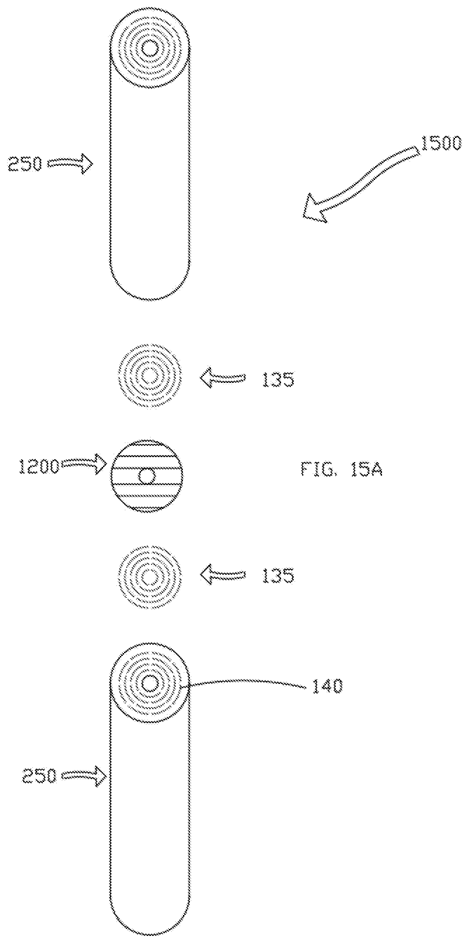

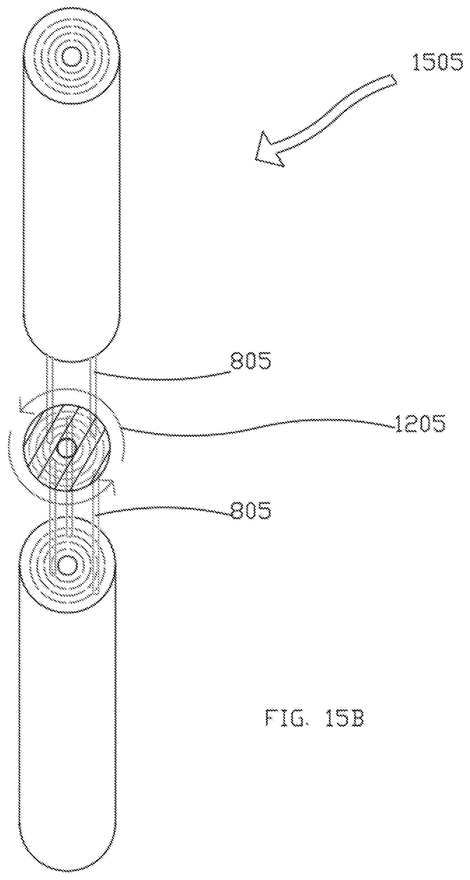

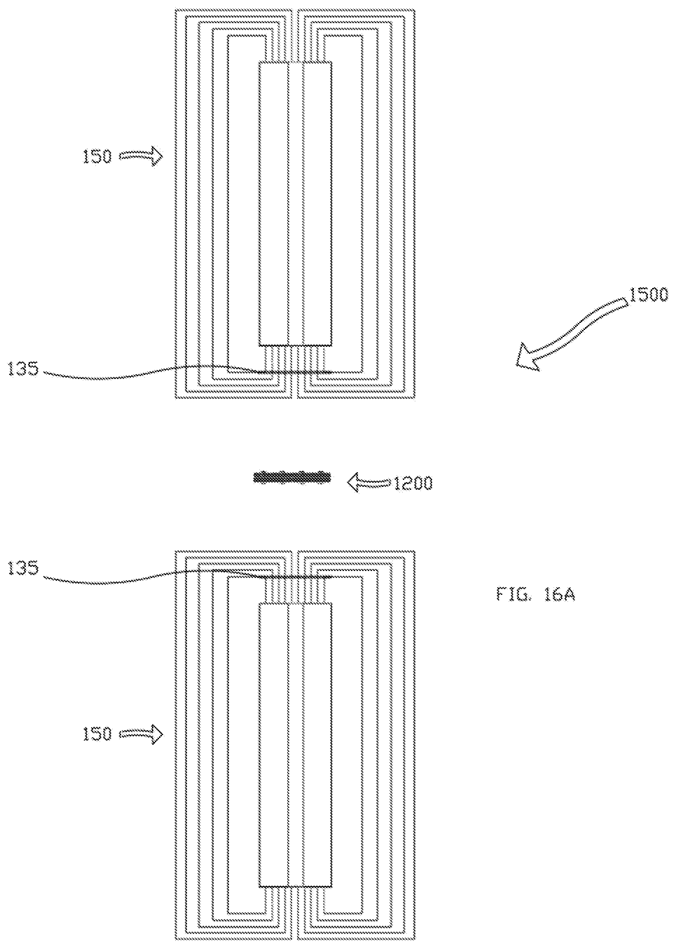

From a front-view/cutaway perspective, FIG. 14A illustrates the cylindrical permanent magnet with its magnetic field lines 150. Furthermore, FIG. 14A also illustrates a Levitator 1200 within a certain proximity of the magnet. Levitator is composed of very thin layers of a High Temperature Superconductor (HTSC) capable of flux-pinning with the magnetic flux emanating from the magnet. In the present illustration, the Levitator 1200 is out-of-range of the magnetic field and cannot flux pin with the magnet.

From a front-view/cutaway perspective, FIG. 14B illustrates a Levitator flux-pinned to the side of a cylindrical permanent magnet. The Levitator has come within range of the magnetic field forming Vortices 805 with the magnet. FIG. 14B also highlights the outermost field line 130. FIG. 14B also illustrates the Activated Field Line's linear pattern of homogenous flux. Furthermore, FIG. 14B illustrates how the Vortices 805 extend from the Activated Field Line to the Activated Image. This FIG. 14B illustrates that when the Levitator bonds to the side of the cylindrical permanent magnet certain linear motions are allowed without any torque, resistance or breaking of Vortices.

From a front-view/cutaway perspective, FIG. 14C illustrates how a Levitator 1200, which is flux-pinned to the side of a cylindrical permanent magnet, can move in linear manner (up 1405 or down 1410) along the Activated Field Line. Notice that as the Levitator moves from its original position 1400 to its present position 1200; its motions produce no torque or resistance from the Vortices and the Vortices are maintained throughout the action. furthermore, it demonstrates how the Levitator can travel in a linear motion along the homogenous flux of an Activated Field Line at the magnet's side.

From a front-view/cutaway perspective, FIG. 14D demonstrates a type of motion which is prohibited by the Vortices in this present configuration. In particular, the Levitator breaks away from its Activated Field Line moving away from the center of the magnet's axis 1415. Notice that as the Levitator moves from its original position to its present position, its motions produce torque and resistance resulting in the breaking 835 of the Vortices. Notice that all of the Vortices are broken simultaneously by this prohibited motion.

From a front-view/cutaway perspective, FIG. 14E demonstrates a type of motion which is prohibited by the Vortices in this present configuration. In particular, the Levitator breaks away from the homogenous flux provided by the Activated Field Line as it moves beyond 1420 the boundary 1010 at which the magnetic flux is no longer homogenous for the Activate Field Line. Notice that as the Levitator moves from its original position to its present position, its motions produce torque and resistance resulting in the breaking 835 of the Vortices. Notice that the only Vortices that are broken are those that crossed 1015 the boundary of homogenous flux 1010. And each Vortices is broken as it actually crosses this boundary. The Vortices that have not crossed this boundary remain intact 805.

From a ¾ view of the front/top, FIG. 15A illustrates a Levitator between two cylindrical permanent magnets 1500. The cylindrical permanent magnets 250 are illustrated with select portions of their magnetic field lines, those select portion are—in particular—Orbital Patterns 135 as well as the Surface Images 140 produced at the pole of the magnet. Furthermore, FIG. 15A also illustrates a Levitator 1200 within a certain proximity of the magnet; the Levitator 1200 is out-of-range of the magnetic fields and cannot flux pin with the magnets. Levitator is composed of very thin layers of a High Temperature Superconductor (HTSC) capable of flux-pinning with the magnetic flux emanating from the magnet.

From a ¾ view of the front/top, FIG. 15B illustrates a Levitator flux-pinned to the poles of two cylindrical permanent magnets simultaneously 1505. The Levitator 1200 has come within range of the magnetic field forming Vortices 805 with the magnets. To achieve this, both magnets were moved closer to the Levitator bringing it within range of their respective Orbital Patterns. FIG. 15B also illustrates how a Levitator, which is flux-pinned to the poles of two cylindrical permanent magnets, can move about the Activated Orbitals. The magnets have axially symmetric magnetic fields; as such, the Levitator is fixed in every degree of freedom except for its rotation about magnets' axis of symmetry (i.e. magnet's dipole axis). This paradigm allows the Levitator to travel in a circular motion 1205 about the Activated Orbitals. Notice that as the Levitator moves from its original position to its present position; its motions produce no torque or resistance from the Vortices and the Vortices are maintained throughout the action. According to an embodiment of the invention, the rotor's (in this case the Levitator's) movement is powered by a electromagnetic motor/generator (not illustrated herein). When compared to FIG. 12, this FIG. 15 provides for an increased number of Vortices.

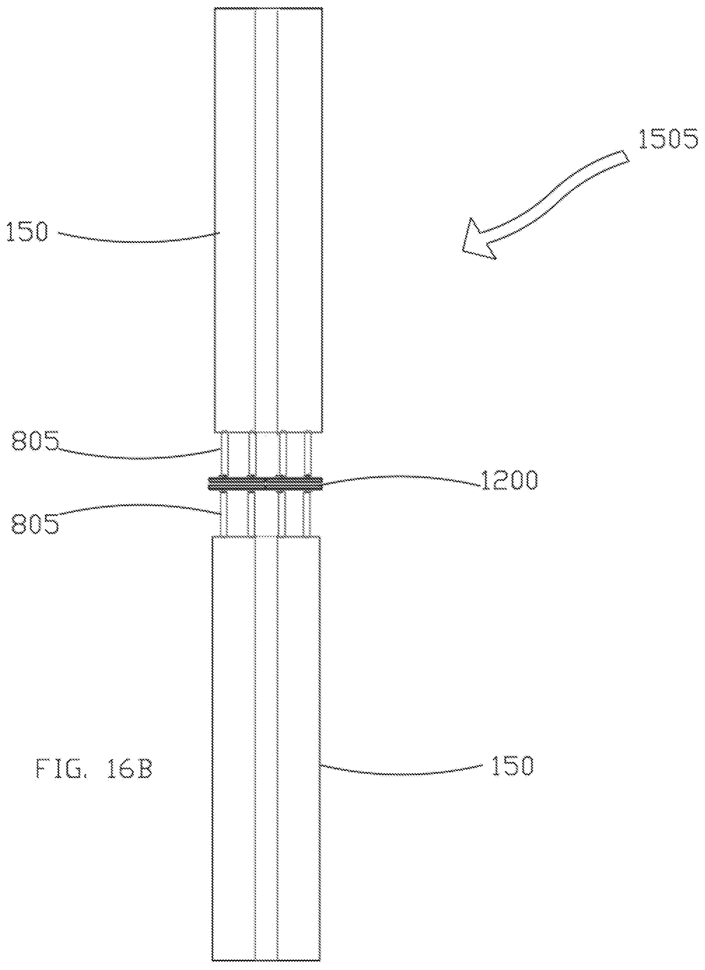

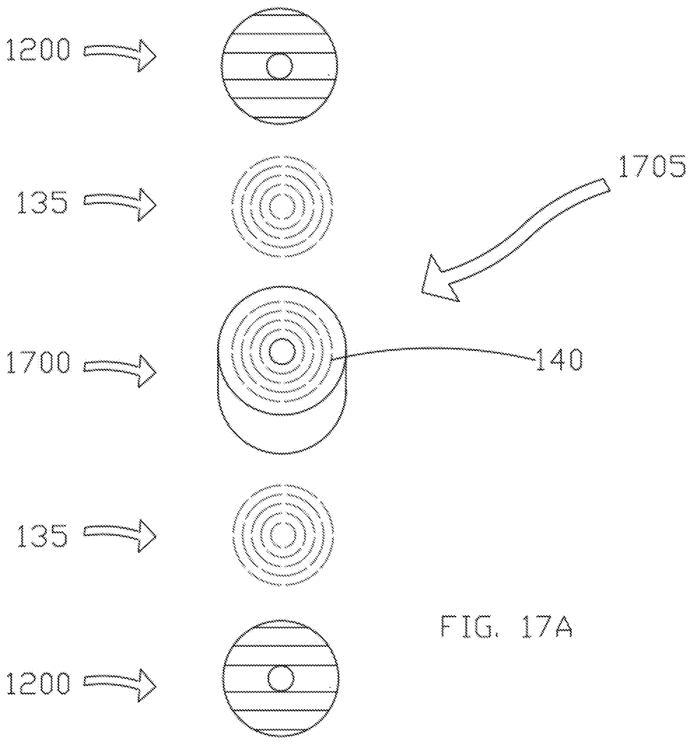

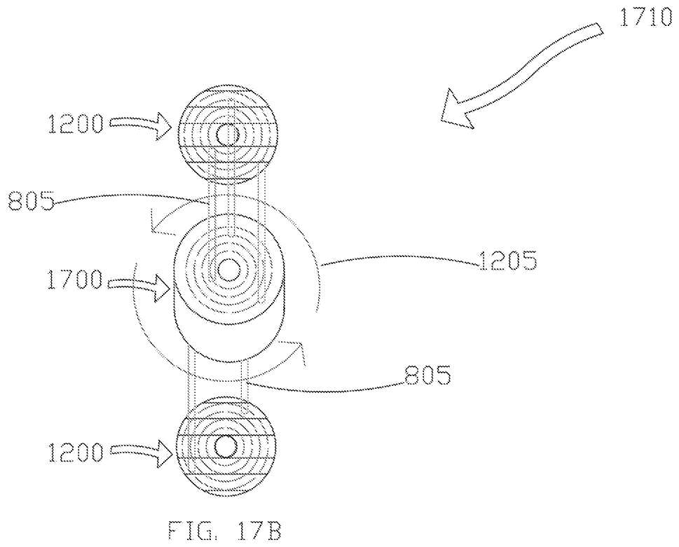

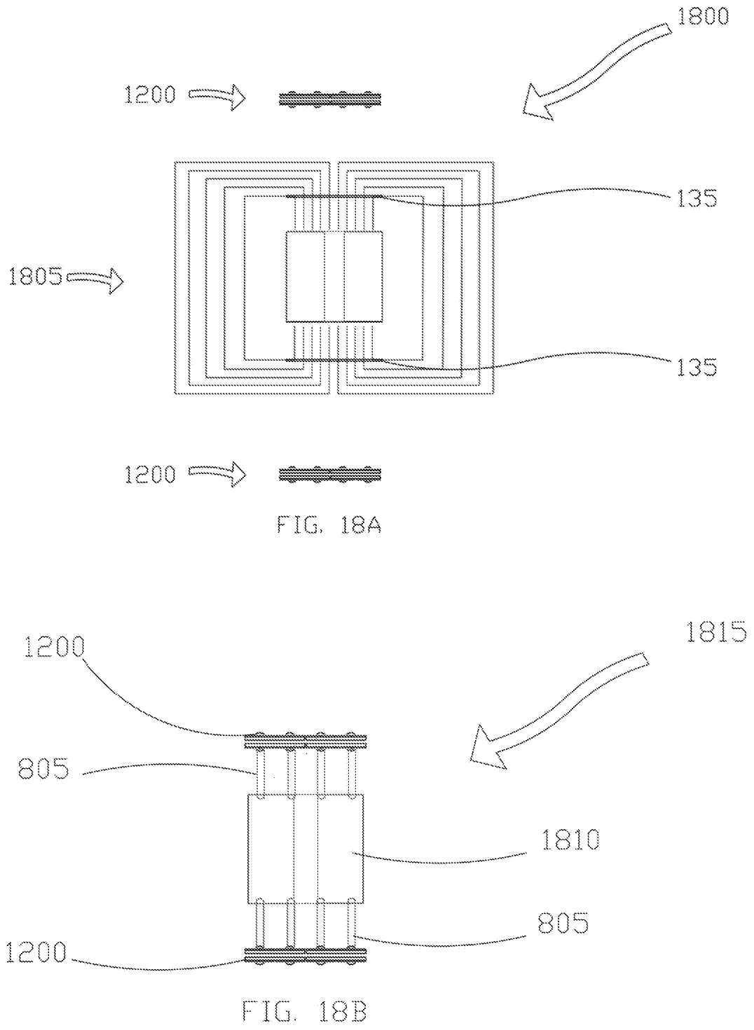

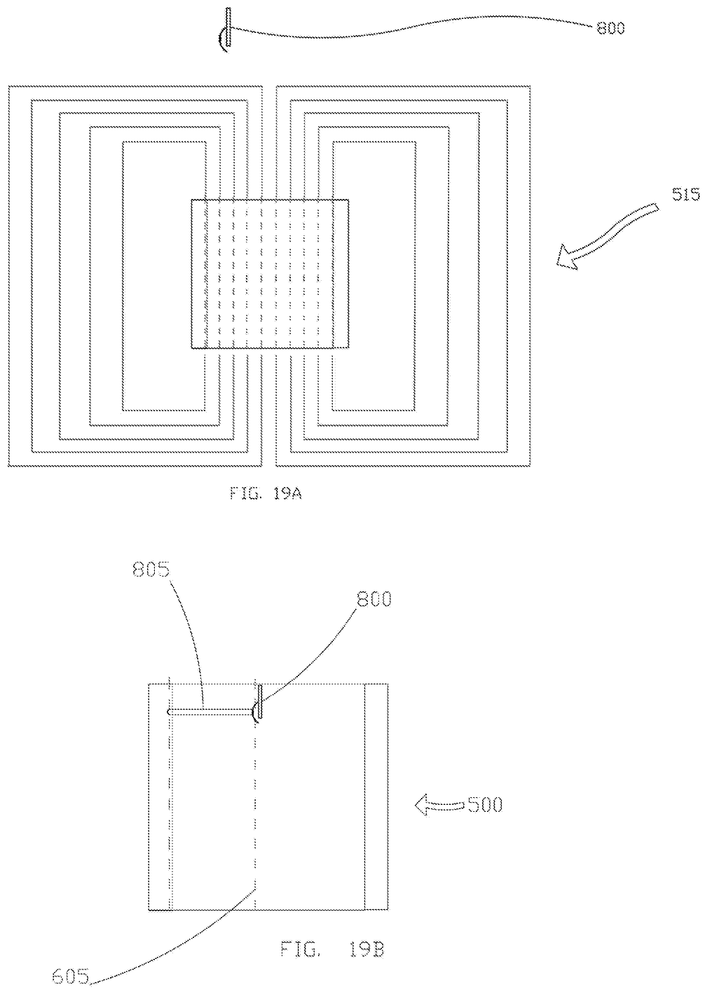

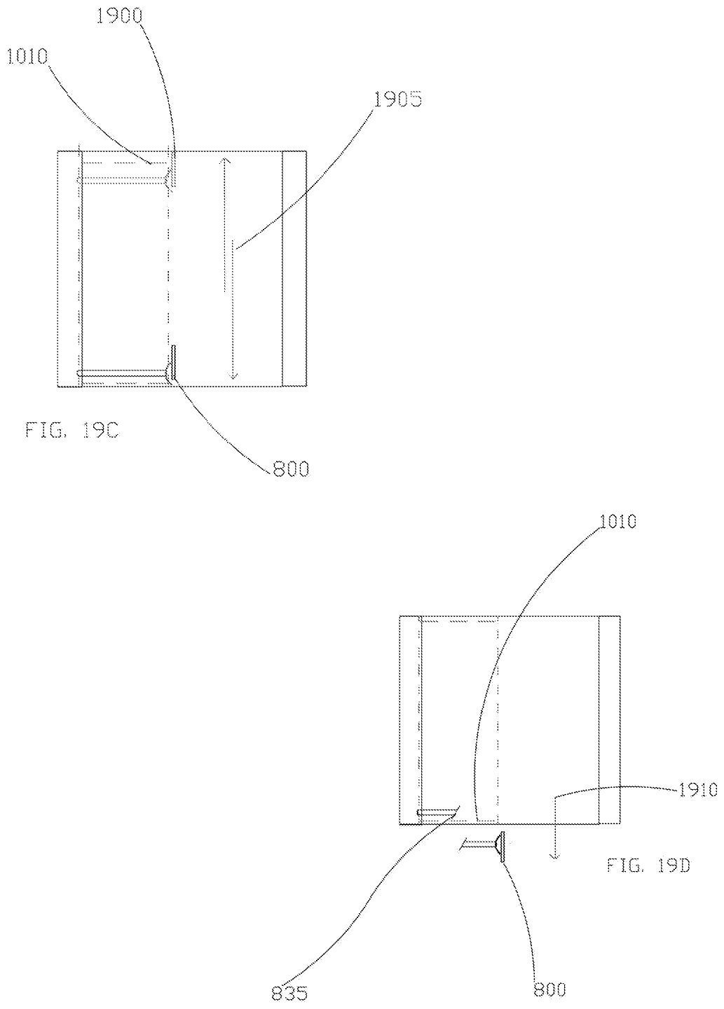

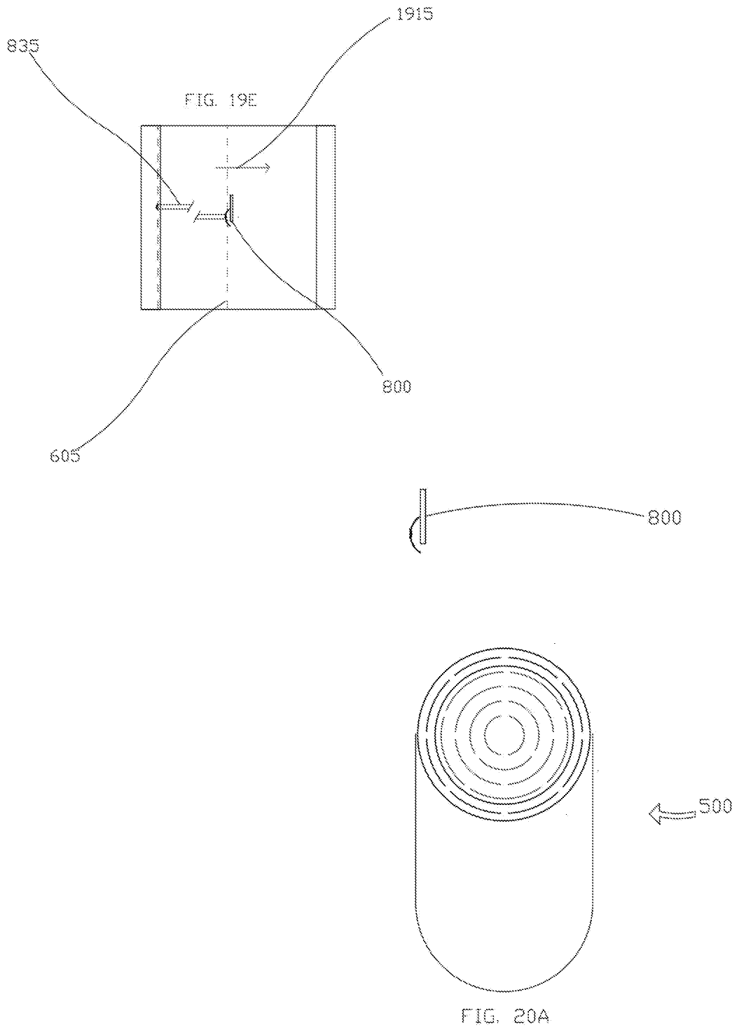

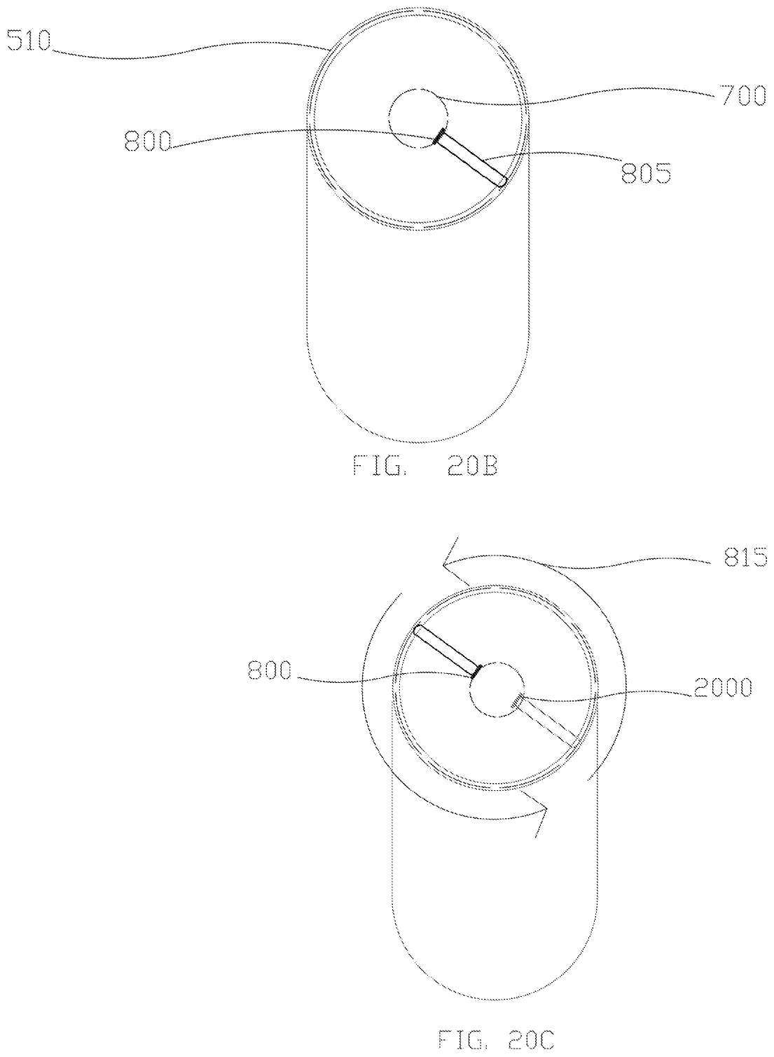

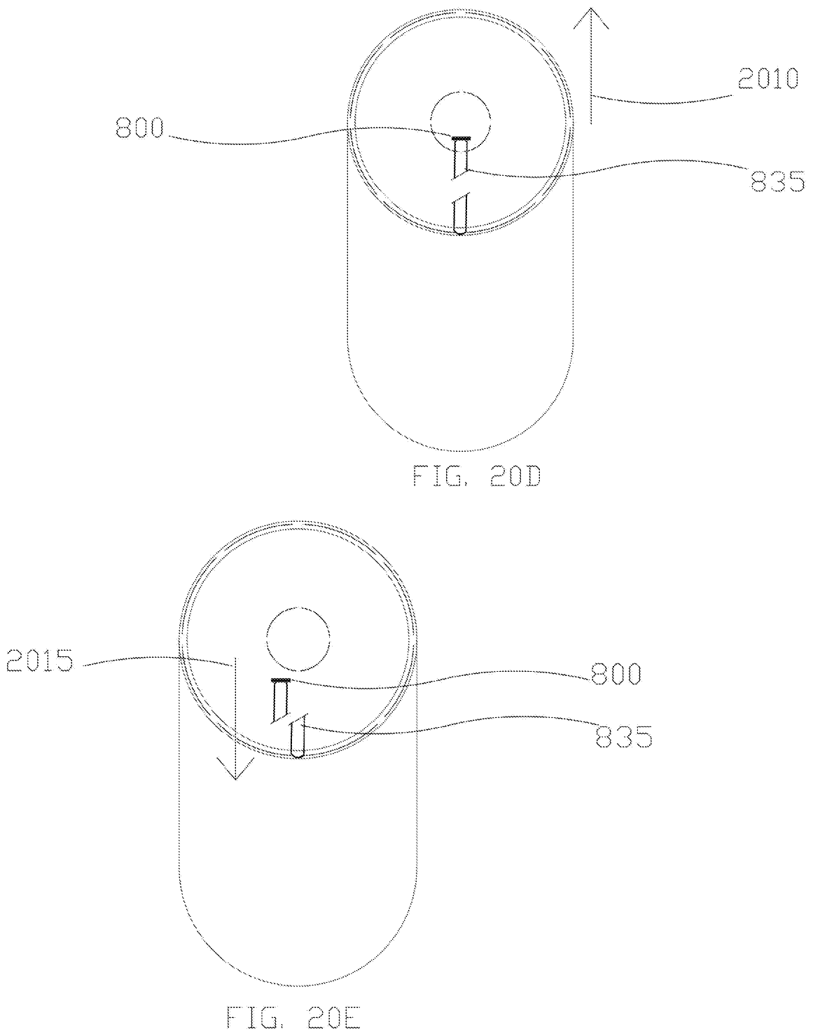

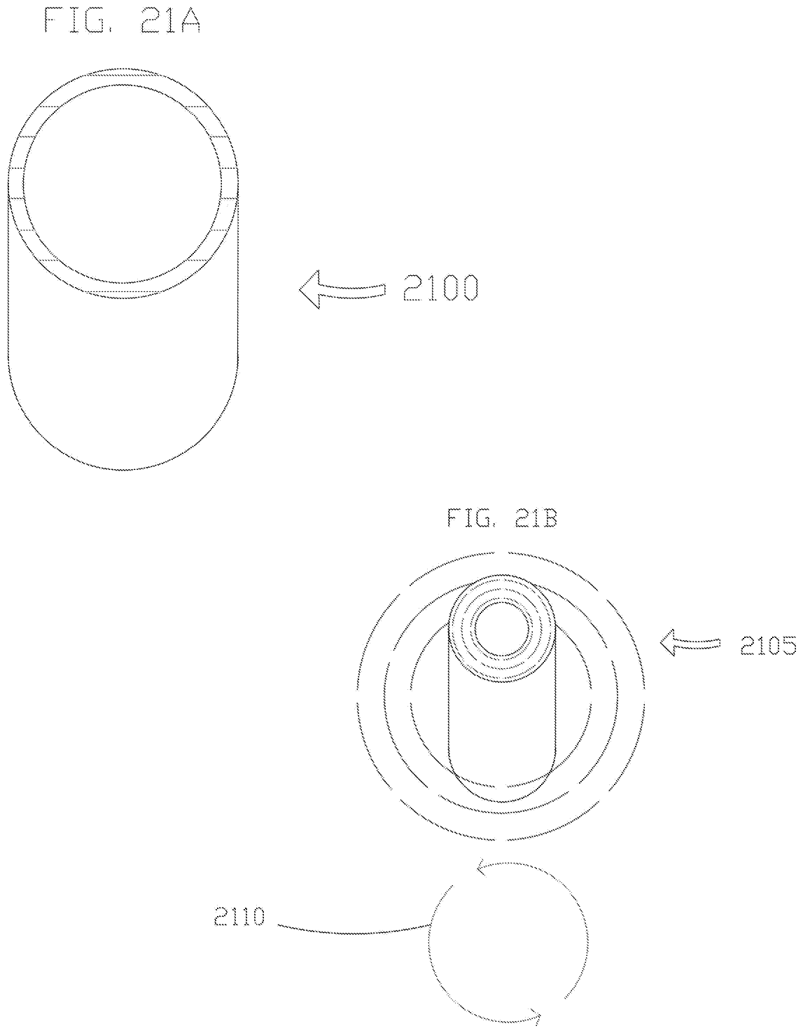

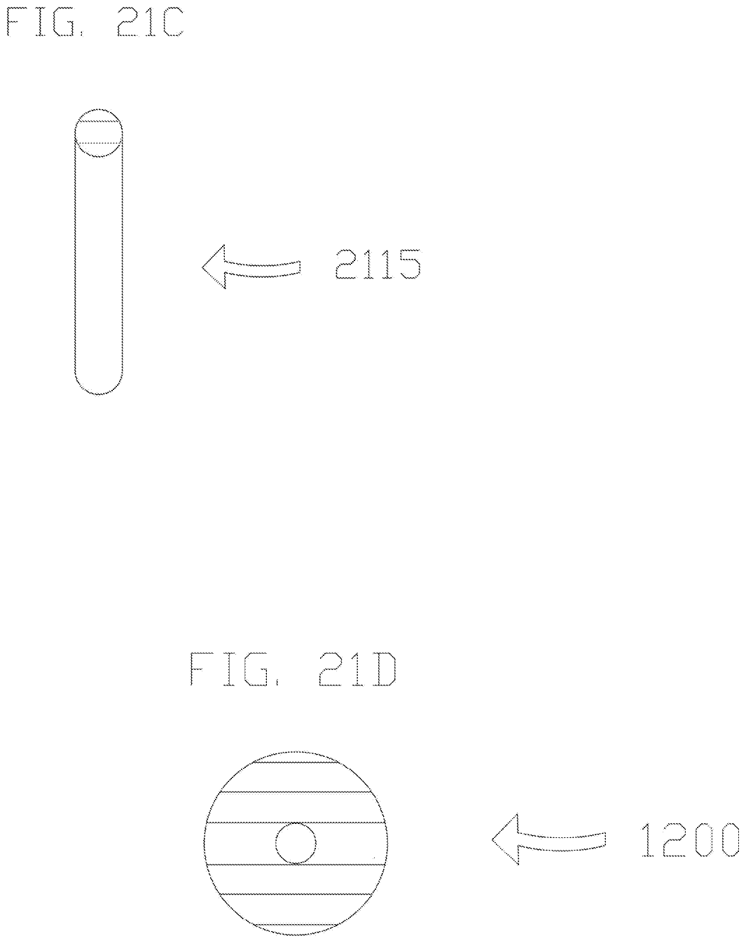

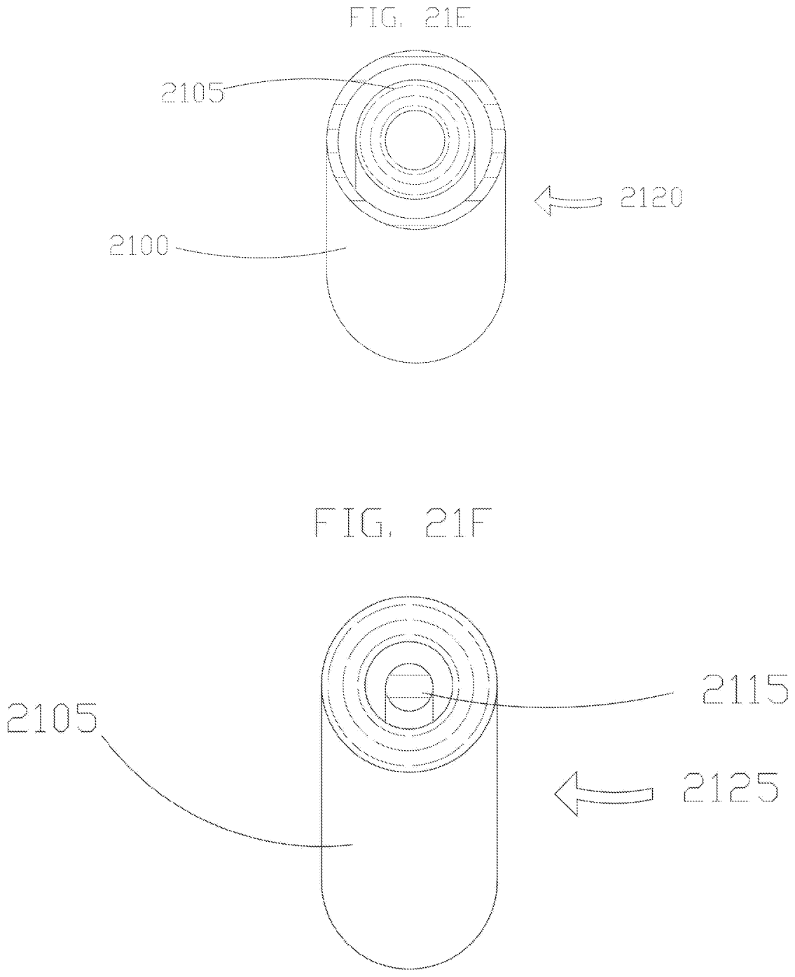

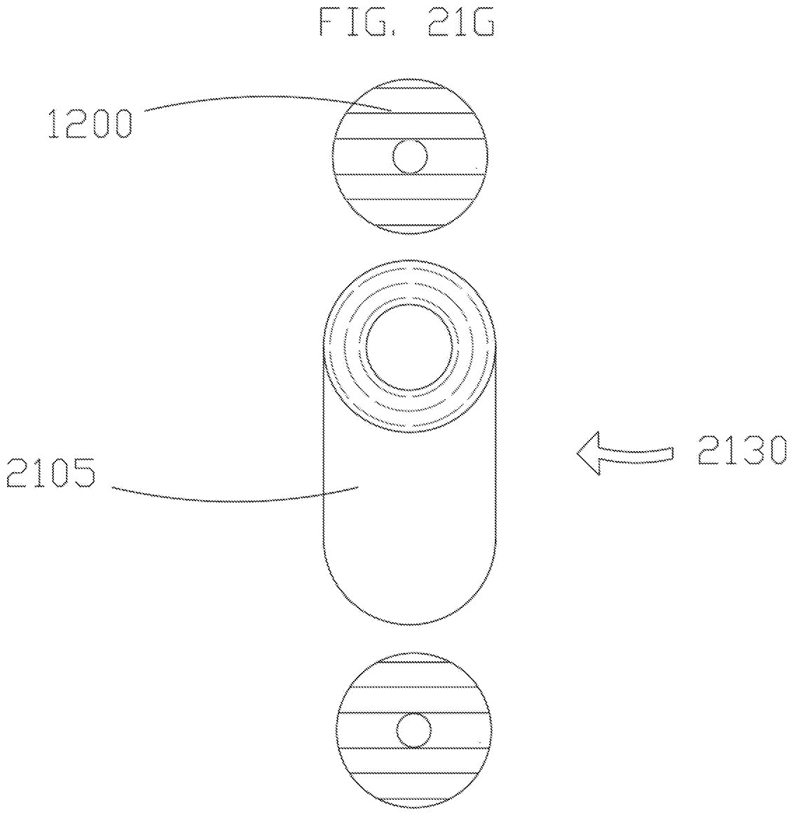

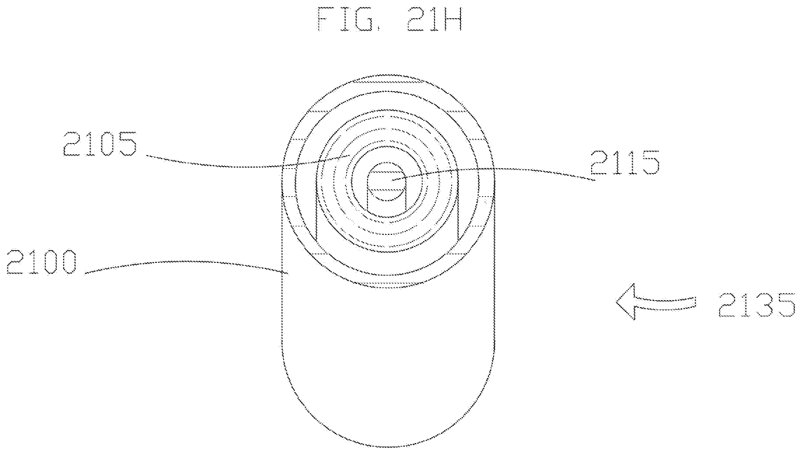

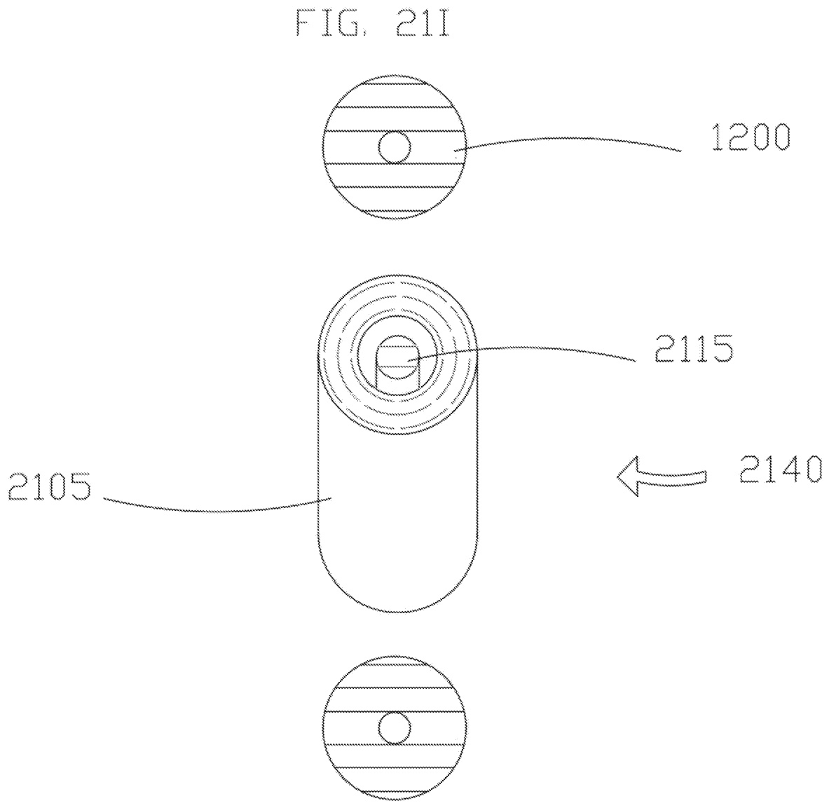

From a front-view/cutaway perspective, FIG. 16A illustrates a Levitator between two cylindrical permanent magnets 1500. The cylindrical permanent magnets 150 are illustrated with select portions of their magnetic field lines, those select portion are—in particular—Orbital Patterns 135 as well as the Surface Images produced at the pole of the magnet. Furthermore, FIG. 16A also illustrates a Levitator 1200 within a certain proximity of the magnet; the Levitator 1200 is out-of-range of the magnetic fields and cannot flux pin with the magnets. Levitator is composed of very thin layers of a High Temperature Superconductor (HTSC) capable of flux-pinning with the magnetic flux emanating from the magnet.

From a front-view/cutaway perspective, FIG. 16B illustrates a Levitator flux-pinned to the poles of two cylindrical permanent magnets simultaneously 1505. The Levitator 1200 has come within range of the magnetic field forming Vortices 805 with the magnets. To achieve this, both magnets were moved closer to the Levitator bringing it within range of their respective Orbital Patterns. When compared to FIG. 1I, this FIG. 16 provides for an increased number of Vortices. furthermore, it demonstrates how the Levitator can travel in a circular path along the pattern of homogenous flux of conjoined Orbital Pattern at each magnet's pole. Notice that the Levitator in this example is large enough to enclose almost the entirety of the magnet's Orbital Pattern

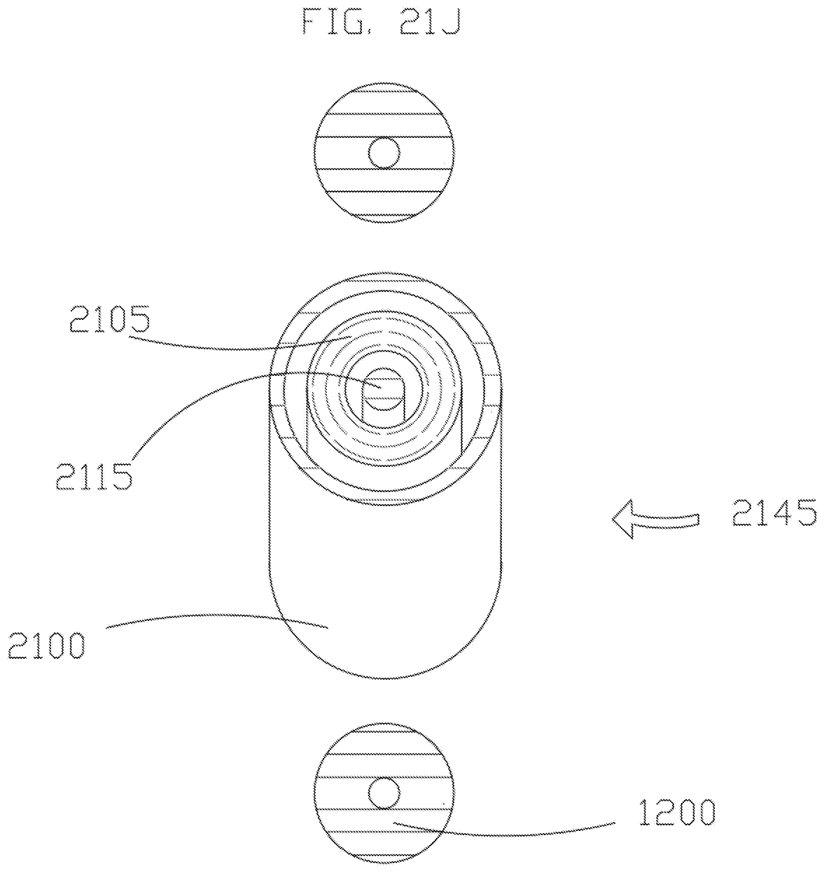

From a ¾ View of the front/top, FIG. 17A illustrates two Levitators sandwiching a cylindrical permanent magnets 1705. The cylindrical permanent magnet 1700 is illustrated with select portions of its magnetic field lines, those select portion are—in particular—Orbital Patterns 135 as well as the Surface Images 140 produced at the pole of the magnet. Furthermore, FIG. 17A also illustrates two Levitator 1200 within a certain proximity of the magnet; the Levitators 1200 is out-of-range of the magnetic fields and cannot flux pin with the magnet. The Levitators are composed of very thin layers of a High Temperature Superconductor (HTSC) capable of flux-pinning with the magnetic flux emanating from the magnet.

From a ¾ View of the front/top, FIG. 17B illustrates two Levitators flux-pinned to the poles of a cylindrical permanent magnet simultaneously 1710. The Levitators 1200 have come within range of the magnetic field forming Vortices 805 with the magnet. To achieve this, both Levitators were moved closer to the magnet bringing them within range of the respective Orbital Patterns. FIG. 17B also illustrates how the magnet, with Levitators flux-pinned to its poles, can move about the Activated Orbitals. The magnet has an axially symmetric magnetic field; as such, the magnet is fixed in every degree of freedom except for its rotation about its axis of symmetry (i.e. magnet's dipole axis). This paradigm allows the magnet 1700 to travel in a circular motion 1205 about the Activated Orbitals. Notice that as the magnet 1700 moves from its original position to its present position; its motions produce no torque or resistance from the Vortices and the Vortices are maintained throughout the action. furthermore, it demonstrates how the magnet can travel on a circular path along the pattern of homogenous flux of conjoined Orbital Pattern at each magnet's pole. Notice that the Levitators 1200 in this example are large enough to enclose almost the entirety of the magnet's Orbital Patterns. When compared to FIG. 15, this FIG. 17 illustrates the magnet as the spinning element. According to an embodiment of the invention, the rotor's movement is powered by a electromagnetic motor/generator (not illustrated herein).

From a front-view/cutaway perspective, FIG. 18A illustrates two Levitators sandwiching a cylindrical permanent magnet 1800. The cylindrical permanent magnet is illustrated with select portions of its magnetic field lines, those select portion are—in particular—Orbital Patterns 135 as well as the Surface Images produced at the pole of the magnet. Furthermore, FIG. 18A also illustrates two Levitator 1200 within a certain proximity of the magnet 1805; the Levitators 1200 is out-of-range of the magnetic fields and cannot flux pin with the magnet. The Levitators are composed of very thin layers of a High Temperature Superconductor (HTSC) capable of flux-pinning with the magnetic flux emanating from the magnet.

From a front-view/cutaway perspective, FIG. 18B illustrates two Levitators flux-pinned to the poles of a cylindrical permanent magnet simultaneously 1815. The Levitators 1200 have come within range of the magnetic field forming Vortices 805 with the magnet. To achieve this, both Levitators were moved closer to the magnet 1810 bringing them within range of the respective Orbital Patterns. FIG. 18B also illustrates how the magnet 1810, with Levitators flux-pinned to its poles, can move about the Activated Orbitals. The magnet 1810 has an axially symmetric magnetic field; as such, the magnet 1810 is fixed in every degree of freedom except for its rotation about its axis of symmetry (i.e. magnet's dipole axis). This paradigm allows the magnet 1810 to travel in a circular motion about the Activated Orbitals. Notice that as the magnet 1810 moves from its original position to its present position; its motions produce no torque or resistance from the Vortices and the Vortices are maintained throughout the action. furthermore, it demonstrates how the magnet can travel on a circular path along the pattern of homogenous flux of conjoined Orbital Pattern at each magnet's pole. Notice that the Levitators in this example are large enough to enclose almost the entirety of the magnet's Orbital Patterns. When compared to FIG. 16, this FIG. 18 illustrates the magnet as the spinning element.

From a front-view/cutaway perspective, FIG. 19A illustrates the cylindrical permanent magnet with its magnetic field lines 515. Furthermore, FIG. 19A also illustrates a Levitator 800 within a certain proximity of the magnet. Levitator is composed of very thin layers of a High Temperature Superconductor (HTSC) capable of flux-pinning with the magnetic flux emanating from the magnet. In the present illustration, the Levitator 800 is out-of-range of the magnetic field and cannot flux pin with the magnet.

From a front-view/cutaway perspective, FIG. 19B illustrates a Levitator 800 flux-pinned to the inner side of the cavity of a cylindrical permanent magnet 500. The Levitator 800 has come within range of the magnetic field forming Vortices 805 with the magnet. FIG. 19B also highlights the Activated Field Line's 605 linear pattern of homogenous flux. Furthermore, FIG. 19B illustrates how the Vortices 805 extend from the Activated Field Line 605 to the Activated Image.

From a front-view/cutaway perspective, FIG. 19C illustrates how a Levitator 800, which is flux-pinned to the inner side of the cavity of a cylindrical permanent magnet, can move in linear manner 1905 along the Activated Field Line. Notice that as the Levitator moves from its original position 1900 to its present position 800; its motions produce no torque or resistance from the Vortices and the Vortices are maintained throughout the action. Finally, FIG. 19C illustrates the boundary 1010 at which the magnetic flux is no longer homogenous for the Activate Field Line.

From a front-view/cutaway perspective, FIG. 19D demonstrates a type of motion which is prohibited by the Vortices in this present configuration. In particular, the Levitator 800 breaks away from the homogenous flux provided by the Activated Field Line as it move beyond 1910 the boundary 1010 at which the magnetic flux is no longer homogenous for the Activate Field Line. Notice that as the Levitator 800 moves from its original position to its present position, its motions produce torque and resistance resulting in the breaking 835 of the Vortices.

From a front-view/cutaway perspective, FIG. 19E demonstrates a type of motion which is prohibited by the Vortices in this present configuration. In particular, the Levitator 800 breaks away from its Activated Field Line 605 moving towards the center of the magnet's axis 1915. Notice that as the Levitator 800 moves from its original position to its present position, its motions produce torque and resistance resulting in the breaking 835 of the Vortices.

From a ¾ View of Front/Top, FIG. 20A illustrates a cylindrical permanent magnet with (a selection of) its magnetic field lines 500, those select portion are—in particular—Orbital Pattern at the magnet's midpoint within its hollow cavity as well as the Surface Image produced at the pole of the magnet. Furthermore, FIG. 20A also illustrates a Levitator 800 within a certain proximity of the magnet. Levitator is composed of very thin layers of a High Temperature Superconductor (HTSC) capable of flux-pinning with the magnetic flux emanating from the magnet. In the present illustration, the Levitator 800 is out-of-range of the magnetic field and cannot flux pin with the magnet.

From a ¾ View of Front/Top, FIG. 20B illustrates a Levitator 800 flux-pinned to the midpoint of a cylindrical permanent magnet. The Levitator 800 has come within range of the magnetic field forming Vortices 805 with the magnet. FIG. 20B also highlights the Activated Orbital's 700 circular pattern of homogenous flux. Furthermore, FIG. 20B illustrates how the Vortices 805 extend from the Activated Orbital to the Activated Image. The magnet has an axially symmetric magnetic field; as such, this paradigm allows the Levitator to travel in a circular motion about the Activated Orbital 700.

From a ¾ View of Front/Top, FIG. 20C illustrates how a Levitator 800, which is flux-pinned to the midpoint within the hollow cavity of a cylindrical permanent magnet, can move in circular manner 815 about an Activated Orbital. The magnet has an axially symmetric magnetic field; as such, this paradigm allows the Levitator to travel in a circular motion 815 about the Activated Orbital. Notice that as the Levitator moves from its original position 2000 to its present position 800; its motions produce no torque or resistance from the Vortices and the Vortices are maintained throughout the action. According to an embodiment of the invention, Levitator is far smaller than the magnetic surface where the revolute joint is formed. And the Levitator acts as the rotor; and its movement is powered by a electromagnetic motor/generator (not illustrated herein).

From a ¾ View of Front/Top, FIG. 20D demonstrates a type of motion which is prohibited by the Vortices in this present configuration. In particular, the Levitator 800 breaks away from its Activated Orbital moving towards 2010 the center of the magnet's axis. Notice that as the Levitator 800 moves from its original position to its present position 800; its motions produce torque and resistance from the Vortices, resulting in the breaking 835 of the Vortices.

From a ¾ View of Front/Top, FIG. 20E demonstrates a type of motion which is prohibited by the Vortices in this present configuration. In particular, the Levitator 800 breaks away from its Activated Orbital moving away from 2015 the center of the magnet's axis. Notice that as the Levitator 800 moves from its original position to its present position 800, its motions produce torque and resistance from the Vortices, resulting in the breaking 835 of the Vortices.

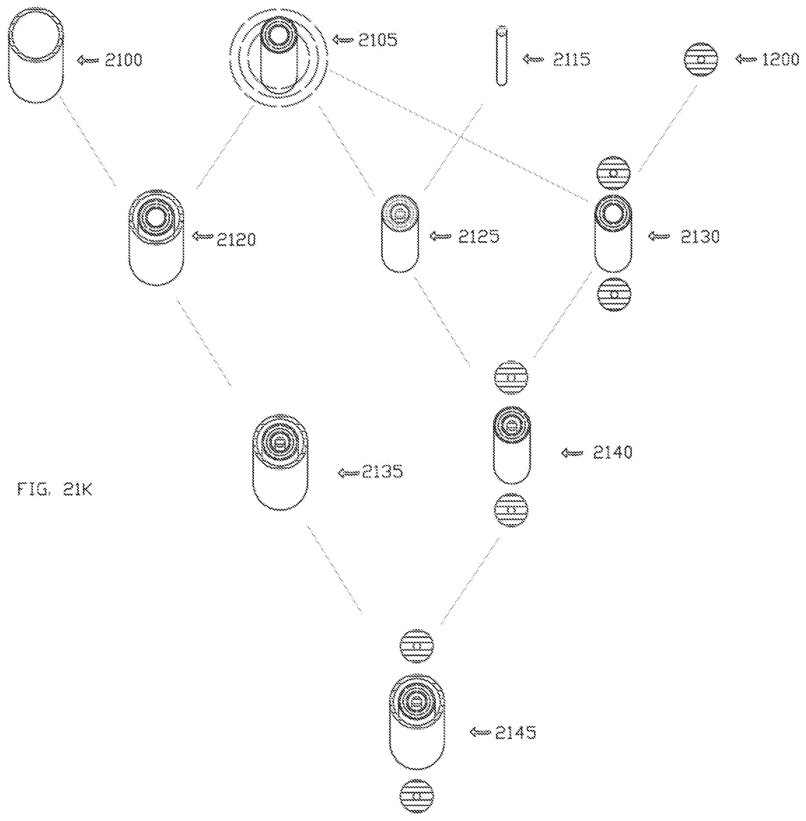

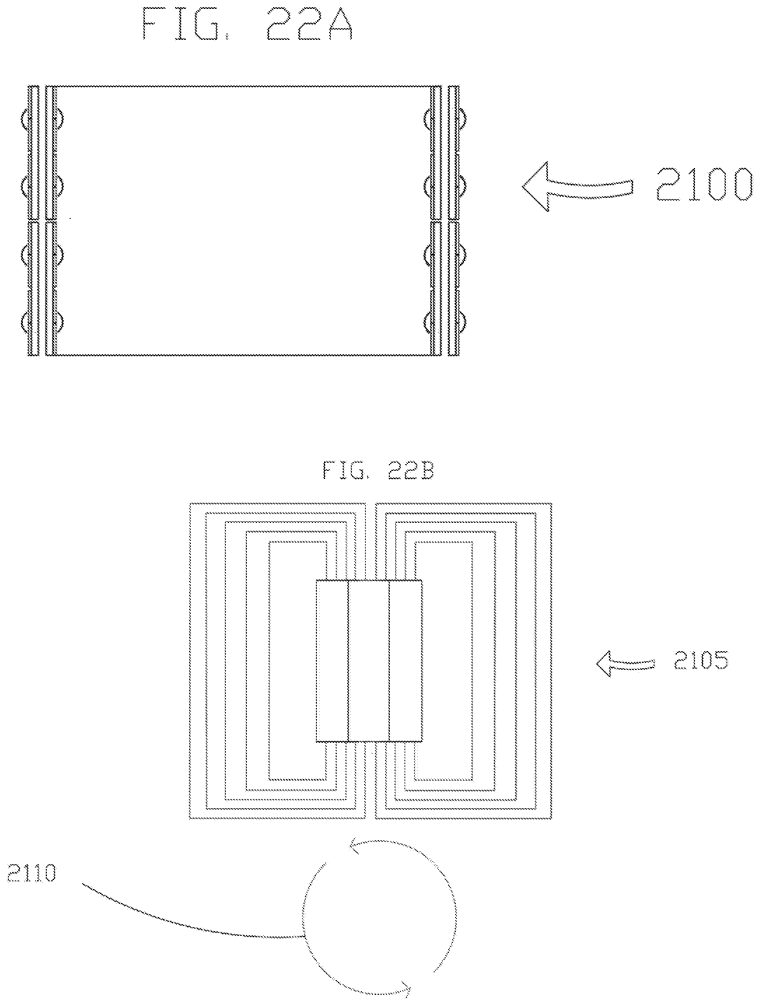

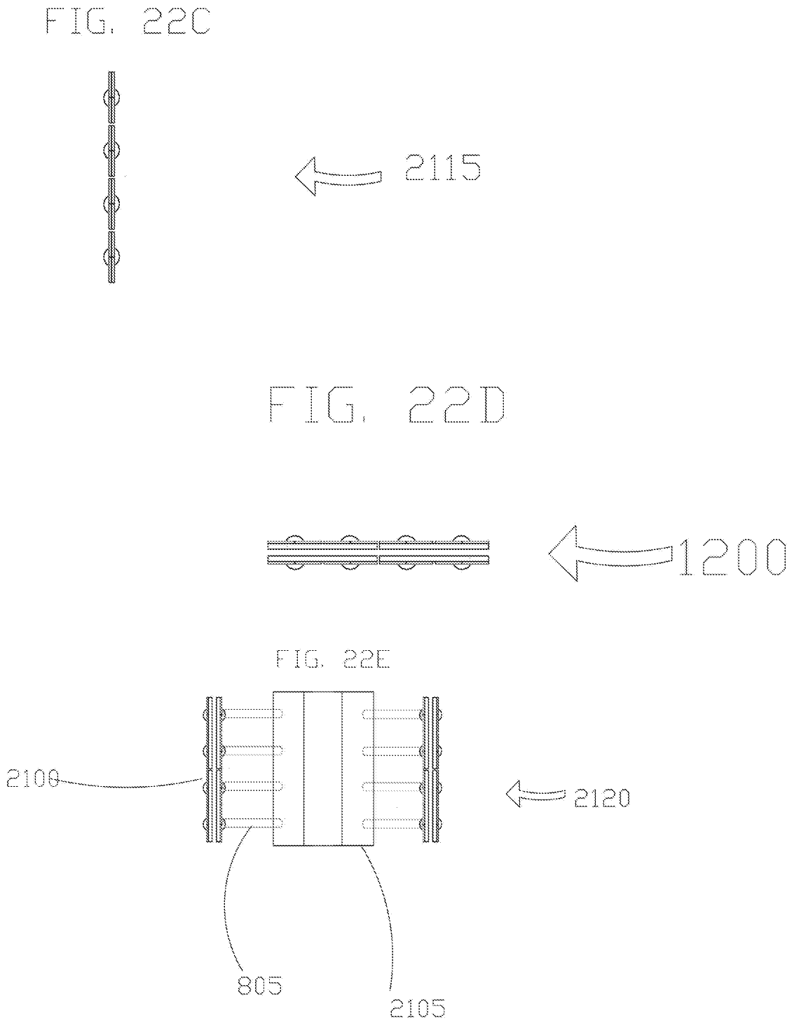

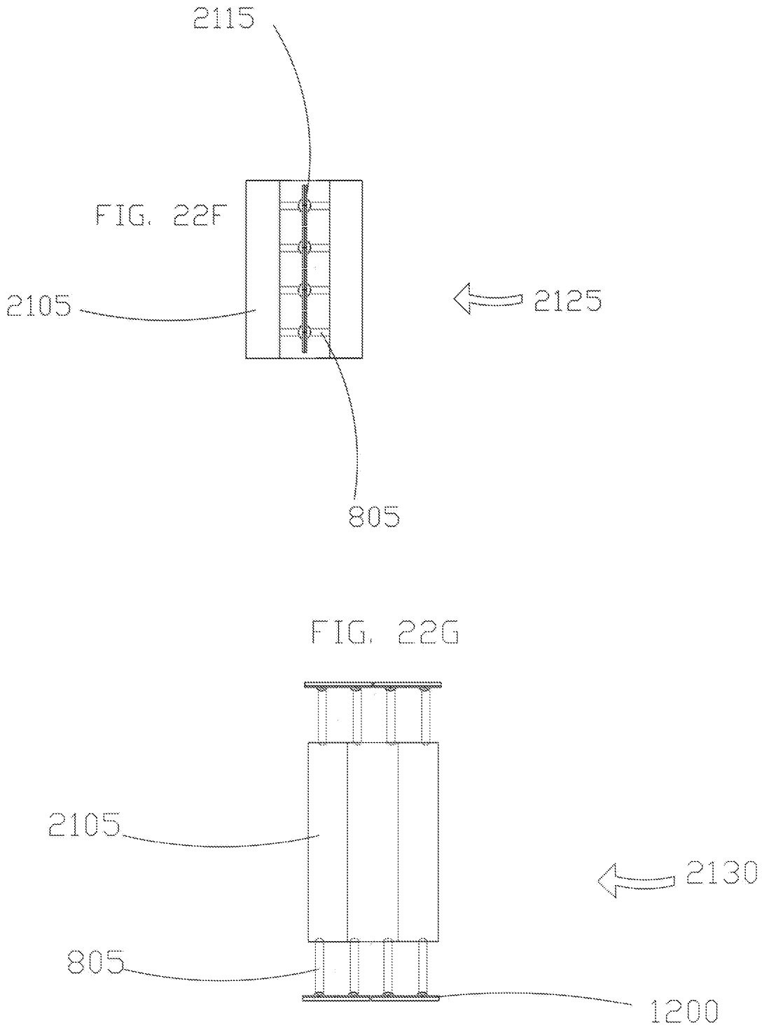

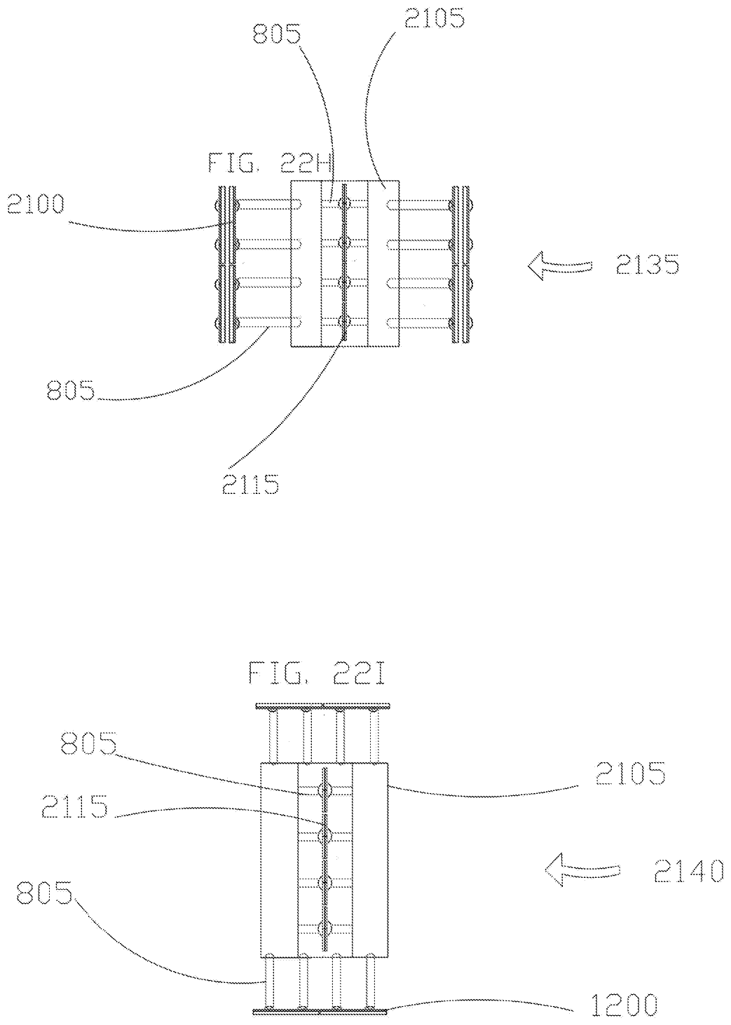

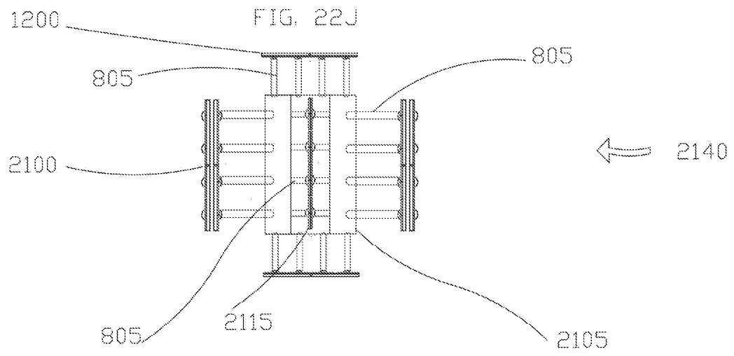

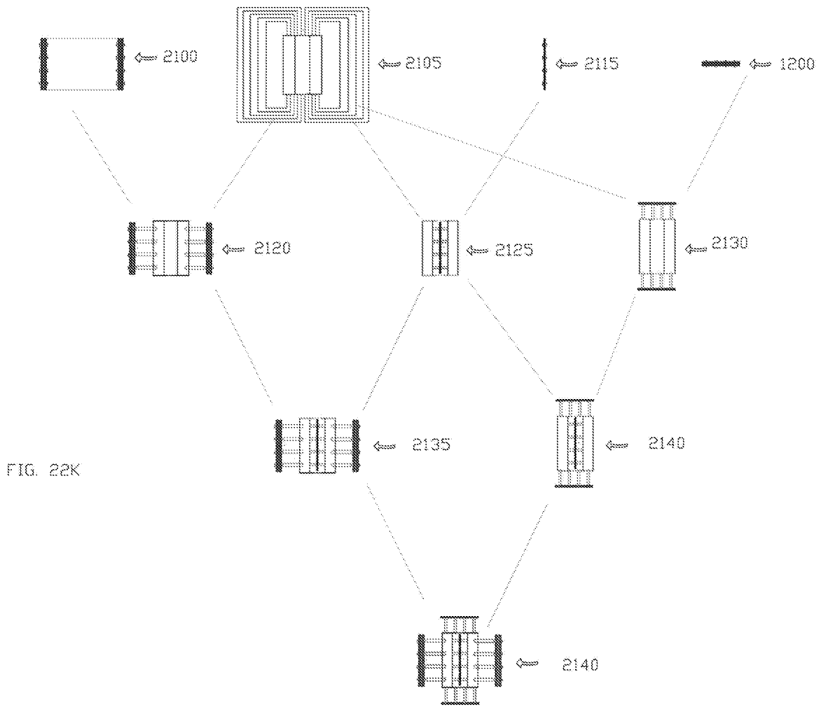

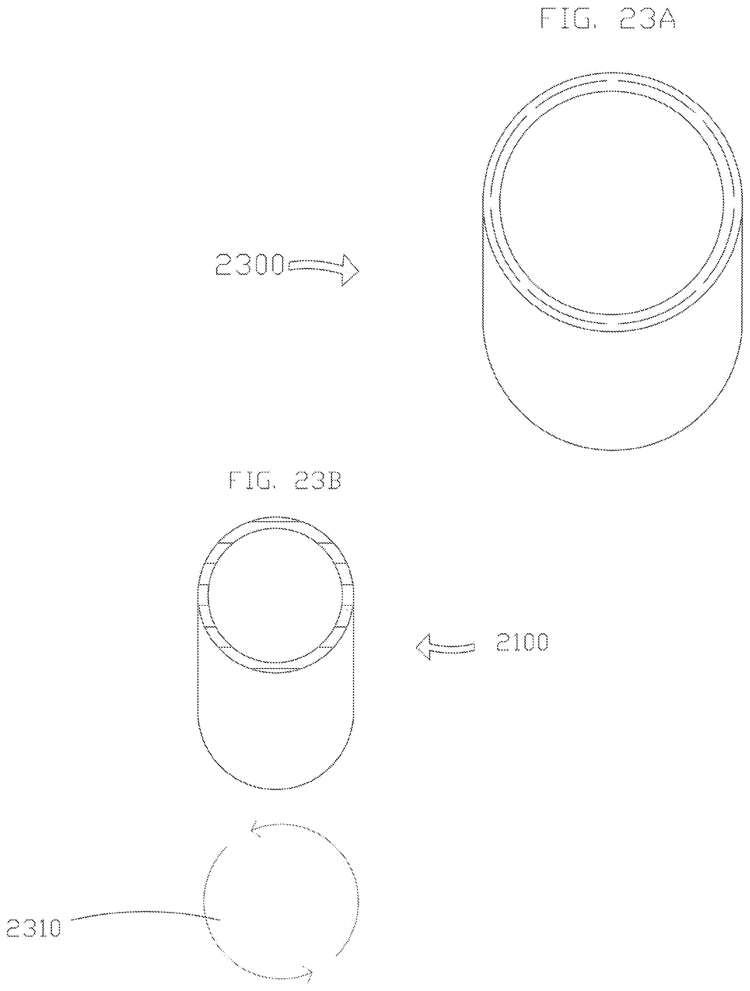

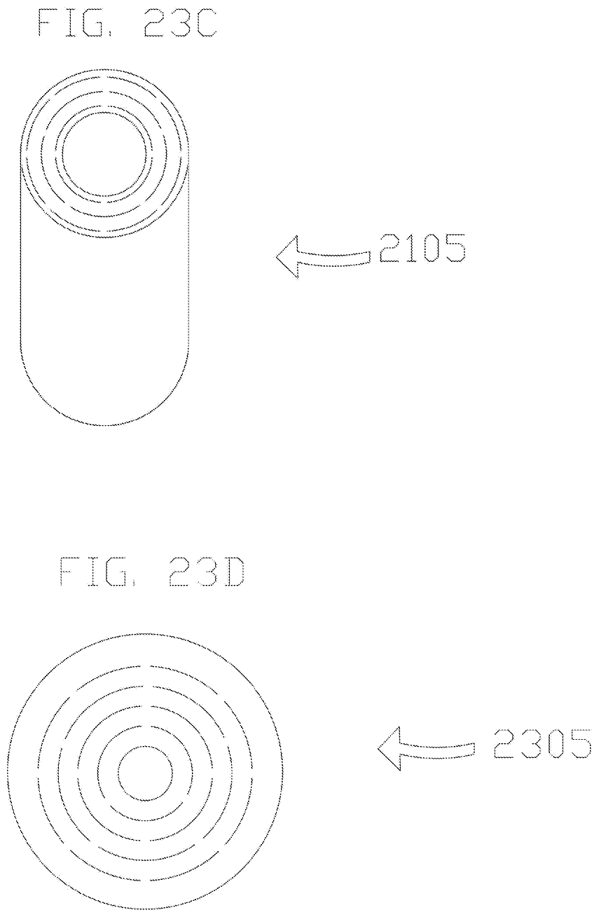

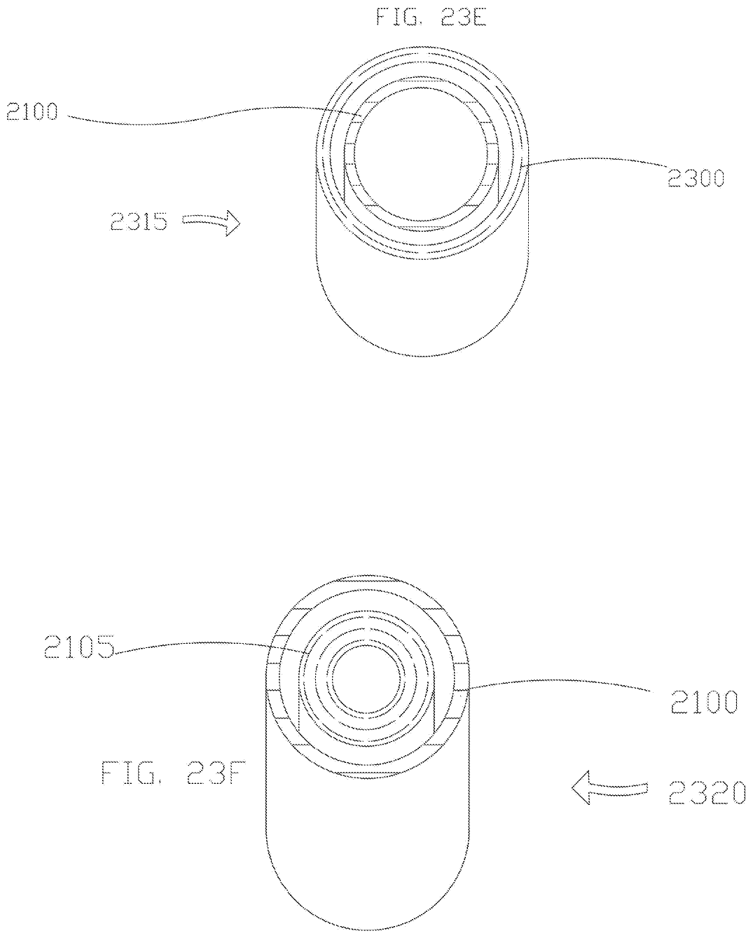

From a ¾ view of front/top, FIG. 21A illustrates the wide cylindrical Levitator with a hollow center 2100.

From a ¾ view of front/top, FIG. 21B illustrates the wide cylindrical permanent magnet with a hollow center 2105. Throughout this FIG. 21 this magnet will act as the spinning component 2110.

From a ¾ view of front/top, FIG. 21C illustrates the narrow cylindrical Levitator 2115.

From a ¾ view of front/top, FIG. 21D illustrates a flat disk shaped Levitator 1200.

From a ¾ view of front/top, FIG. 21E illustrates a flywheel system 2120 where the Levitator 2100 acts as the stator while the magnet 2105 acts as the rotor.

From a ¾ view of front/top, FIG. 21F illustrates a flywheel system 2125 where the Levitator 2115 acts as the stator while the magnet 2105 acts as the rotor.

From a ¾ view of front/top, FIG. 21G illustrates a flywheel system 2130 where the Levitator 1200 acts as the stator while the magnet 2105 acts as the rotor.

From a ¾ view of front/top, FIG. 21H illustrates a flywheel system 2135 where two separate Levitators 2100 and 2115 acts as the stators while the Magnet 2105 acts as the rotor.

From a ¾ view of front/top, FIG. 21I illustrates a flywheel system 2140 where three separate Levitators 1200 and 2115 acts as the stators while the Magnet 2105 acts as the rotor.

From a ¾ view of front/top, FIG. 21J illustrates a flywheel system 2145 where four separate Levitators 1200, 2100 and 2115 acts as the stators while the Magnet 2105 acts as the rotor.

From a ¾ view of front/top, this FIG. 21K illustrates a “battery cell” of the FESS; whereas, one or more Levitator(s) are acting as the stator(s), and several surfaces of stator(s) are flux pinned to a cylindrical permanent magnet forming the necessary revolute joint(s). In this FIG. 21K depiction, the cylindrical permanent magnet is the spinning element (or rotor), while one or more Levitator(s) are acting as the stator. This FESS is alluding to mechanisms described in FIG. 21A through FIG. 21J.

From a front-view/cutaway perspective, FIG. 22A illustrates the wide cylindrical Levitator with a hollow center 2100.

From a front-view/cutaway perspective, FIG. 22B illustrates the wide cylindrical permanent magnet with a hollow center 2105. Throughout this FIG. 22 this magnet will act as the spinning component 2110.

From a front-view/cutaway perspective, FIG. 22C illustrates the narrow cylindrical Levitator 2115.

From a front-view/cutaway perspective, FIG. 22D illustrates a flat disk shaped Levitator 1200.

From a front-view/cutaway perspective, FIG. 22E illustrates a flywheel system 2120 where the Levitator 2100 acts as the stator while the magnet 2105 acts as the rotor. Vortice 805 formation is also illustrated.

From a front-view/cutaway perspective, FIG. 22F illustrates a flywheel system 2125 where the Levitator 2115 acts as the stator while the magnet 2105 acts as the rotor. Vortice 805 formation is also illustrated.

From a front-view/cutaway perspective, FIG. 22G illustrates a flywheel system 2130 where the Levitator 1200 acts as the stator while the magnet 2105 acts as the rotor. Vortice 805 formation is also illustrated.

From a front-view/cutaway perspective, FIG. 22H illustrates a flywheel system 2135 where two separate Levitators 2100 and 2115 acts as the stators while the magnet 2105 acts as the rotor. Vortice 805 formation is also illustrated.

From a front-view/cutaway perspective, FIG. 22I illustrates a flywheel system 2140 where three separate Levitators 1200 and 2115 acts as the stators while the magnet 2105 acts as the rotor. Vortice 805 formation is also illustrated.

From a front-view/cutaway perspective, FIG. 22J illustrates a flywheel system 2145 where four separate Levitators 1200, 2100 and 2115 acts as the stators while the magnet 2105 acts as the rotor. Vortice 805 formation is also illustrated.

From a front-view/cutaway perspective, this FIG. 22K illustrates a “battery cell” of the FESS; whereas, one or more Levitator(s) are acting as the stator(s), and several surfaces of stator(s) are flux pinned to a cylindrical permanent magnet forming the necessary revolute joint(s). In this FIG. 22K depiction, the cylindrical permanent magnet is the spinning element (or rotor), while one or more Levitator(s) are acting as the stator. This FESS is alluding to mechanisms described in FIG. 22A through FIG. 22J.

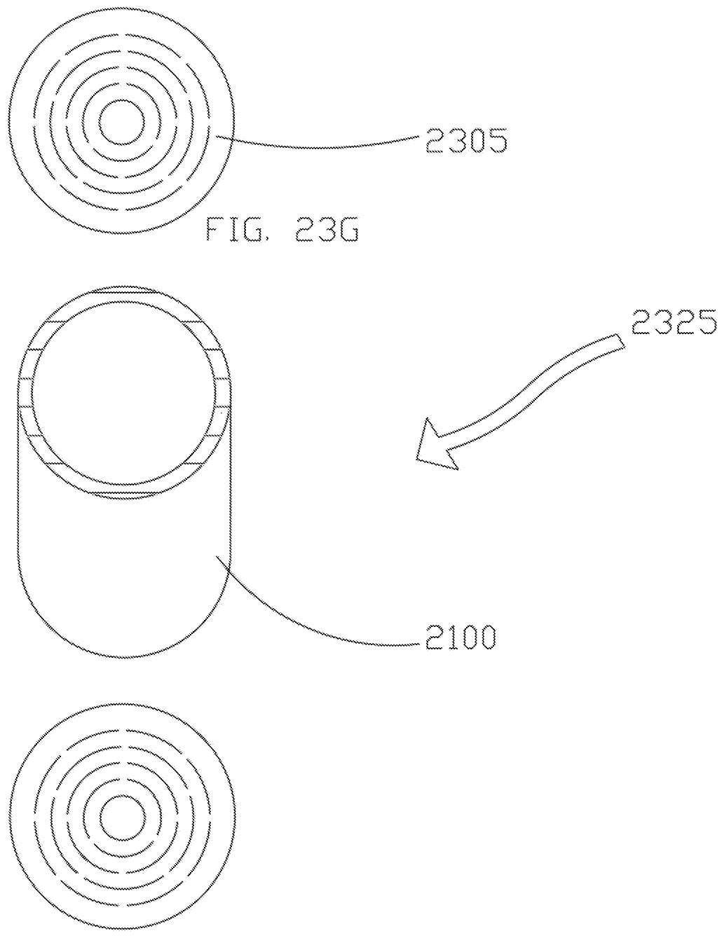

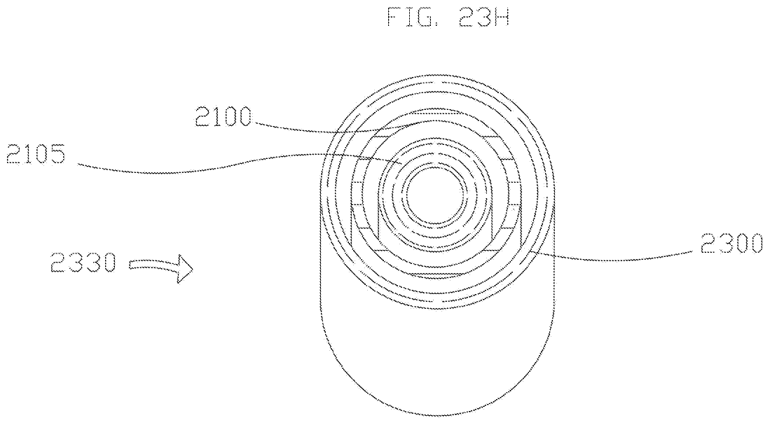

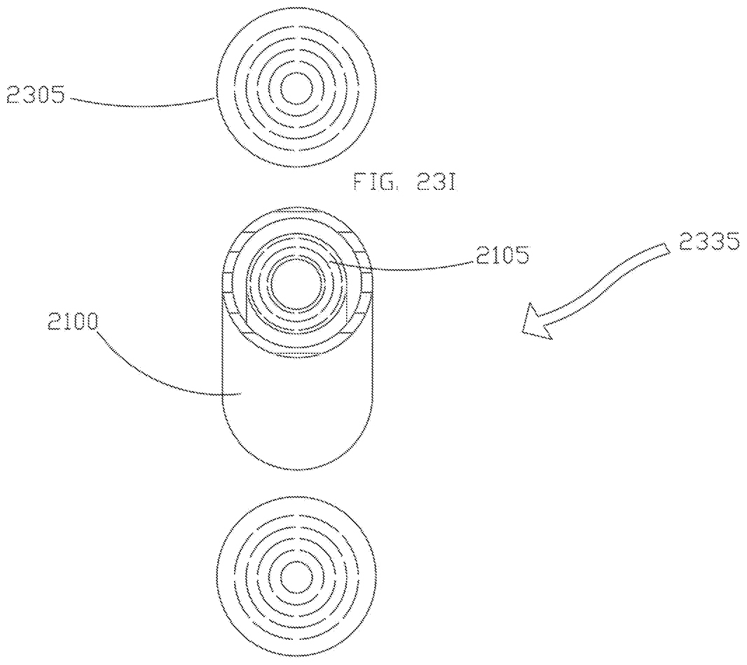

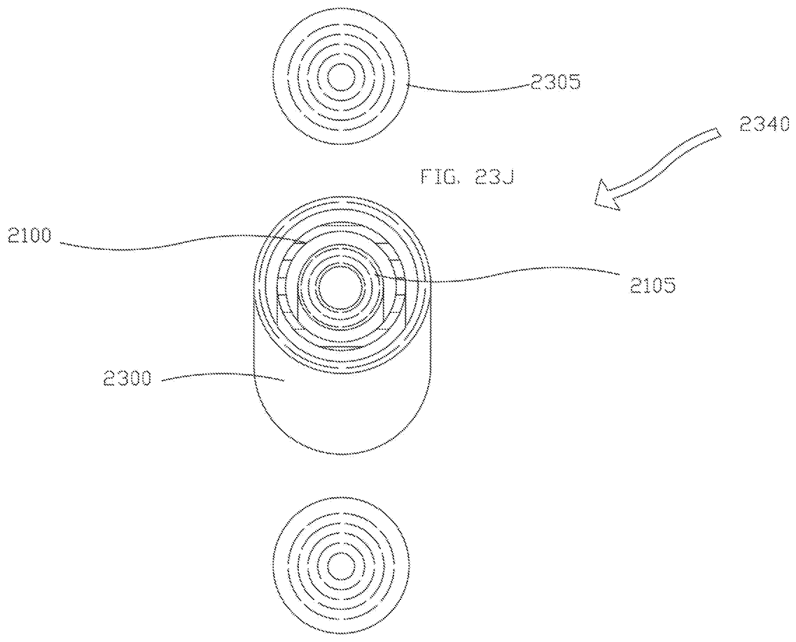

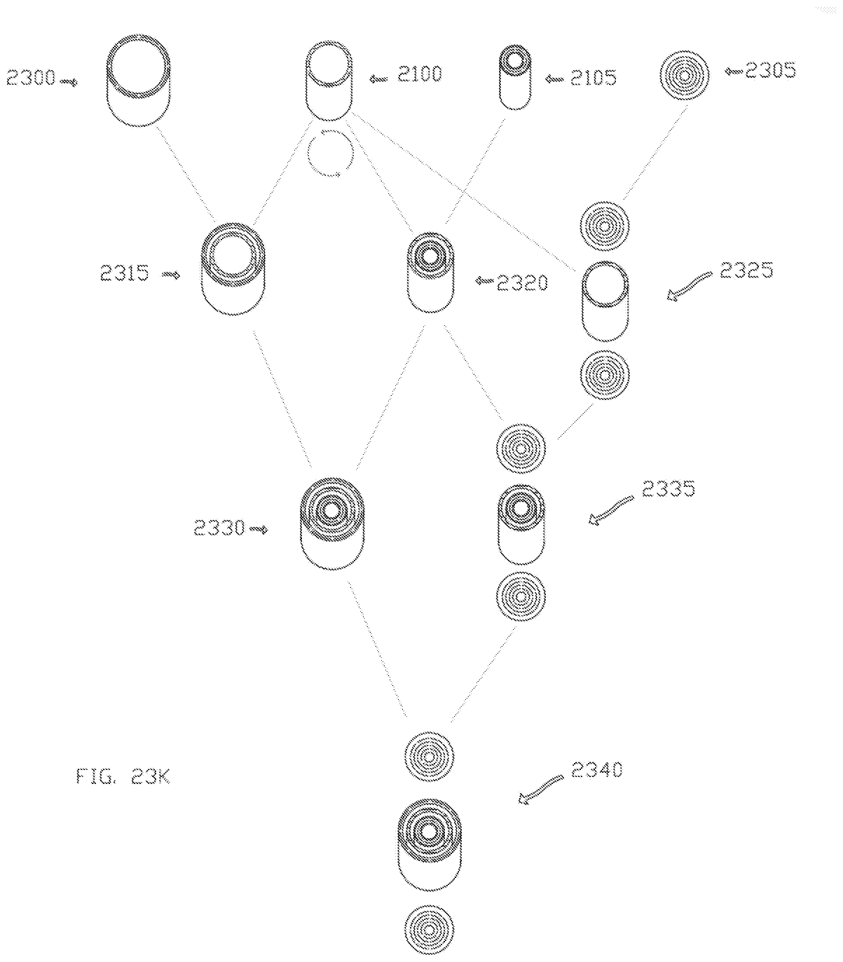

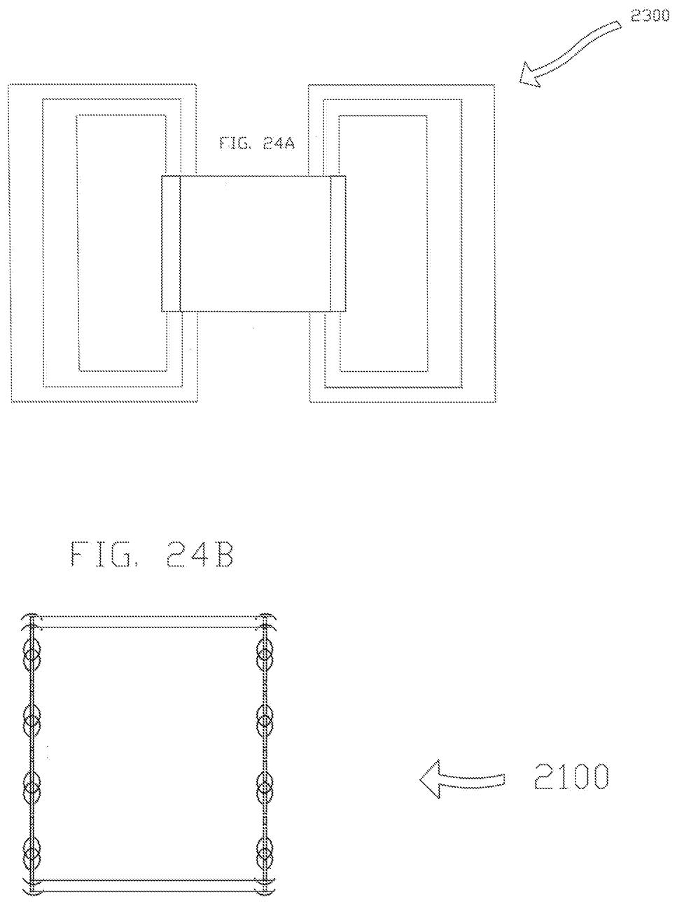

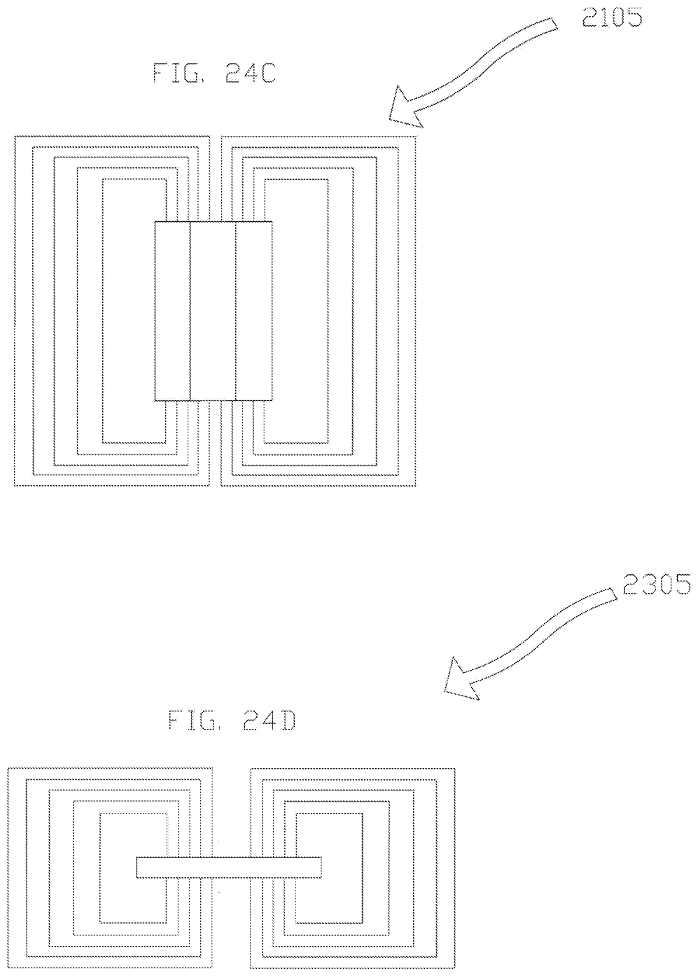

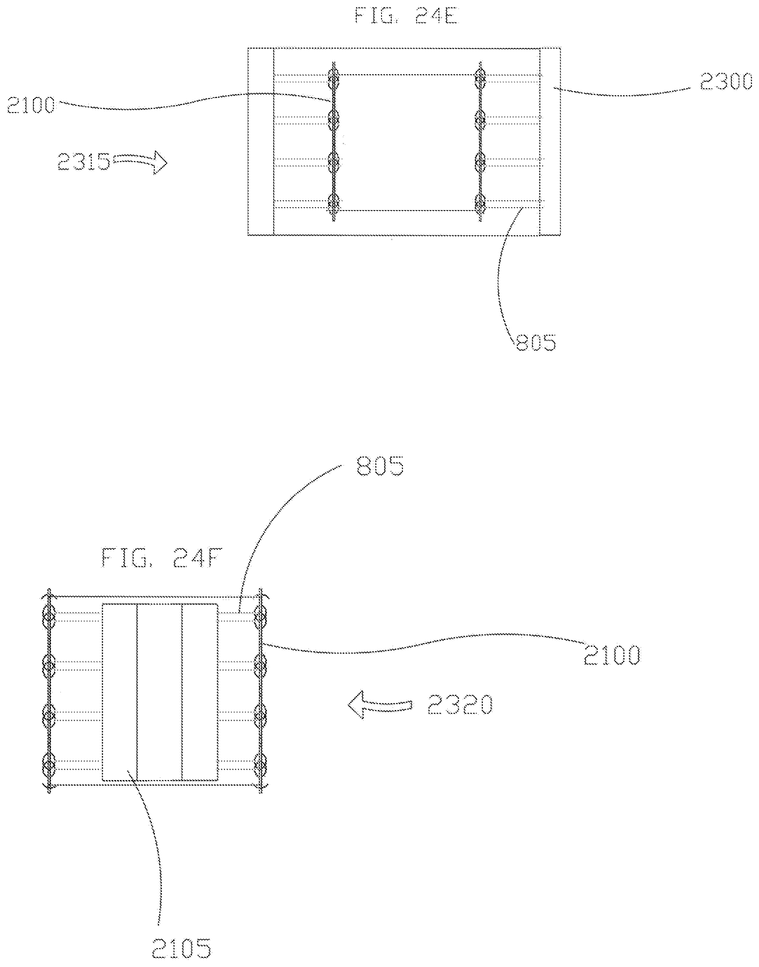

From a ¾ view of front/top, FIG. 23A illustrates the very wide cylindrical permanent magnet with a hollow center 2300.

From a ¾ view of front/top, FIG. 23B illustrates the wide cylindrical Levitator with a hollow center 2100. Throughout this FIG. 23 this Levitator will act as the spinning component 2310.

From a ¾ view of front/top, FIG. 23C illustrates the wide cylindrical permanent magnet with a hollow center 2105.

From a ¾ view of front/top, FIG. 23D illustrates a flat disk shaped magnet 2305.

From a ¾ view of front/top, FIG. 23E illustrates a flywheel system 2315 where the magnet 2300 acts as the stator while the Levitator 2100 acts as the rotor.

From a ¾ view of front/top, FIG. 23F illustrates a flywheel system 2320 where the magnet 2105 acts as the stator while the Levitator 2100 acts as the rotor.

From a ¾ view of front/top, FIG. 23G illustrates a flywheel system 2325 where two separate magnets 2305 acts as the stator while the Levitator 2100 acts as the rotor.

From a ¾ view of front/top, FIG. 23H illustrates a flywheel system 2330 where two separate magnets 2300 and 2105 acts as the stators while the Levitator 2100 acts as the rotor.

From a ¾ view of front/top, FIG. 23I illustrates a flywheel system 2335 where three separate magnets 2305 and 2105 acts as the stators while the Levitator 2100 acts as the rotor.

From a ¾ view of front/top, FIG. 23J illustrates a flywheel system 2340 where four separate magnets 2300, 2105 and 2305 acts as the stators while the Levitator 2100 acts as the rotor.

From a ¾ view of front/top, this FIG. 23K illustrates a “battery cell” of the FESS; whereas, one or more cylindrical permanent magnet(s) are acting as the stator(s), and several surfaces of stators are flux pinned to a Levitator forming the necessary revolute joint(s). In this FIG. 23K depiction, the Levitator is the spinning element (or rotor), while one or more magnets are acting as the stator. This FESS is alluding to mechanisms described in FIG. 23A through FIG. 23J.

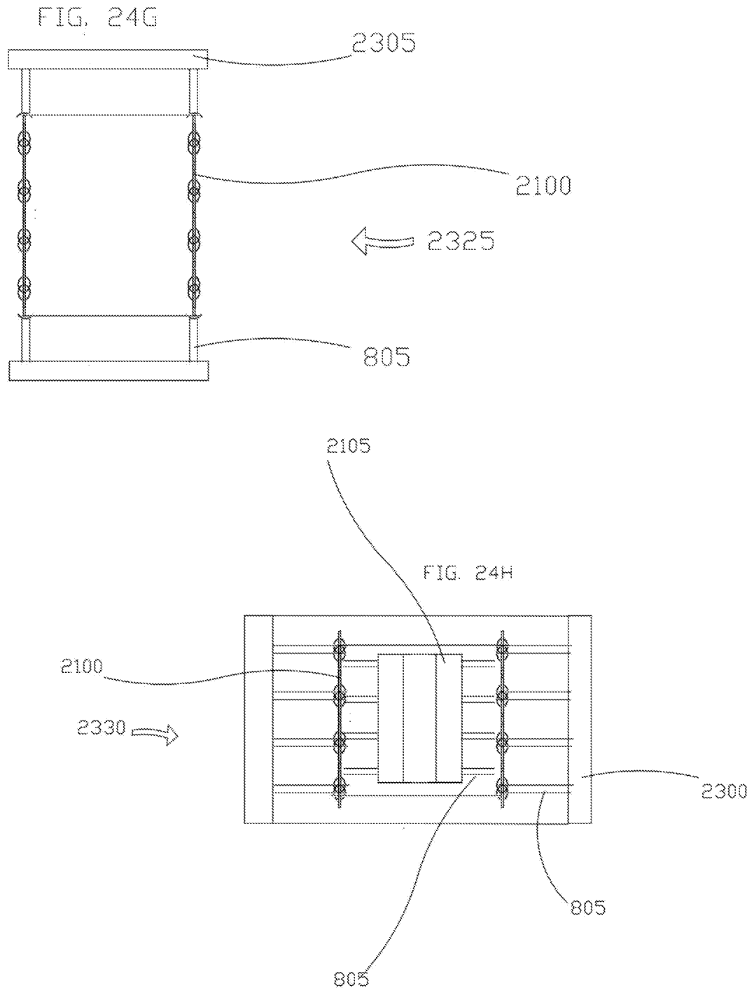

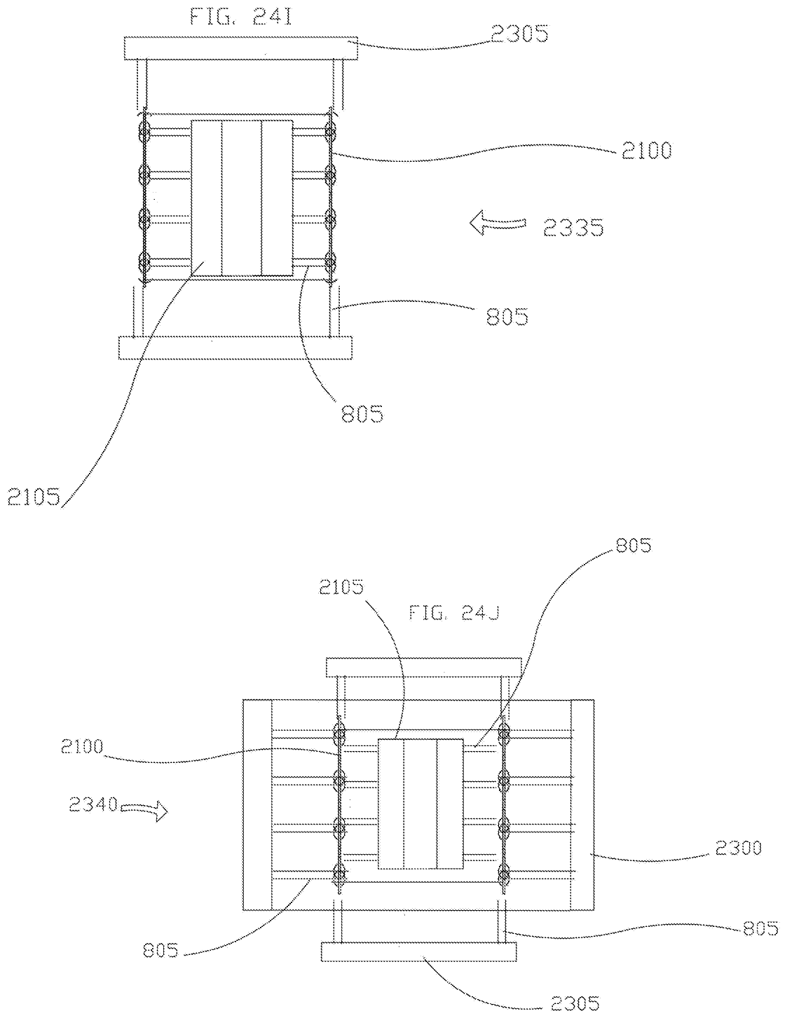

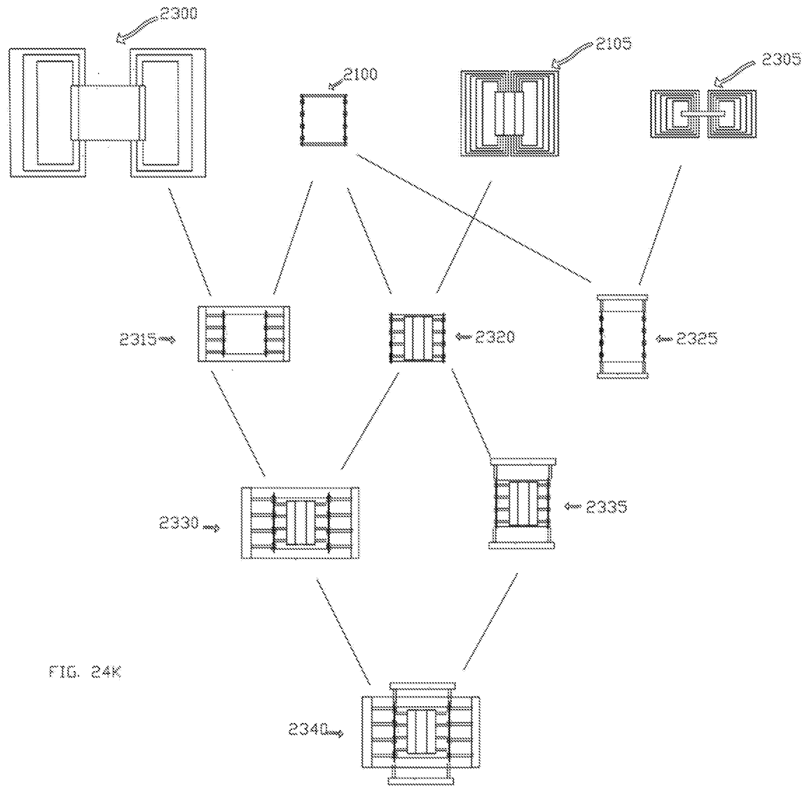

From a front-view/cutaway perspective, FIG. 24A illustrates the very wide cylindrical permanent magnet with a hollow center 2300.

From a front-view/cutaway perspective, FIG. 24B illustrates the wide cylindrical Levitator with a hollow center 2100. Throughout this FIG. 24 this Levitator will act as the spinning component/rotor.

From a front-view/cutaway perspective, FIG. 24C illustrates the wide cylindrical permanent magnet with a hollow center 2105.

From a front-view/cutaway perspective, FIG. 24D illustrates a flat disk shaped magnet 2305.

From a front-view/cutaway perspective, FIG. 24E illustrates a flywheel system 2315 where the magnet 2300 acts as the stator while the Levitator 2100 acts as the rotor. Vortice 805 formation is also illustrated.

From a front-view/cutaway perspective, FIG. 24F illustrates a flywheel system 2320 where the magnet 2105 acts as the stator while the Levitator 2100 acts as the rotor. Vortice 805 formation is also illustrated.

From a front-view/cutaway perspective, FIG. 24G illustrates a flywheel system 2325 where two separate magnets 2305 acts as the stator while the Levitator 2100 acts as the rotor. Vortice 805 formation is also illustrated.

From a front-view/cutaway perspective, FIG. 24H illustrates a flywheel system 2330 where two separate magnets 2300 and 2105 acts as the stators while the Levitator 2100 acts as the rotor. Vortice 805 formation is also illustrated.

From a front-view/cutaway perspective, FIG. 24I illustrates a flywheel system 2335 where three separate magnets 2305 and 2105 acts as the stators while the Levitator 2100 acts as the rotor. Vortice 805 formation is also illustrated.

From a front-view/cutaway perspective, FIG. 24J illustrates a flywheel system 2340 where four separate magnets 2300, 2105 and 2305 acts as the stators while the Levitator 2100 acts as the rotor. Vortice 805 formation is also illustrated.

From a front-view/cutaway perspective, this FIG. 24K illustrates a “battery cell” of the FESS; whereas, one or more cylindrical permanent magnet(s) are acting as the stator(s), and several surfaces of stators are flux pinned to a Levitator forming the necessary revolute joint(s). In this FIG. 24K depiction, the Levitator is the spinning element (or rotor), while one or more magnets are acting as the stator. This FESS is alluding to mechanisms described in FIG. 24A through FIG. 24J.

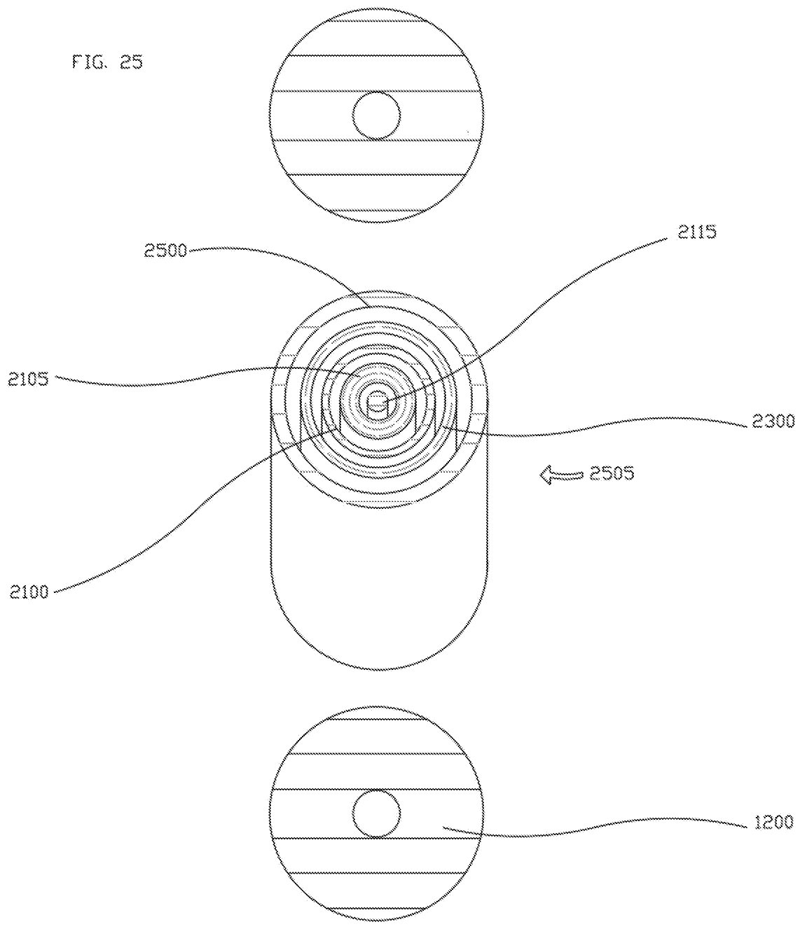

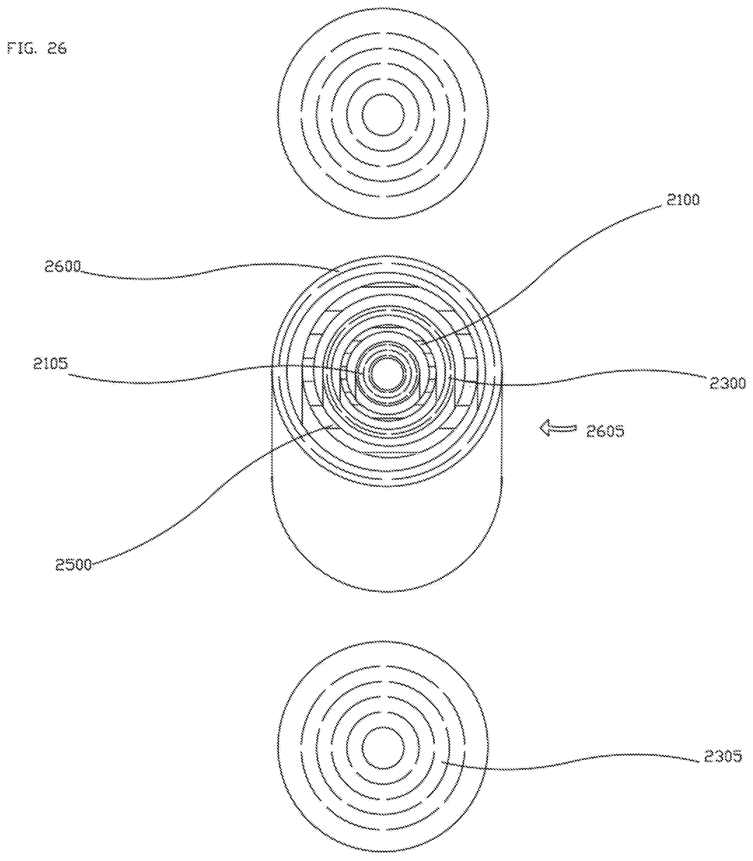

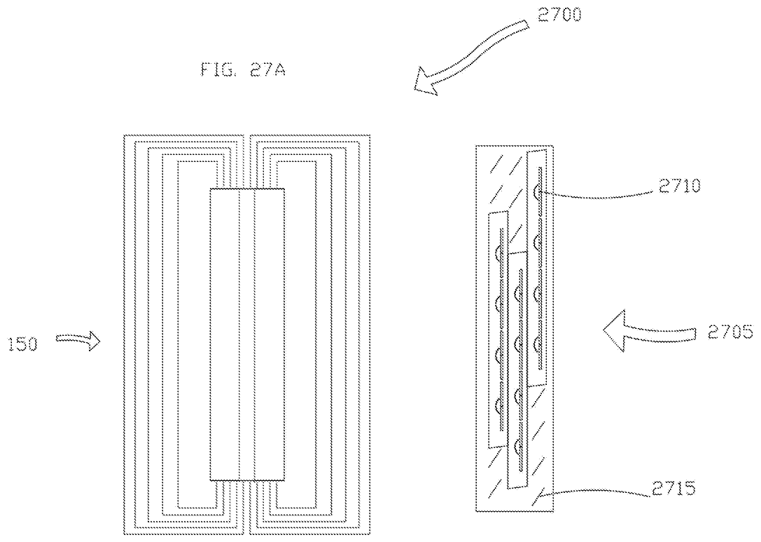

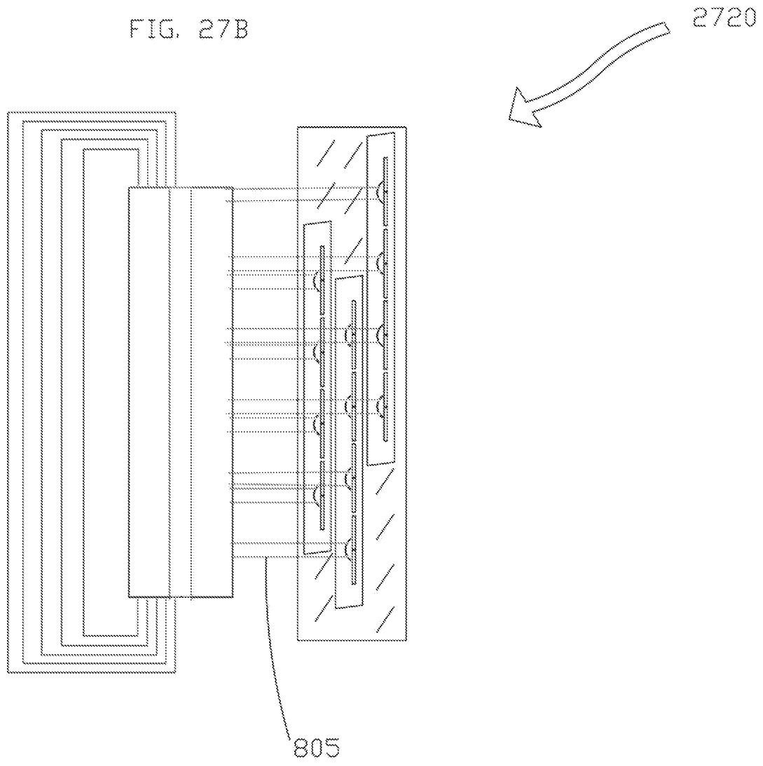

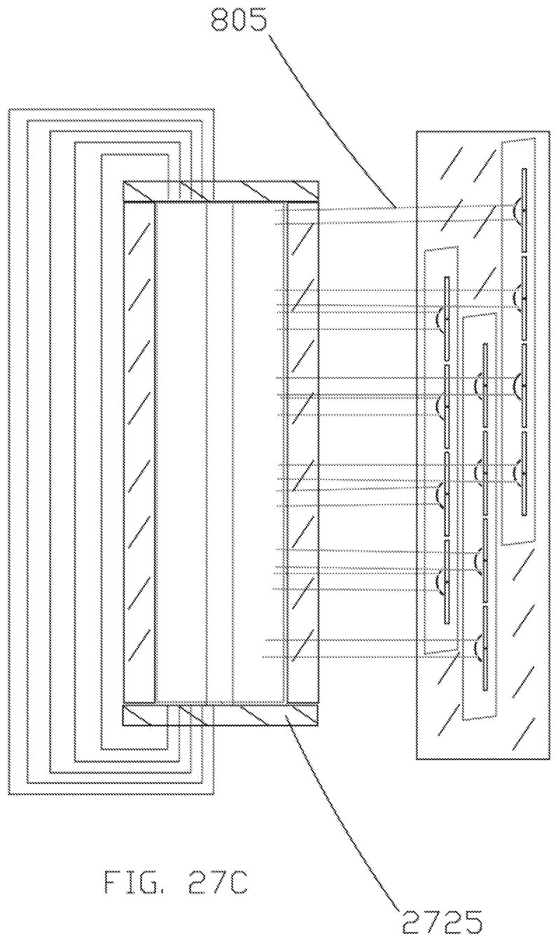

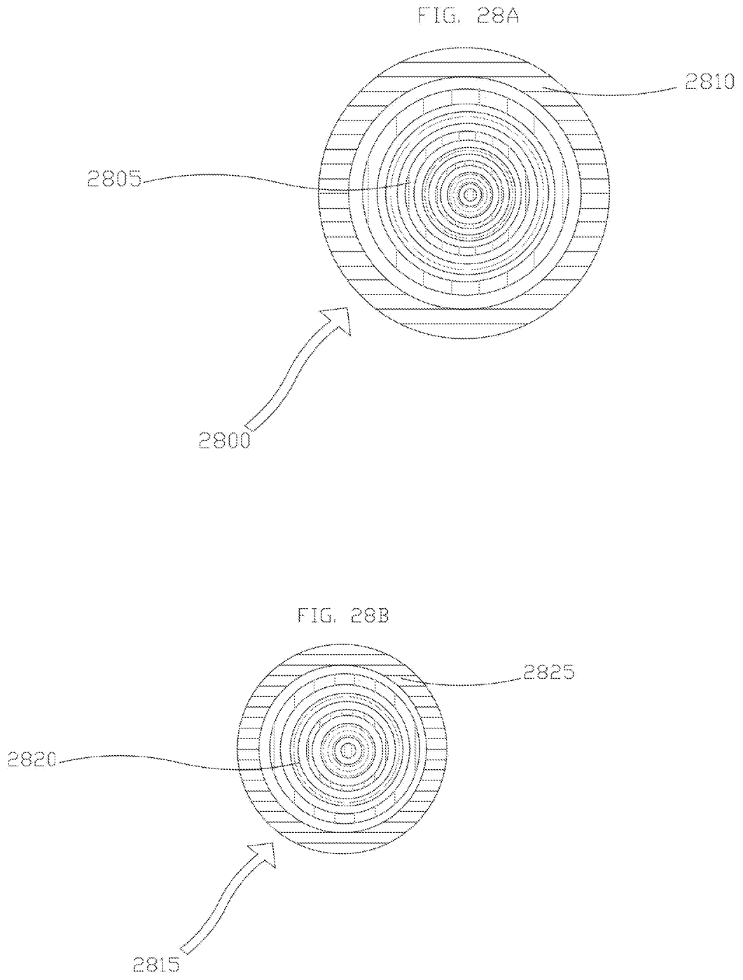

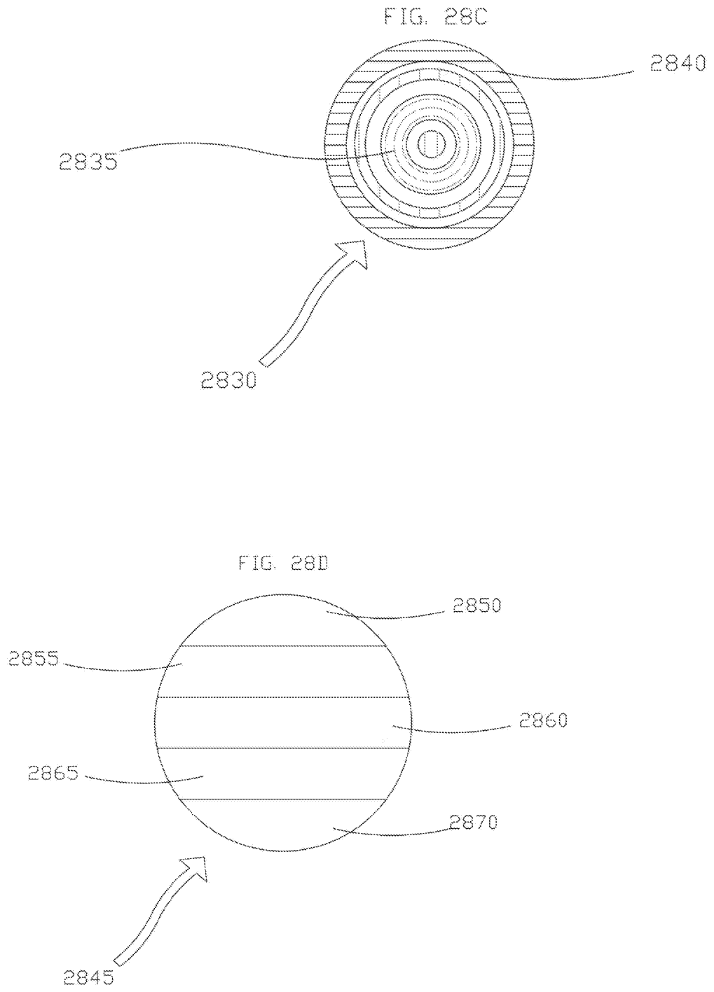

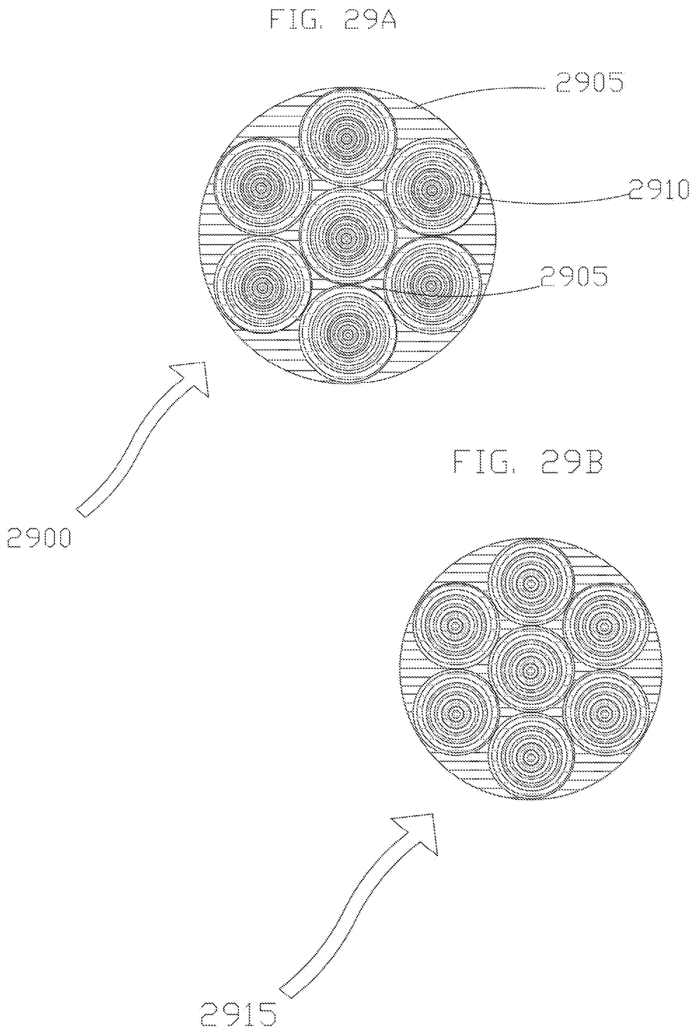

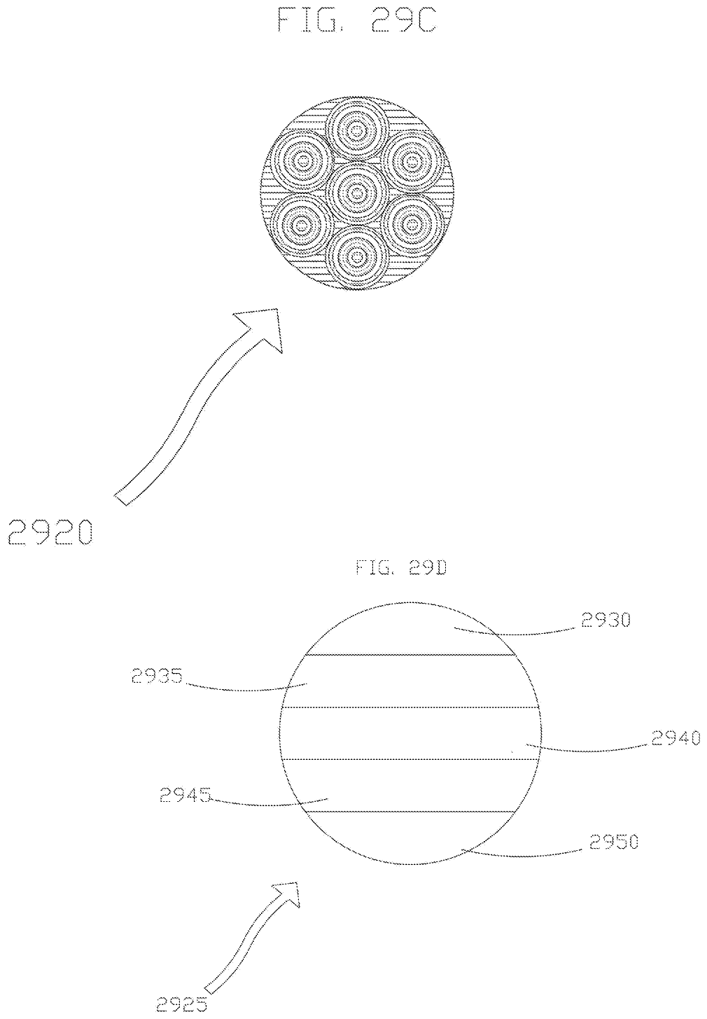

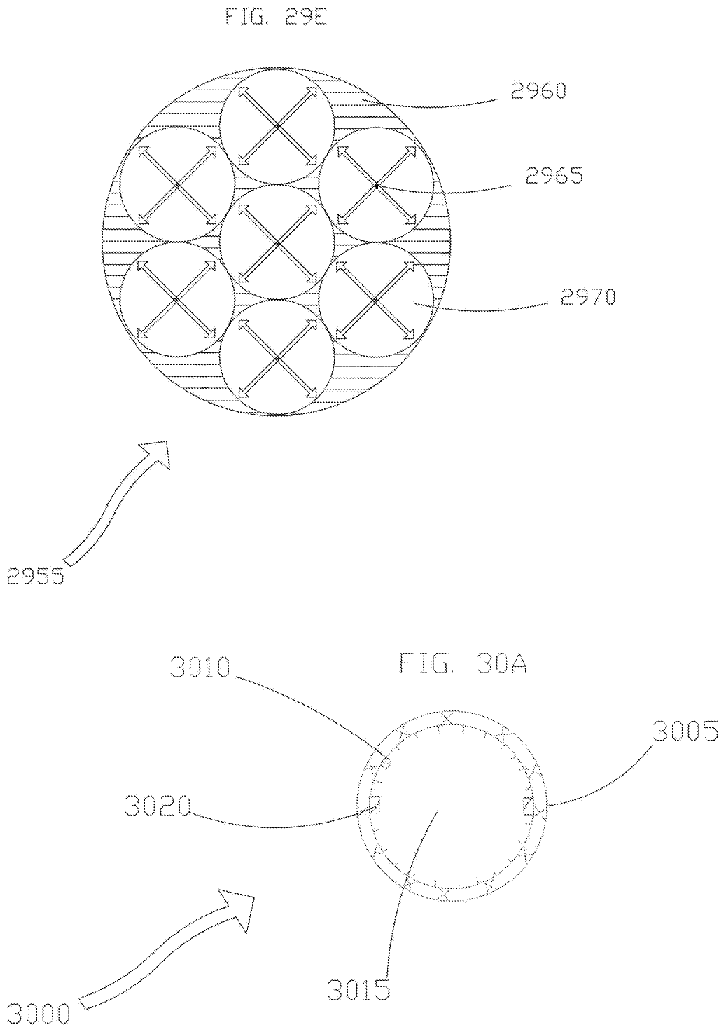

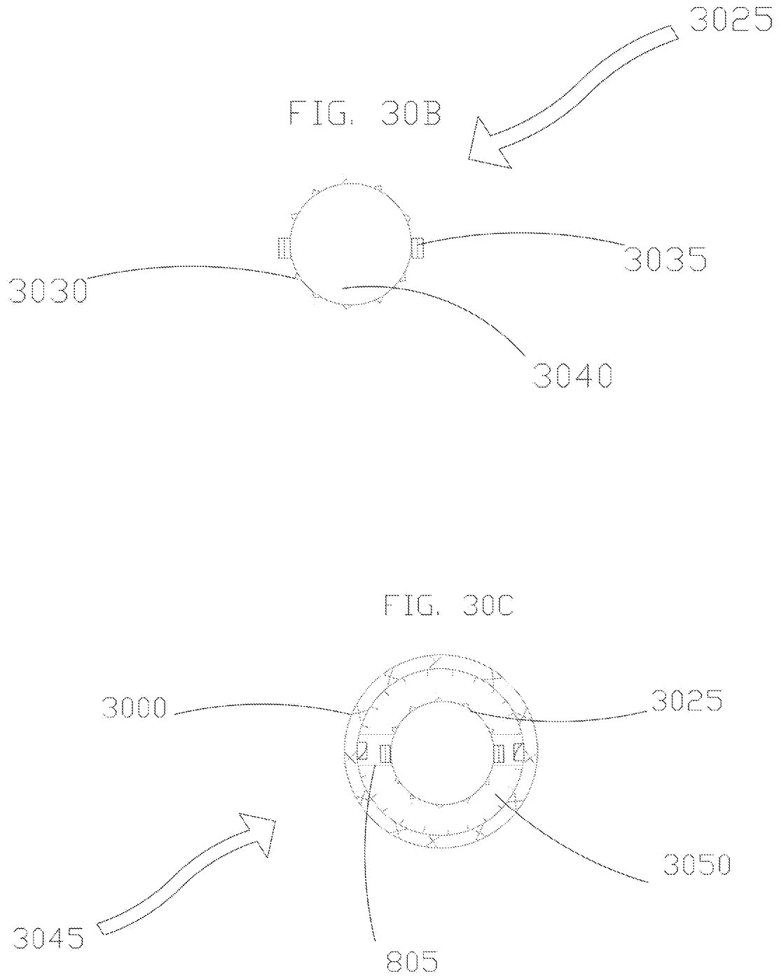

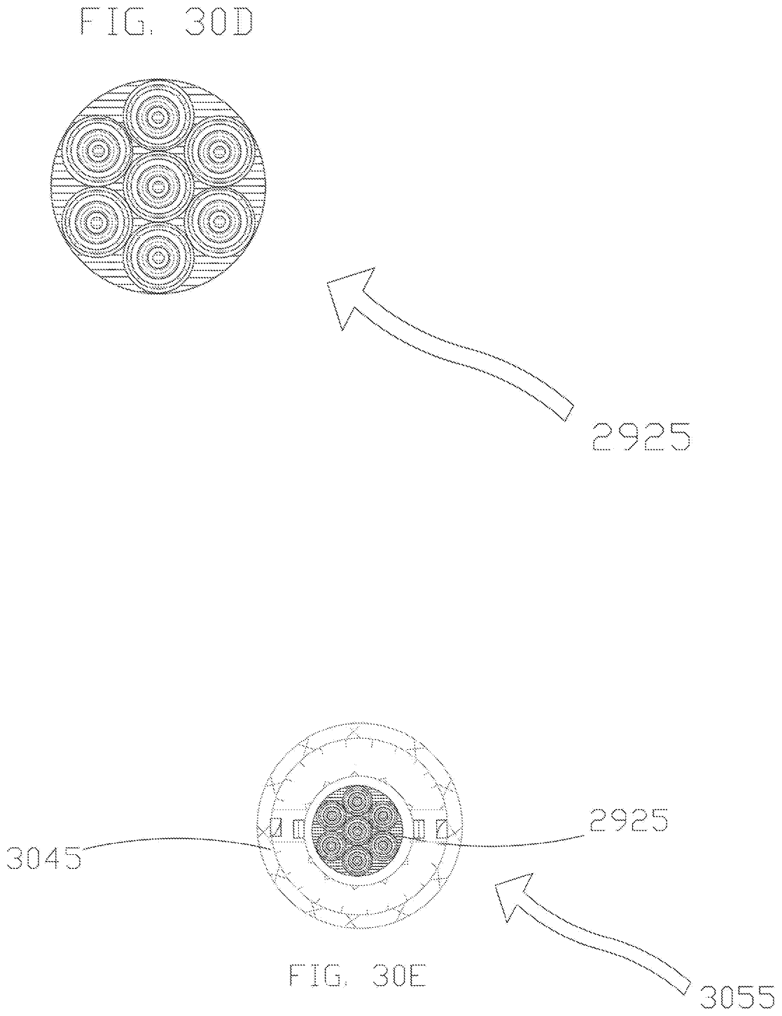

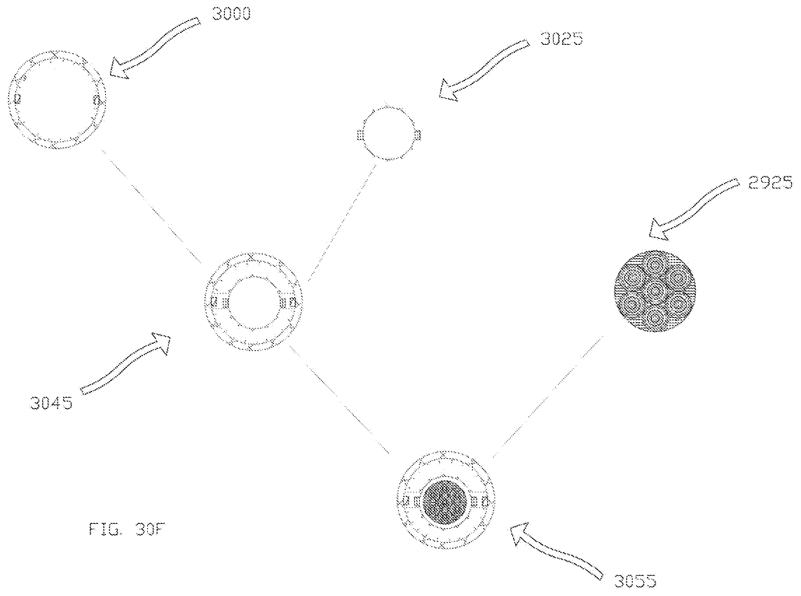

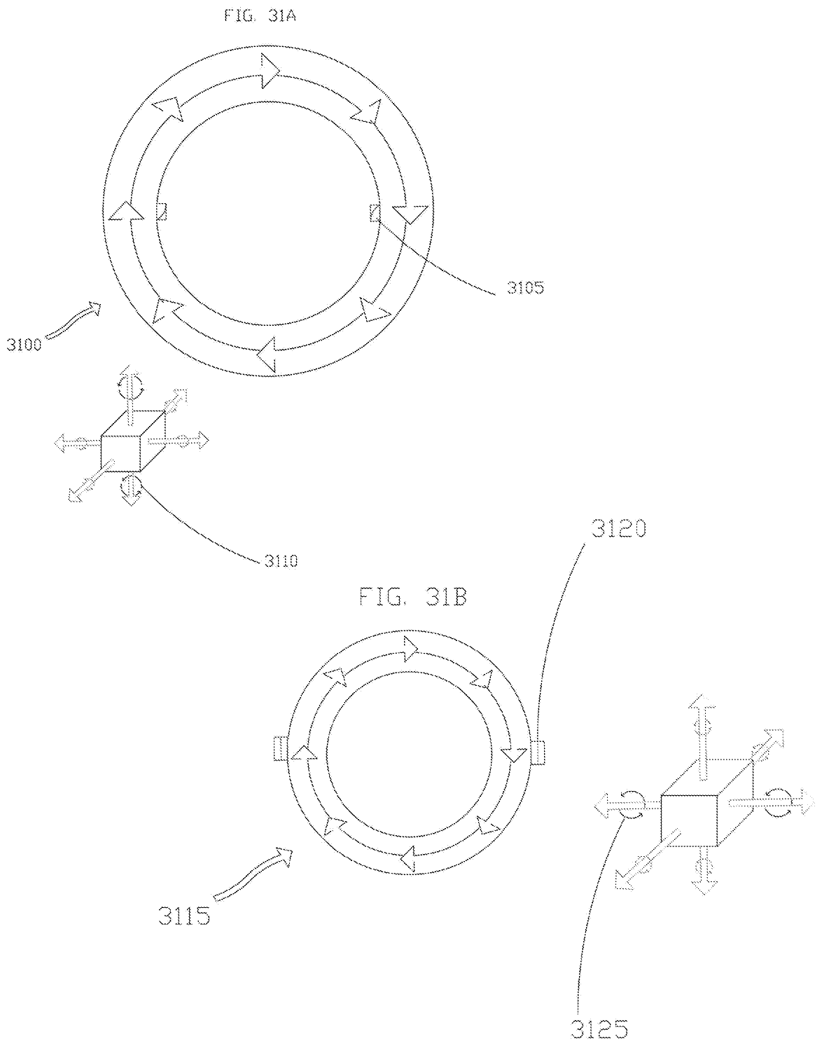

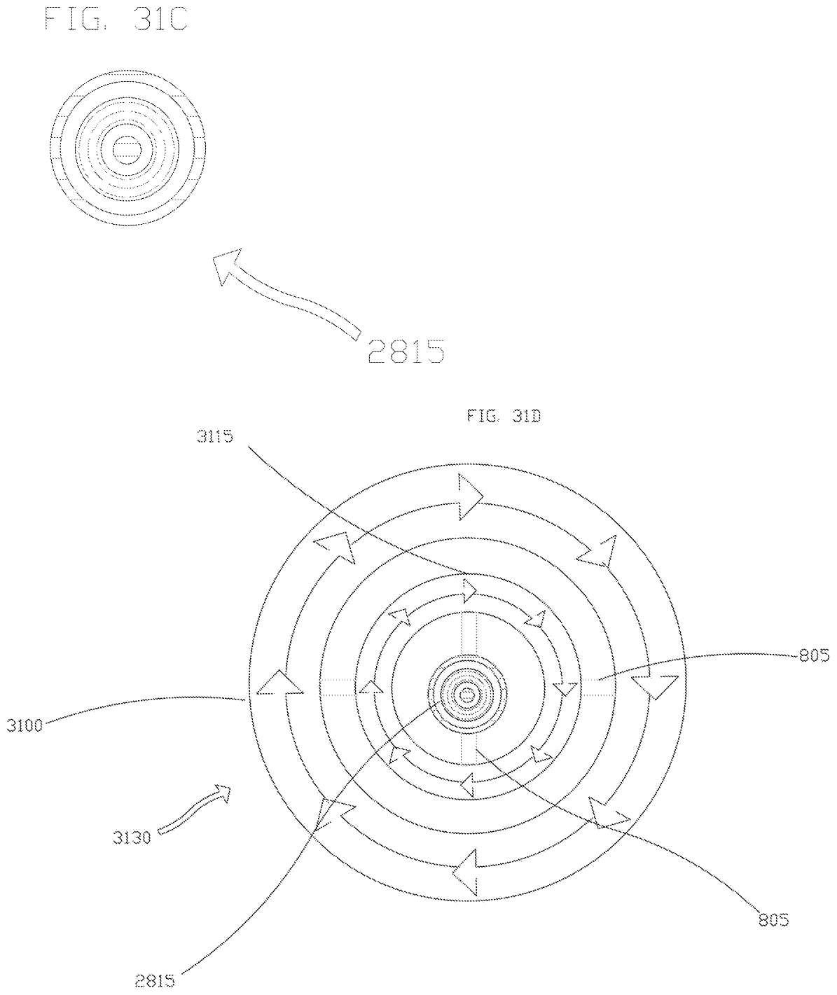

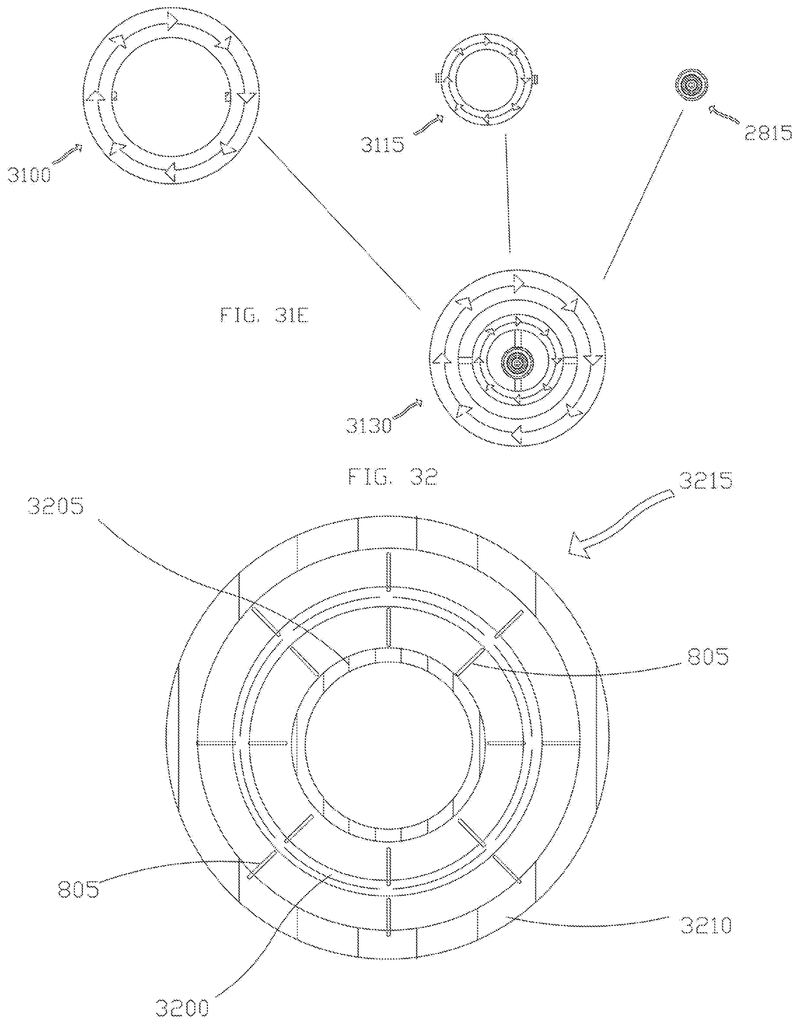

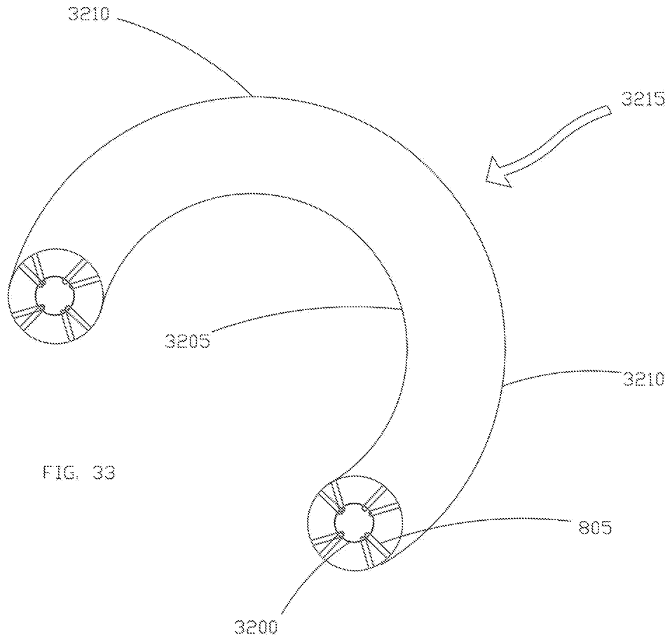

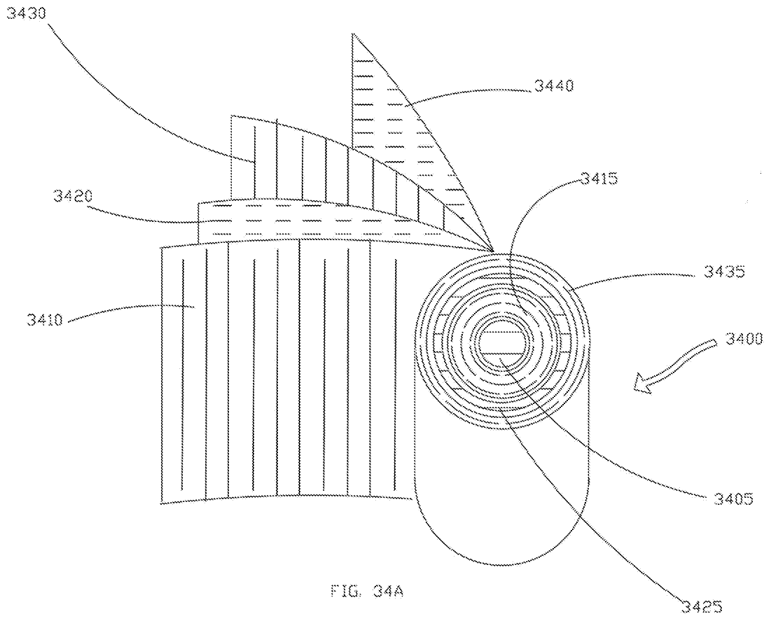

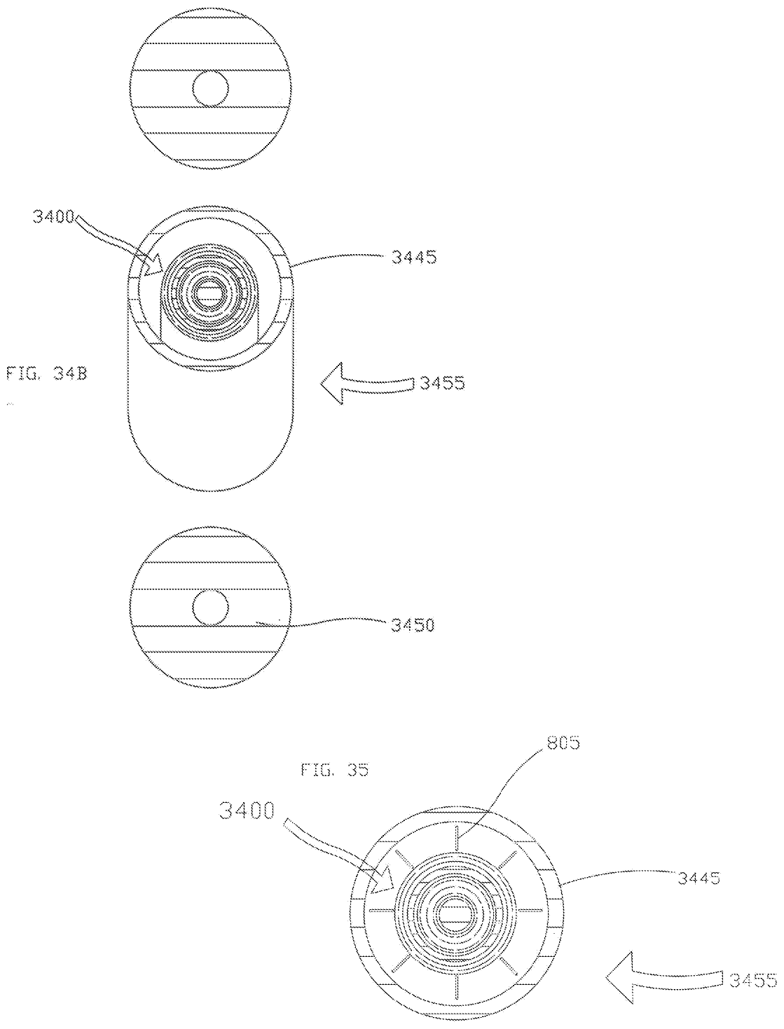

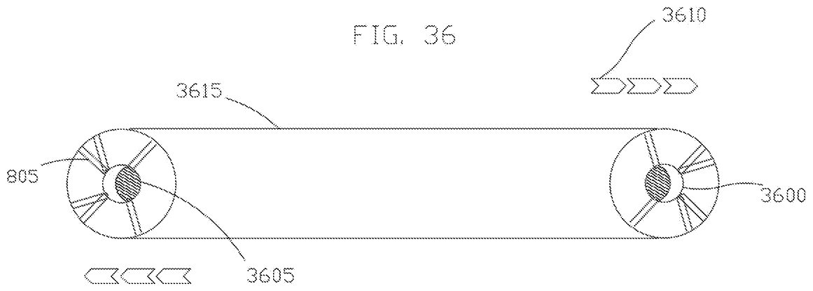

FIG. 25 illustrates—from a ¾ view of front/top—a FESS “battery cell” 2505 with several (two) rotors, each rotor is surrounded by a four (4) sided “tunnel” composed of stator(s). In this example, five separate Levitators (1200, 2500, 2115 and 2100) are acting as the stator(s); the four surfaces of stators comprise the tunnel to which each of the cylindrical permanent magnet(s) is flux pinned to form the necessary revolute joint(s). Additionally, these Levitators can also be flux pinned to cylindrical permanent magnet(s) on either side of their tunnel. The two cylindrical permanent magnets (2300 and 2105), in turn, act as the rotors for the FESS battery cells. According to an embodiment of the invention, the rotors' movement is powered by a electromagnetic motor/generator (not illustrated herein).

FIG. 26 illustrates—from a ¾ view of front/top—a FESS “battery cell” 2605 with several (two) rotors, each rotor is surrounded by a four (4) sided “tunnel” composed of stator(s). In this example, five separate cylindrical permanent magnets (2305, 2600, 2300 and 2105) are acting as the stator(s); the four surfaces of stators comprise the tunnel to which each of the Levitators is flux pinned to form the necessary revolute joint(s). And the two Levitators (2500 and 2100), acting as rotors within each tunnel, are suspended by their flux pinned interactions with the magnetic fields to create the necessary revolute joints. And additionally, some of these magnetic stators can also form bonds with additional Levitators on either side of the stator tunnel. (These cylindrical permanent magnets are separated from one another by reinforcement so as not to interrupt each other's magnetic fields). According to an embodiment of the invention, the rotor's movement is powered by a electromagnetic motor/generator (not illustrated herein).

From a front-view/cutaway perspective, FIG. 27A illustrates the cylindrical permanent magnet with its magnetic field lines 150. Furthermore, FIG. 27A also illustrates a Levitator within a certain proximity of the magnet 2700. Levitator 2705 is composed of very thin layers of a High Temperature Superconductor (HTSC) 2710 supported by layers of reinforcement material 2715. The HTSC is capable of flux-pinning with the magnetic flux emanating from the magnet. In the present illustration, the Levitator 2705 is out-of-range of the magnetic field and cannot flux pin with the magnet.

FIG. 27B illustrates a Levitator flux-pinned to the side of a cylindrical permanent magnet 2720. The Levitator has come within range of the magnetic field forming Vortices 805 with the magnet. (Note that the layers on reinforcement on the HTSC does not interfere with the formation of the vortices. Hence, the reinforcement composition cannot be composed of materials that cause interference with magnetic fields.)

FIG. 27C illustrates a Levitator flux-pinned to the side of a cylindrical permanent magnet. Yet in this depiction, the magnet has also been strengthened by layers of reinforcement material 2725. Note that the layers on reinforcement on both the magnet and the HTSC do not interfere with the formation of the vortices. Hence, the reinforcement composition cannot be composed of materials that cause interference with magnetic fields.

FIG. 27C illustrates—front-view/cutaway—a paired arrangement between the Levitator and the permanent cylindrical magnet, wherein one (or both) of the partners is composed largely of reinforcement materials. The Levitator is composed of interlocking layers of High Temperature Superconductor (HTSC) and reinforcement materials. The cylindrical permanent magnet may also be encased in layers of reinforcement material. (Reinforcement materials may also be deposited within the magnet, so long as said deposits (i) do not inhibit the magnet field, or (ii) separate a portion of the magnet from itself so as to change the overall magnetic field strength or even its nature as a cylindrical permanent magnet). And the rotor may be constructed in a manner, in which the particular materials (within the rotor)—that will be under the influence of flux pinning—are positioned within the rotor's mass to reinforce any other masses (within the rotor) from centrifugal stress. Centrifugal stress creates pressure that attempts to move the materials within the rotor in a outward direction from its axis. And the flux pinned materials, within the rotor, are situated to absorb and redirect this stress away to the reinforced stator. As such, the outermost rim of the rotor (as well as the majority of its outmost layers) should be composed of the materials undergoing flux pinning interactions. This construction prevents extraction of unreinforced materials from the rotor during operations; since the reinforced material is between the unreinforced material and the rim of the rotor, keeping it in place.

FIG. 27C further illustrates how Remote Structural Reinforcement allows for the continual strengthening of the Rotor through flux-pinning. Through this reinforcement mechanism, the Rotor can support increased rotational speeds, without increasing the mass of the Rotor. In this paired arrangement between the rotor and the stator, one (or both) of the partners is composed largely of reinforcement materials. Furthermore, as we increase the number of Vortices, the rigidity of the pair becomes increasingly similar. These layers of reinforcement strengthen the load that the stator can absorb from the Rotor—thereby, increasing the rotors tensile strength and ultimately the energy density of the Flywheel Energy Storage System (FESS). For this reason, these two core features increase tensile strength as well as energy density: (1) increasing the number of flux-pinned bonds that can be supported and (2) increasing the amount of reinforcement for the bonded pair. Both FIG. 27B and FIG. 27C provide examples of the use of Encasing Reinforcement within a Stator as discussed below in [420]-[0432]; with FIG. 27C illustrating Encasing Reinforcement of a magnet, while FIG. 27B illustrates Encasing Reinforcement of a Levitator or HTSC.

FIG. 28A Illustrates a top/cutaway view of a view of a battery-cell-tray. In particular, this example battery-cell-tray is the largest of those depicted in this FIG. 28 and will be referred to as the large-battery-cell-tray 2800. Finally, the outermost wall of the sphere is composed of reinforcement materials 2810. While the inner portion 2805 is the actual FESS “battery cell” which can be like the various embodiments depicted like examples in either FIG. 25 or FIG. 26.

FIG. 28B Illustrates a top/cutaway view of a view of a battery-cell-tray. In particular, this example battery-cell-tray is the second largest of those depicted in this FIG. 28 and will be referred to as the medium-battery-cell-tray 2815. Finally, the outermost wall of the sphere is composed of reinforcement materials 2825. While the inner portion 2820 is the actual FESS “battery cell” which can be like the various embodiments depicted like examples in either FIG. 25 or FIG. 26.

FIG. 28C Illustrates a top/cutaway view of a view of a battery-cell-tray. In particular, this example battery-cell-tray is the smallest of those depicted in this FIG. 28 and will be referred to as the small-battery-cell-tray 2830. Finally, the outermost wall of the sphere is composed of reinforcement materials 2840. While the inner portion 2835 is the actual FESS “battery cell” which can be like the various embodiments depicted like examples in either FIG. 25 or FIG. 26.

FIG. 28D illustrates—from a side view—Spherical Holder 2845 of five battery-cell-trays where each battery-cell-tray is layered upon one another in the following order (top to bottom): The uppermost layer 2850 is a small-battery-cell-tray 2830. The second-uppermost layer 2855 is a medium-battery-cell-tray 2815. The third uppermost layer 2860 is a large-battery-cell-tray 2800. The fourth uppermost 2865 is a medium-battery-cell-tray 2815. The lowermost 2870 is a small-battery-cell-tray 2830. FIG. 28D illustrates a systems for storing FESS battery cells in a spherical container with a high level of efficiency. The several FESS “battery cells” are stored—layered within the spherical container; whereas the outer shell of the spherical container is composed of reinforcement material;

FIG. 29A Illustrates a top/cutaway view of a view of a battery-cell-tray. In particular, this example battery-cell-tray is the largest of those depicted in this FIG. 29 and will be referred to as the large-battery-cell-tray 2900. Finally, the outermost wall of the sphere is composed of reinforcement materials 2905. While the inner portion 2910 is the actual FESS “battery cell” which can be like the various embodiments depicted like examples in either FIG. 25 or FIG. 26.

FIG. 29B Illustrates a top/cutaway view of a view of a battery-cell-tray. In particular, this example battery-cell-tray is the second largest of those depicted in this FIG. 29 and will be referred to as the medium-battery-cell-tray 2915. Finally, the outermost wall of the sphere is composed of reinforcement materials. While the inner portion is the actual FESS “battery cell” which can be like the various embodiments depicted like examples in either FIG. 25 or FIG. 26.

FIG. 29C Illustrates a top/cutaway view of a view of a battery-cell-tray. In particular, this example battery-cell-tray is the smallest of those depicted in this FIG. 29 and will be referred to as the small-battery-cell-tray 2920. Finally, the outermost wall of the sphere is composed of reinforcement materials. While the inner portion is the actual FESS “battery cell” which can be like the various embodiments depicted like examples in either FIG. 25 or FIG. 26.

FIG. 29D illustrates—from a side view—Spherical Holder 2925 of five battery-cell-trays where each battery-cell-tray is layered upon one another in the following order (top to bottom): The uppermost layer 2930 is a small-battery-cell-tray 2920. The second-uppermost layer 2935 is a medium-battery-cell-tray 2915. The third uppermost layer 2940 is a large-battery-cell-tray 2900. The fourth uppermost 2945 is a medium-battery-cell-tray 2915. The lowermost 2950 is a small-battery-cell-tray 2920.

FIG. 29E illustrates—from a top/cutaway view—the benefits of this embodiment. In this illustration of the tray 2955, the cavity 2970 which typically holds the battery-cell is vacant, in order to better visualize the centrifugal force 2965 emitted by each battery cell. This system allow the centrifugal stress of one cell to provide additional reinforcement (in conjunction with the reinforcement material 2960) for its neighboring cells. (Note that various versions of this could be fabricated with additional layers of ringed FESS battery cells.) FIG. 29E illustrates a systems for storing FESS battery cells in a spherical container with a high level of efficiency, where the centrifugal stress of the battery cells can be used a reinforcement mechanism for its neighboring cells. In this spherical container, several FESS “battery cells” are stored within layers within the spherical container. And each FESS “battery cell” within a particular layer is arranged between patches of reinforcement, so that the centrifugal stress produce by any single “battery cell” can be used to gird its neighboring “battery cell” against its own centrifugal stress. Whereas the outer layer of the spherical container is composed of reinforcement material;

FIG. 30A illustrates—from a top/cutaway view—the Outermost-Spherical-Insulation-chamber 3000 that acts as a vacuum chamber; as highlighted by its hollow cavity 3015. The inner surface 3010 of the chamber is coated with materials that are highly absorptive of infrared radiation. The materials adjacent 3005 to this coating should be composed of materials that can act as a highly efficient heat sink. The outermost materials of the chamber should be highly insulating and capable of maintains strong vacuum. Also, attached to the inner surface of the chamber is several magnet surfaces 3020 for flux binning with other components.

FIG. 30B illustrates—from a top/cutaway view—the Innermost-Spherical-Insulation-chamber 3025, which acts as an encasement for the Spherical Holder 2925 of the FESS battery cells as discuss in FIG. 30E. The chamber has a hollow cavity 3040 presently. The outer surface 3030 of the chamber is coated with materials that are highly absorptive of infrared radiation. The materials adjacent to this coating should be composed of materials that can act as a highly efficient heat sink. The outermost materials of the chamber should be highly insulating and capable of maintains strong vacuum. Also, attached to the outer surface of the chamber is several Levitators (HTSC) surfaces 3035 for flux pinning with other components.

FIG. 30C illustrates—from a top/cutaway view—a combines assembly where the Innermost-Spherical-Insulation-chamber 3040 is placed within the Outermost-Spherical-Insulation-chamber 3000 to form the Insulation Chamber 3045 for the battery. Notice that flux pinning occurs—and vortices 805 form—between the magnetic surfaces 3020 of the Outermost-Spherical-Insulation-chamber 3000 and the Levitators (HTSC) surfaces 3035 of the Innermost-Spherical-Insulation-chamber 3025; this interaction cause the Innermost-Spherical-Insulation-chamber 3025 to levitate with the Outermost-Spherical-Insulation-chamber 3000. Hence, these two components are making no physical contact and are separate by a vacuum 3050.

FIG. 30D illustrates—from a top/cutaway view—the battery 2925 which will be place within the insulation chamber. A generic battery example is illustrated.

FIG. 30E illustrates—from a top/cutaway view—the completed insulation system 3055 with both the insulation chamber 3045 with a battery 2925 assembly within it.

FIG. 30F illustrates—from a top/cutaway view—the insulation system is composed of a dual chambered enclave designed to insulate and extract heat from the FESS in form of infrared light. Whereas the inner chamber—in which the FESS is stored—has an outer surface that is coated with a material that is highly reflective of infrared radiation; this inner chamber is levitated (via flux pinning) within an outer chamber. Furthermore, the inner surface of the outer chamber is coated with a material that is highly absorptive of infrared radiation. And in the zone separating these two chambers, a vacuum is maintained.

FIG. 31A illustrates—from a top/cutaway view—the outermost sphere 3100 of the gimbal. On the inner surface of the sphere are magnet surfaces for flux pinning 3105. The illustration demonstrates the degrees of movement this sphere will enable 3110.

FIG. 31B illustrates—from a top/cutaway view—the innermost sphere 3115 of the gimbal. On the outer surface of the sphere are Levitator surfaces (HTSC) 3110 for flux pinning. The illustration demonstrates the degrees of movement this sphere will enable 3125.

FIG. 31C illustrates—from a top/cutaway view—a generic example of a FESS battery cell 2815.

FIG. 31D illustrates—from a top/cutaway view—the fully assembled gimbal 3130 with the battery cell within it. Here, we see that Vortices 805 form between the battery cell 2815 and the innermost sphere 3115. Furthermore, we see that Vortices 805 form between the outermost sphere 3100 and the innermost sphere 3115.

FIG. 31E illustrates—from a top/cutaway view—a spherical gimbal that utilizes flux pinning that to produce the requisite revolute joints. Furthermore, this gimbal is comprised of dual spherical chambers, one enclosing the other. And the FESS is stored within the innermost chamber.

FIG. 32 here we illustrate—from a top/cutaway view—a donut shaped rotor 3200, enclosed within a hollow donut shaped stator, which increases the surface area available for the formation of Vortices 805. According to an embodiment of the invention 3215, the rotor's movement is powered by a electromagnetic motor/generator (not illustrated herein). The FESS example 3215 is composed of a levitator base stator and magnet based rotor. FIG. 32 illustrates a Levitator encasement composed of HTSC. In particular, we illustrate the inner portion 3205 of the donut shaped Levitator as well as the outer portion 3210 of the Levitator.

FIG. 33 here we illustrate—from a ¾ front/top cutaway view—a donut shaped rotor 3200, enclosed within a hollow donut shaped stator, which increases the surface area available for the formation of Vortices 805. According to an embodiment of the invention 3215, the rotor's movement is powered by a electromagnetic motor/generator (not illustrated herein). The FESS example 3215 is composed of a levitator base stator and magnet based rotor. FIG. 33 illustrates a Levitator encasement composed of HTSC. In particular, we illustrate the inner portion 3205 of the donut shaped Levitator as well as the outer portion 3210 of the Levitator. [It is quite preferable to use a cylindrical permanent magnet that is a superconducting permanent magnet in this example. Whereas said superconducting permanent cylindrical magnet is composed of either a type 1 or type 2 superconducting materials formed into a short circuit and endowed with an magnetic field of sufficient strength. The material can be endowed with a magnetic field, various means, including applied repetitious exposure to another permanent of sufficient strength. (Mercury is an excellent material for forming a superconducting permanent cylindrical magnet; once it is frozen, brought to its critical temperature, and endowed with a magnetic field of sufficient strength).]

FIG. 34A illustrates—from a ¾ cutaway view of front/top—a solid-multilayer-FESS-rotor 3400 composed of several overlapping layers of cylindrical permanent magnets and cylindrical Levitators thin films. This particular illustration has a portion of the rotor unraveled and a portion bonded for illustration purpose. Each of these layers, though in direct physical contact form flux-pinning bonds with one another. As each magnet film forms a complete circle or circuit, it in effect forms a cylindrical permanent magnet forming vortices with every cylindrical Levitator layer of HTSC within range of the magnetic field. FIG. 34A also illustrates the unraveled portion of the rotor with the Outermost Unraveled Magnetic film layer 3440, the Outermost Unraveled Levitator film layer 3430, the Innermost Unraveled Magnetic film layer 3420, and the Innermost Unraveled Levitator film layer 3410. Furthermore, FIG. 34A finally illustrates the bonded portion of the rotor with the Outermost Bonded Magnetic film layer 3435, the Outermost Bonded Levitator film layer 3425, the Innermost Bonded Magnetic film layer 3415, the Innermost Bonded Levitator film layer 3405.

FIG. 34B illustrates—from a ¾ cutaway view of front/top—a solid-multilayer-FESS-rotor 3400 (fully bonded) implemented with its three surface stator (Levitator based stator in this example) 3445 and 3450. Each layer of the rotor essentially forms a hollow cylindrical shell of one of the following: (i) a Levitator (HTSC), (ii) a permanent cylindrical magnet, or (iii) composite reinforcement. Furthermore, each cylindrical layer encases the next. According to an embodiment of the invention, the rotor's movement is powered by a electromagnetic motor/generator (not illustrated herein). Important note: Levitator's HTSC material must not form a short circuit (or circle) so as not to become an additional superconducting magnet. Levitator's reinforcement layers should be positioned to prevent the HTSC from forming the requisite short circuit. [It is quite preferable to use a cylindrical permanent magnet that is a superconducting permanent magnet in this example. Whereas said superconducting permanent cylindrical magnet is composed of either a type 1 or type 2 superconducting materials formed into a short circuit and endowed with an magnetic field of sufficient strength. The material can be endowed with a magnetic field, various means, including applied repetitious exposure to another permanent of sufficient strength. (Mercury is an excellent material for forming a superconducting permanent cylindrical magnet; once it is frozen, brought to its critical temperature, and endowed with a magnetic field of sufficient strength).] [If both components (Levitator and cylindrical permanent magnet) are composed of superconducting materials. The superconducting characteristics of the materials within Levitator should be activated (via cooling to critical temperature et al), prior to endowing the superconducting materials within (what will become) superconducting permanent cylindrical magnet with a magnetic field. This will allow the rotor to retain maximum stiffness from the flux pinning interactions by abating any potential field cooling mechanisms that might have otherwise been incited during construction of the rotor.]

FIG. 35 illustrates—from a top/cutaway view—a solid-multilayered-rotor 3455 composed of very thin overlapping layers of magnetic materials and HTSC and reinforcement. Each layer of the rotor essentially forms a hollow cylindrical shell of one of the following: (i) a Levitator (HTSC), (ii) a permanent cylindrical magnet, or (iii) composite reinforcement. Furthermore, each cylindrical layer encases the next. According to an embodiment of the invention, the rotor's movement is powered by a electromagnetic motor/generator (not illustrated herein). In this illustration, we demonstrate the Vortices 805 forming between the stator wall 3445 and the solid-multilayer-FESS-rotor 3400.

FIG. 36 here we illustrate—from a front/cutaway view—a donut shaped rotor 3630, enclosed within a hollow donut shaped stator 3615, which increases the surface area available for the formation of Vortices 805. (The rotor and stator are separated by a Vacuum). According to an embodiment of the invention 3600, the rotor's movement is powered by a electromagnetic motor/generator (not illustrated herein). This FESS example 3600, could be composed of either: (i) a permanent cylindrical magnet based rotor paired with a Levitator based stator or (ii) Levitator based rotor pair with a permanent cylindrical magnet based stator. Notice how the reinforcement is built into the inner portion of the donut shaped rotor 3610; while the outer portion of the rotor 3605 composed of flux pinning materials.

As a result of these features, the rotor has be constructed in a manner, in which the particular materials (within the rotor)—that will be under the influence of flux pinning—are positioned within the rotor's mass to reinforce any other masses (within the rotor) from centrifugal stress. As such, the outermost rim of the rotor is actually composed of the materials undergoing flux pinning interactions. FIG. 36 also illustrates the direction in which the centrifugal stress is acting on the rotor 3620. The Levitator is composed of interlocking layers of High Temperature Superconductor (HTSC) and reinforcement materials. The cylindrical permanent magnet may also be encased in layers of reinforcement material; and reinforcement materials may also be deposited within the magnet, so long as said deposits (i) do not inhibit the magnet field, or (ii) separate a portion of the magnet from itself so as to change the overall magnetic field strength or even its nature as a cylindrical permanent magnet. And the rotor is be constructed in a manner, in which the particular materials (within the rotor)—that will be under the influence of flux pinning—are positioned within the rotor's mass to reinforce any other masses (within the rotor) from centrifugal stress. Centrifugal stress creates pressure that attempts to move the materials within the rotor in a outward direction from its axis. And the flux pinned materials, within the rotor, are situated to absorb and redirect this stress away to the reinforced stator. As such, the outermost rim of the rotor (as well as the majority of its outmost layers) should be composed of the materials undergoing flux pinning interactions. This construction prevents extraction of unreinforced materials from the rotor during operations; since the reinforced material is between the unreinforced material and the rim of the rotor, keeping it in place. This is one example of the use of Embedded Reinforcement within a Rotor as discussed below in [0420]-[0432].

Encasing Reinforcement (with an embodiment illustrated in FIG. 36) versus Embedded Reinforcement (with an embodiment illustrated in FIG. 27).

Reinforcement of the stator is necessary; since it is the stator that will be absorbing the centrifugal stress from the rotor via the flux pinning interaction (i.e. Vortices). As such, the stator may be reinforced in two ways, using: Encasing Reinforcement as well as Embedded Reinforcement. Encasing Reinforcement is reinforcement material that surrounds the materials undergoing flux pinning; hence, it is reinforcement that would surround either the permanent cylindrical magnet or the Levitator's HTSC. Embedded Reinforcement is the reinforcement material that would be either (i) layered thinly between thin layers of the materials undergoing flux pinning or (ii) deposited within (potentially in a fashion similar to steel rebar reinforcing a concrete foundation). And since the centrifugal stress typically manifest as a lateral pressure, each layer of reinforcement should be layered laterally (i.e. left to right, so to speak, rather than vertically one above the other) in a series of concentric rings. The stator would benefit from both of these paradigms being used simultaneously. Yet, Encasing Reinforcement is most necessary. Additionally, both Encasing Reinforcement as well as Embedded Reinforcement should be positioned so as to reinforce the flux pining material in the stator from centrifugal stress during FESS operation. Importantly, the centrifugal stress typically manifest as a lateral pressure. As such, Encasing Reinforcement should be arranged with lateral reinforcement on the outermost rim of the stator; while Embedded Reinforcement should have laterally oriented reinforcement layers (or rebar cages) woven between the flux pinning materials of the stator.

Examples for Possible Embedded Reinforcement of Stator:
For example, each layer of reinforcement—within a Levitator based stator—should be layered laterally (i.e. left to right, so to speak, rather than vertically one above the other) between layers of HTSC.
As an alternative example, Embedded Reinforcement (of a permanent cylindrical magnet based) stator could take the form of layers of interlocking-rebar-cages of reinforcement within a cylindrical magnetic mass. And these interlocking-rebar-cages should layered be layered laterally (i.e. left to right, so to speak, rather than vertically one above the other) within the magnetic mass. Please note that reinforcement could be composed of any number of materials (e.g. carbon fiber) so long as said reinforcement material (i) does not inhibit the magnet field, or (ii) separate a portion of the magnet from itself so as to change the overall magnetic field strength or magnetic field shape or even its nature as a cylindrical permanent magnet.

Example for Encasing Reinforcement of Stator:
For example, the outermost shell (or layers) stator could be composed of reinforcement. This would lateral rim or boundary holding the stator in place. (Somewhat like a tire surrounding a wheel). This outermost rim of reinforcement would act like a dam keeping the centrifugal stress from bursting through the stator material. The Encasing reinforcement doesn't necessarily require covering the top or bottom of the stator; since the centrifugal stress is attacking from the sides. In fact, in some instances it might be preferable to leave top and bottom reinforcement absent so as to increase the stator's proximity to the rotor.

Reinforcement for the rotor is somewhat optional. Since the rotor could theoretically be composed entirely of a flux-pinned material, which ultimately is receiving sufficient reinforcement from the Vortices to deal with all stresses (centrifugal or otherwise). However, when reinforcement is added to the rotor it should be a form of Embedded Reinforcement (one example is illustrated in FIG. 36). Encasing Reinforcement (one example is illustrated in FIG. 27) is less desirable; on account, that the Encasing Reinforcement is by its nature on the outside of the rotor. Furthermore, it is not engaged in any flux pinning interactions. As such, said Encasing Reinforcement will only have its own tensile strength to gird it against the centrifugal stress of FESS operation. This might cause it to fail (as a material) at lower velocities than the rotor materials undergoing flux-pinning. As such, any reinforcement added to the rotor, that will not itself be flux pinned, must be added in a manner in which it is embedded behind (i.e. closer to the center of the rotor than) other materials in the rotor that will be undergoing flux pinning.

Examples for Embedded Reinforcement of Rotor:
Each layer of reinforcement—within a Levitator based rotor—should be layered laterally (i.e. left to right, so to speak, rather than vertically one above the other) between layers of HTSC in concentric rings. —And the outermost layers of the should be composed of HTSC.
As an alternative example, Embedded Reinforcement (of a permanent cylindrical magnet based) rotor could take the form of layers of interlocking-rebar-cages of reinforcement (forming concentric rings) within a cylindrical magnetic mass. And these interlocking-rebar-cages should layered be layered laterally (i.e. left to right, so to speak, rather than vertically one above the other) within the magnetic mass. —It is very important that the entirety of the reinforcement material be within and covered by the magnetic mass undergoing flux pinning interactions. Please note that reinforcement could be composed of any number of materials (e.g. carbon fiber) so long as said reinforcement material (i) does not inhibit the magnet field, or (ii) separate a portion of the magnet from itself so as to change the overall magnetic field strength or magnetic field shape or even its nature as a cylindrical permanent magnet.

Both Embedded and Encasing reinforcement should be distinguished the basic Levitator composition. While a Levitator may be composed entirely of a bulk HTSC; it is preferable to construct a Levitator with ultra thin layers of HTSC and reinforcement. Levitator is composed in this fashion to form ultra thin HTSC layers, which are separated from one another. The thinness and separation aids reducing the superconductors' resistance to and interference with magnetic fields. It also strengthens the HTSC materials for handling during construction as well as within FESS operation.

Additionally, since the centrifugal stress typically manifest as a lateral pressure, each layer of reinforcement should be layer laterally (i.e. left to right, so to speak, rather than vertically one above the other) in a series of concentric rings. Additionally, these layers can take the form of cages of rebar.

While the present disclosure has been described in connection with a series of preferred embodiments, these descriptions are not intended to limit the scope of the disclosure to the particular forms set forth herein. The above description is illustrative and not restrictive. Many variations of the embodiments will become apparent to those of skill in the art upon review of this disclosure. The scope of this disclosure should, therefore, be determined not with reference to the above description, but instead should be determined with reference to the appended claims along with their full scope of equivalents. The present descriptions are intended to cover such alternatives, modifications, and equivalents as can be included within the spirit and scope of the disclosure as defined by the appended claims and otherwise appreciated by one of ordinary skill in the art. In several respects, embodiments of the present disclosure can act to close the loopholes in the current industry practices in which good business practices and logic are lacking because it is not feasible to implement with current resources and tools.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

What is claimed is:

1. A Flywheel Energy Storage System (FESS) that utilizes flux pinning in a manner that allows the physical reinforcements—placed around or within the stator—to provide contactless reinforcement to the rotor during the FESS' operation. Hence, the FESS provides Remote Structural Reinforcement to the rotor during operation; and this advanced FESS comprises:
a Levitator, which may either be (i) a bulk HTSC or (ii) one composed of ultra thin layers of High Temperature Superconductor (HTSC) having been brought to its critical temperature(s) enabling the superconducting characteristics of its components; further, each layer of HTSC may be separated from one another by layers of ultra thin reinforcement-materials; and Levitator may also be encased in layers of reinforcement materials; said reinforcement materials must not inhibit the superconductivity or magnetic penetration of various components;
a cylindrical permanent magnet, which may be a superconducting magnet with components brought to their critical temperature(s) enabling their superconducting characteristics; and which may be encased in (and/or embedded with) layers of reinforcement material; said reinforcement materials must not inhibit the superconductivity or magnetic penetration of various components;
a contactless-levitating-revolute joint (or frictionless hinge) upon which the rotor can move about the stator in a circular contactless fashion; such joint will be formed as the Levitator is brought within range of the appropriate portion of the cylindrical permanent magnet's axially symmetric magnetic field—establishing Vortices between Levitator and magnet;
a rotor, for which either the cylindrical permanent magnet or the Levitator may be designated, that will act as the moving component of the FESS; whereby, the rotor is be constructed in a manner, in which the flux pinning materials of the rotor are positioned around and within the rotor's mass to reinforce the non-flux pinning materials (within the rotor) (if any) from centrifugal stress; as such, the outermost rim of the rotor should be composed entirely of the materials undergoing flux pinning interactions;
a stator, for which either the cylindrical permanent magnet or the Levitator may be designated, that will act as the stationary component of the FESS; whereby the stator is be constructed in a manner, in which the non-flux pinning materials of the stator are positioned (around and (potentially) within) the stator's mass to reinforce the flux pinning materials (within the stator) from the centrifugal stress transmitted from the rotor during the flux pinning interactions;
as such, the outermost rim of the stator should be composed entirely of the materials that are not undergoing flux pinning interactions;
an electromagnetic motor/generator, wherein the motor—using electricity—accelerates the rotor to store energy, and wherein the generator later extracts energy from the rotor's motion to generate electricity;
a vacuum chamber, in which all (or a portion of) the air has been evacuated, to reduce friction and increase insulation; and
a refrigeration (and insulation) system for the retention of the critical temperature(s) of the superconducting components.

2. The system of claim 1, wherein the cylindrical permanent magnet is a superconducting permanent magnet; whereas said superconducting permanent cylindrical magnet is composed of either a type 1 or type 2 superconducting material formed into a short circuit and endowed with a magnetic field of sufficient strength; mercury is an excellent example of a type 1 superconducting material that could be used in forming such a superconducting permanent cylindrical magnet.

3. The system of claim 1, wherein the embedded reinforcement is composed of reinforcement layered laterally (i.e. in a series of concentric rings) within the materials undergoing flux pinning interactions.

4. The system of claim 3, wherein the concentric layers of reinforcement can take the form of rebar-cages.

5. The system of claim 1, wherein the encasing reinforcement is of composed reinforcement surrounding/enveloping the materials undergoing flux pinning interactions.

6. The system of claim 1, wherein the rotor is doughnut-shaped and contained within a similarly doughnut-shaped yet hollow stator, allowing for an increase in surface area exposure between the cylindrical permanent magnet and the Levitator for the formation of Vortices; it is important to note that the permanent cylindrical magnet as well as the levitator can be readily formed into either component for this claim.

7. The system of claim 1, wherein the “battery cell” of the FESS is composed of one or more Levitator(s) that are flux pinned with one or more cylindrical permanent magnet(s) forming one or more revolute joint(s).

8. The system of claim 7, wherein each Levitator is far smaller than the magnetic surface (of the permanent cylindrical magnet) where the revolute joint is formed.

9. The system of claim 7, wherein each Levitator is large enough to nearly cover the entirety of the magnetic surface (of the permanent cylindrical magnet) where the revolute joint is formed.

10. The system of claim 9, wherein each rotor is separated from one another by a four (4) sided “tunnel” composed of stator(s) or stator materials.

11. The system of claim 10, wherein several of the tunnel walls, composed of stator(s) or stator material, could engage in flux pinning interactions with rotors on either side of the wall (bonding with rotors both inside and outside the tunnel).

12. The system of claim 1, further comprising:
a “solid-multilayered-rotor” composed of very thin overlapping/encasing layers of cylindrical permanent magnet(s) and Levitator(s) and reinforcement.

13. The system of claim 12, wherein each of the layers (within the a solid-multilayered-rotor) essentially forms a hollow cylindrical shell of one of the following: Levitator, permanent cylindrical magnet, or composite reinforcement; where each layer encases the next.

14. The system of claim 12, wherein each layer, that is composed of either Levitator(s) or permanent cylindrical magnet(s), undergoes flux pinning interactions with the other appropriate layers within the rotor—providing the rotor with increased tensile strength.

15. The system of claim 12, wherein the stator undergoes flux pinning interactions with either the Levitator layer(s) or permanent cylindrical magnet layer(s) within the rotor, forming the revolute joint of the FESS.

16. The system of claim 12, further comprising:
a core of the rotor, at the center of the many layers, which is composed of strong material as final reinforcement.

17. The system of claim 1, further comprising:
a spherical container for several FESS “battery cells”

18. The system of claim 17, further comprising a series of layered shelves, contained within the spherical container, in which the FESS “battery cells” are stored.

19. The system of claim 18, wherein each FESS “battery cells” is stored within one of the layered shelves, one atop the other, within said spherical container.

20. The system of claim 18, wherein several FESS “battery cells” are stored within each of the layered shelves within said spherical container.

21. The system of claim 20, wherein each FESS “battery cell” within a particular layer is arranged between patches of reinforcement, so that the centrifugal stress produce by any single “battery cell” can be used to gird its neighboring “battery cell” against its own centrifugal stress.

22. The system of claim 21, further comprising:
Machine Learning Software design guide the respective motor/generator(s) in distributing power to/from the battery cells in each shelf.

23. The system of claim 22, wherein the Machine Learning Software distributes energy, between the battery cells, in a manner that maximizes each battery's ability to provide structural support to its neighbor.

24. The system of claim 17, further comprising:
an outer shell of the spherical container which is composed of reinforcement material.

25. The system of claim 1, further comprising:
an insulation system composed of a dual chambered enclave (one chamber within the other) designed to insulate and extract heat from the FESS in form of infrared light.

26. The system of claim 25, wherein the FESS is stored in the inner chamber

27. The system of claim 25, wherein the inner chamber has an outer surface that is coated with a material that is highly reflective of infrared radiation—such as plexiglass.

28. The system of claim 25, wherein the outer chamber has an inner surface that is coated with a material that is highly absorptive of infrared radiation—such as Vantablack.

29. The system of claim 25, wherein the inner chamber is levitated (via flux pinning) within the outer chamber.

30. The system of claim 25, wherein the outer surface of the inner chamber is embedded with several Levitators (brought to their critical temperature).

31. The system of claim 25, wherein the inner surface of the outer chamber is embedded with several magnets.

32. The system of claim 25, wherein the Levitators and the magnets, embedded within the walls of each respective chamber, undergo flux pinning interactions producing the levitation of the inner chamber.

33. The system of claim 25, wherein a vacuum is maintained in the zone separating these two chambers.

34. The system of claim 1, further comprising:
a spherical gimbal—to which the FESS is attached or enclosed—that utilizes revolute joints produced by flux-pinning.

35. The system of claim 34, wherein the gimbal is comprised of dual spherical chambers, one enclosing the other.

36. The system of claim 34, wherein the FESS is stored in the inner chamber.

37. The system of claim 34, wherein outer surface of the FESS is embedded with Levitators (brought to their respective critical temperatures).

38. The system of claim 34, wherein inner surface of the inner chamber is embedded with cylindrical permanent magnet(s).

39. The system of claim 34, wherein—through flux pinning interactions—Levitators (HTSC) and cylindrical permanent magnets form revolute joints (frictionless hinges) between the FESS and the inner chamber.

40. The system of claim 34, wherein revolute joints allow on a FESS to rotate within the inner chamber on one axis of the gimbal.

41. The system of claim 34, wherein outer surface of the inner chamber is embedded with Levitators (brought to their respective critical temperatures).

42. The system of claim 34, wherein inner surface of the outer chamber is embedded with cylindrical permanent magnet(s).

43. The system of claim 34, wherein—through flux pinning interactions—Levitators (HTSC) and cylindrical permanent magnets form revolute joints (frictionless hinges) between the inner chamber and the outer chamber.

44. The system of claim 34, wherein revolute joints allow on a FESS to rotate within the inner chamber on another (opposing) axis of the gimbal.

45. A method for providing Remote Structural Reinforcement to the rotor of a Flywheel Energy Storage System, the method comprising:
flux pinning a Levitator with a cylindrical permanent magnet on a plane of the axially symmetric magnetic field—in such a way that one of the pair is levitating above the other and is able to move in a circular fashion above its partner;
setting up one of the pair, either the levitator or the cylindrical permanent magnet, as the stator;
setting up the other of the pair, either the levitator or the cylindrical permanent magnet, as the rotor;
positioning materials within the rotor in such a way that the flux pinning materials within the rotor's mass reinforce the non-flux pinning materials (within the rotor's mass) from centrifugal stress during operation;
positioning materials within the stator in such a way that the reinforcement materials within the stator's mass reinforce the flux pinning materials (within the stator's mass) from centrifugal stress transmitted from the rotor during operation;
placing the rotor and reinforced stator into a vacuum chamber, in which all or a part of the air has been removed, to reduced air resistance and increase insulation;
providing refrigeration and insulation (as needed) to maintain the critical temperatures of any superconducting components;
accelerating the rotor—to store energy—using a contactless electromagnetic motor/generator; and
decelerating the rotor—to extract energy—using a contactless electromagnetic motor/generator.

46. A method of claim 45, further comprising:
providing encasing reinforcement (to the stator) by surrounding/enveloping the materials undergoing flux pinning interactions with reinforcement materials (like composites).

47. A method of claim 45, further comprising:
providing embedded reinforcement (to the rotor and/or stator) by layering reinforcement laterally (i.e. left to right in a series of concentric rings) within the materials undergoing flux pinning interactions; (these concentric layers may take the form of rebar-cages).
